(19) United States
(12) Patent Application Publication
(10) Pub. No.: US 2026/0126629 A1
(43) Pub. Date: May 7, 2026

(54) VARIABLE MAGNIFICATION IMAGING OPTICAL SYSTEM

(71) Applicant: SIGMA CORPORATION, Kanagawa (JP)

(72) Inventor: Yasumoto OGINOME, Tokyo (JP)

(73) Assignee: SIGMA CORPORATION, Kanagawa (JP)

(21) Appl. No.: 19/352,771

(22) Filed: Oct. 8, 2025

(30) Foreign Application Priority Data
Nov. 7, 2024 (JP) 2024-195203

(51) Int. Cl. G02B 13/00; G02B 7/02; G02B 15/14

(52) U.S. Cl. CPC G02B 13/009; G02B 7/025; G02B 13/0045; G02B 13/006; G02B 15/1461

(57) ABSTRACT

A variable magnification imaging optical system achieves reduction in size and weight, suppresses lateral chromatic aberration and on-axis chromatic aberration during magnification change, enables high-speed focusing, and has favorable optical performance from infinity to a closest distance over the entire zoom range. A variable magnification imaging optical system includes, in order from an object side, a first lens group G1 having a positive refractive power, a second lens group G2 having a positive refractive power, a third lens group G3 having a negative refractive power, a middle group GM including an aperture diaphragm S consisting of one or more lens groups, a focusing group GF, and a subsequent group GR consisting of one lens group, in which a distance between adjacent lens groups changes during magnification change, and the focusing group GF moves along an optical axis during focusing from an infinite distance object to a close distance object.

### TECHNICAL FIELD

The present invention relates to a variable magnification imaging optical system suitable for an imaging optical system used in an imaging apparatus such as a digital camera or a video camera.

### BACKGROUND ART

In recent years, mirrorless digital cameras and video cameras have been developed, and high-performance cameras have been mounted on smartphones and mobile data terminals. Therefore, in order to differentiate digital cameras and video cameras from these mobile devices, there is an increasing demand for super telephoto zoom lenses.

In addition, in recent years, the image sensor of the digital camera and the video camera has been further increased in resolution, and the demand for high performance of the imaging optical system has been further increased.

Patent Documents 1 to 3 describe examples of variable magnification imaging optical system in which the half angle of view at the telephoto end is approximately 3 degrees or less.

### RELATED ART DOCUMENT

### Patent Document

[Patent Document 1] JP-A-2013-167749
[Patent Document 2] JP-A-2016-080825
[Patent Document 3] JP-A-2019-020450

### SUMMARY OF THE INVENTION

In a super telephoto zoom lens in which an angle of view at a telephoto end is narrow, in order to improve usability as a zoom lens, it is necessary to achieve three points of: a large zoom ratio, a reduction in size for improving portability, and imaging performance.

In order to achieve a large zoom ratio, a lens group having a positive refractive power is disposed closest to the object side, and the lens group is moved to the object side by magnification change to increase a telephoto ratio (a value obtained by dividing a total lens length by a focal length) at the telephoto end and to improve imaging performance in a telephoto state.

In addition, in a telephoto type lens, aberrations generated in a lens group of a convergent system disposed on the object side are magnified by a rear lens group. In a case of a fixed focal length lens, it is possible to simply suppress aberrations generated in the convergent system on the object side based on this relationship to improve the imaging performance. However, in a zoom lens, various aberrations fluctuate due to a change in power arrangement by magnification change, and thus the improvement cannot be simply achieved as in the fixed focal length lens. In particular, in a lens in a super telephoto range having a narrow angle of view, a change in direction in which a lateral chromatic aberration by magnification change occurs is a problem. Therefore, in order to reduce the size of the optical system while suppressing the occurrence of the lateral chromatic aberration over the entire zoom range, it is important to select an optical material in accordance with the change in power arrangement by magnification change.

The optical system described in Patent Document 1 is an example of a super telephoto zoom lens having a fixed total length. The various aberrations are suppressed over the entire zoom range, and the imaging performance is high. However, in a case where the zoom ratio is increased while maintaining the imaging performance in a type in which the total length is fixed, the optical system is significantly enlarged, which is not preferable.

The optical system described in Patent Document 2 is an example of a super telephoto zoom lens of a type in which the total length is variable by moving out a first group. However, a back focus (distance from a final lens to an image surface) with respect to the total lens length is large, and thus the optical system is insufficient in terms of reduction in size of the optical system in view of short flange back due to mirrorless development in recent years. In addition, the change in the lateral chromatic aberration is large from the wide-angle end to the telephoto end, and the correction is insufficient.

The optical system described in Patent Document 3 is an example of a super telephoto zoom lens corresponding to short flange back. However, the change in the lateral chromatic aberration is large from the wide-angle end to the telephoto end, and the correction is insufficient. In addition, the suppression of the total lens length at the wide-angle end is also insufficient.

The present invention has been made in view of such problems, and an object thereof is to provide a variable magnification imaging optical system that achieves reduction in size and weight, suppresses a lateral chromatic aberration and an on-axis chromatic aberration during magnification change, enables high-speed focusing, and has favorable optical performance from infinity to a closest distance over the entire zoom range.

In order to solve the above-described problem, according to an aspect of a variable magnification imaging optical system according to the present invention, the variable magnification imaging optical system consists of, in order from an object side, a first lens group G1 having a positive refractive power, a second lens group G2 having a positive refractive power, a third lens group G3 having a negative refractive power, a middle group GM including an aperture diaphragm S consisting of one or more lens groups, a focusing group GF, and a subsequent group GR consisting of one lens group, in which a distance between adjacent lens groups changes during magnification change, and the focusing group GF moves along an optical axis during focusing from an infinite distance object to a close distance object.

### Advantage of the Invention

According to the variable magnification imaging optical system according to at least one embodiment of the present invention, it is possible to provide a variable magnification imaging optical system that achieves reduction in size and weight, suppresses a lateral chromatic aberration and an on-axis chromatic aberration during magnification change, enables high-speed focusing, and has favorable optical performance from infinity to a closest distance over the entire zoom range.

### BRIEF DESCRIPTION OF THE DRAWINGS

FIG. 1 is a lens configuration diagram of a wide-angle end in a case of focusing on infinity in Example 1 of the variable magnification imaging optical system according to the present invention.

FIG. 2 is a longitudinal aberration diagram of the wide-angle end in a case of focusing on infinity in Example 1 of the variable magnification imaging optical system according to the present invention.

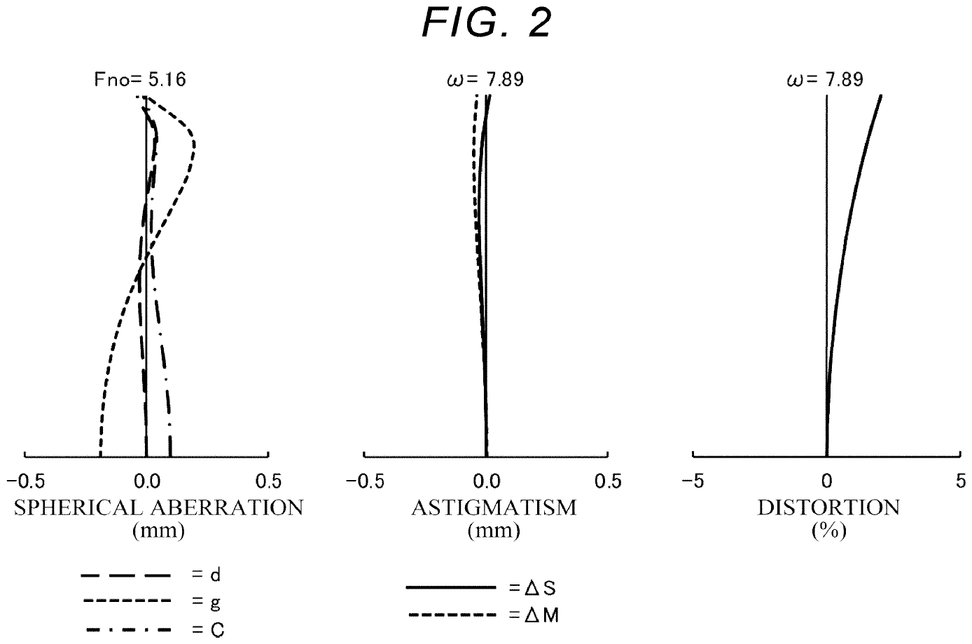

FIG. 3 is a longitudinal aberration diagram of a middle focal length in a case of focusing on infinity in Example 1 of the variable magnification imaging optical system according to the present invention.

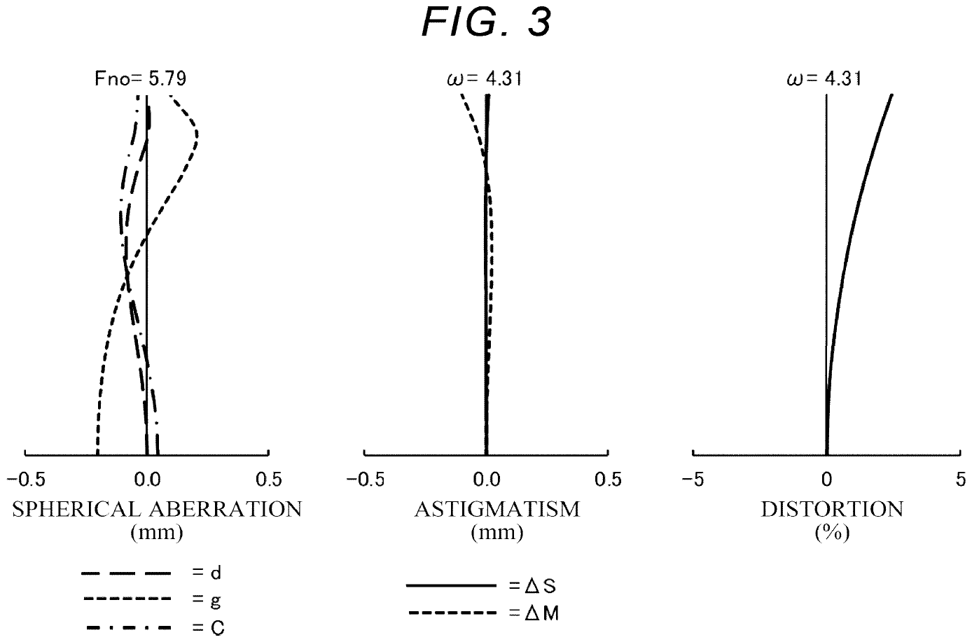

FIG. 4 is a longitudinal aberration diagram of a telephoto end in a case of focusing on infinity in Example 1 of the variable magnification imaging optical system according to the present invention.

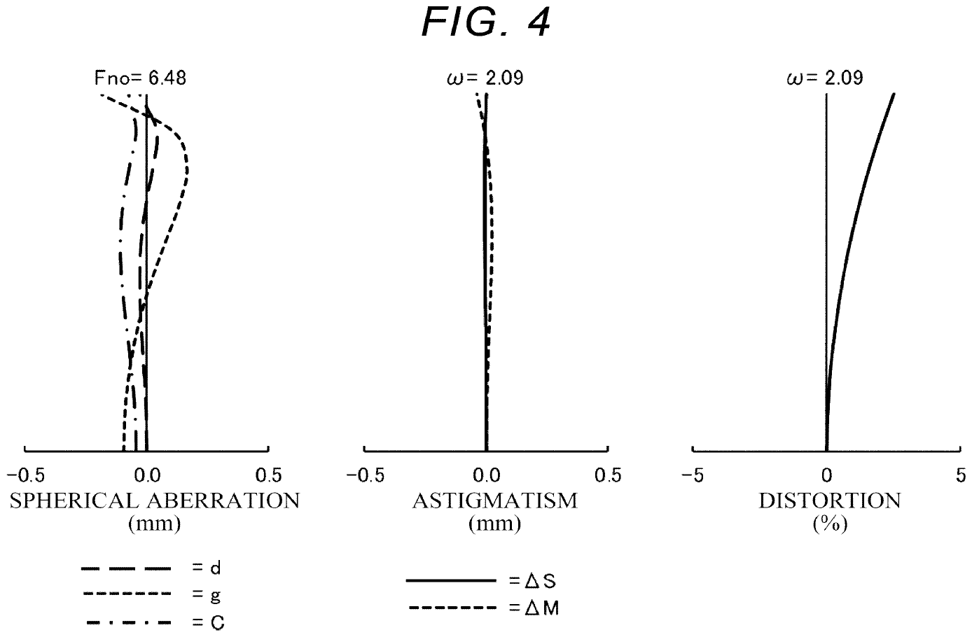

FIG. 5 is a lateral aberration diagram of the wide-angle end in a case of focusing on infinity in Example 1 of the variable magnification imaging optical system according to the present invention.

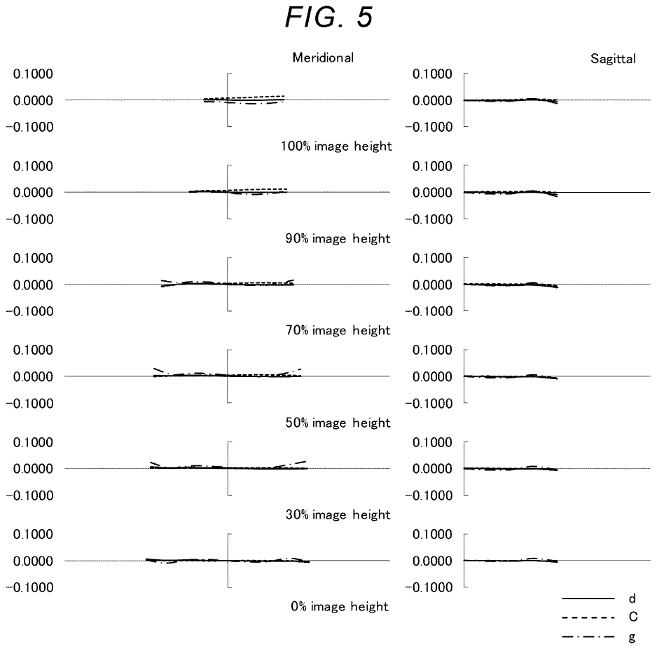

FIG. 6 is a lateral aberration diagram of the middle focal length in a case of focusing on infinity in Example 1 of the variable magnification imaging optical system according to the present invention.

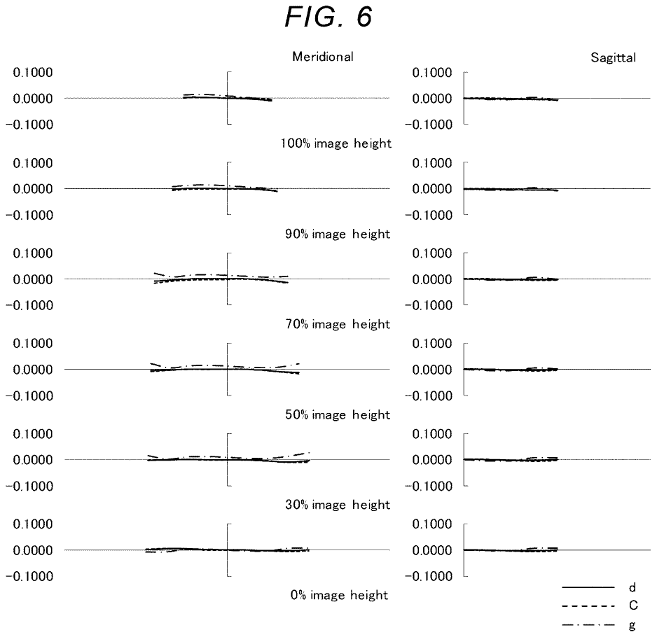

FIG. 7 is a lateral aberration diagram of the telephoto end in a case of focusing on infinity in Example 1 of the variable magnification imaging optical system according to the present invention.

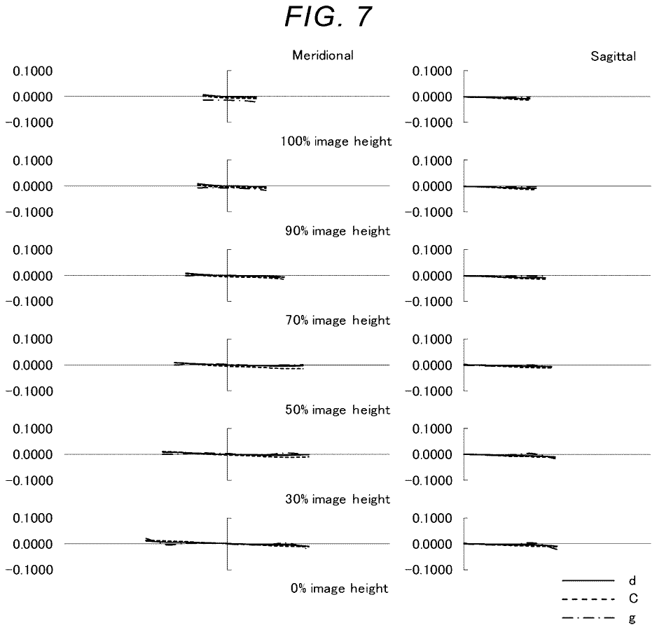

FIG. 8 is a lateral aberration diagram of the wide-angle end in a case of focusing at an object distance of 2.5 m in Example 1 of the variable magnification imaging optical system according to the present invention.

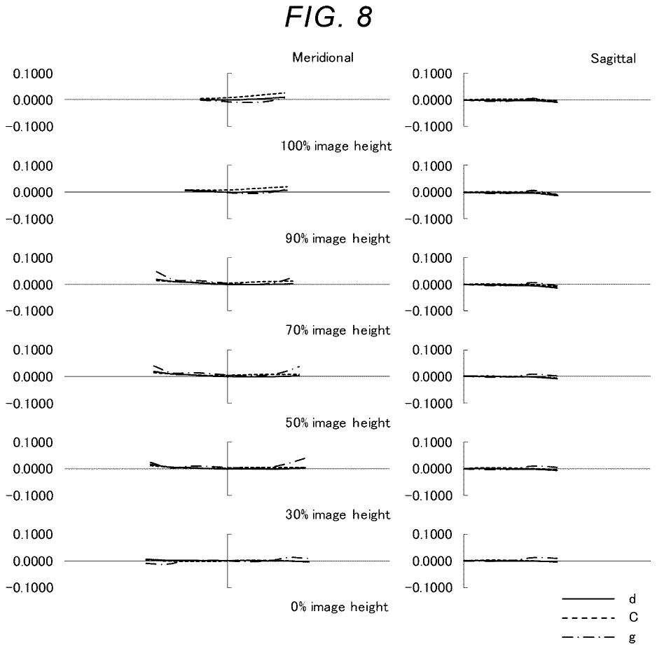

FIG. 9 is a lateral aberration diagram of the middle focal length in a case of focusing at an object distance of 2.5 m in Example 1 of the variable magnification imaging optical system according to the present invention.

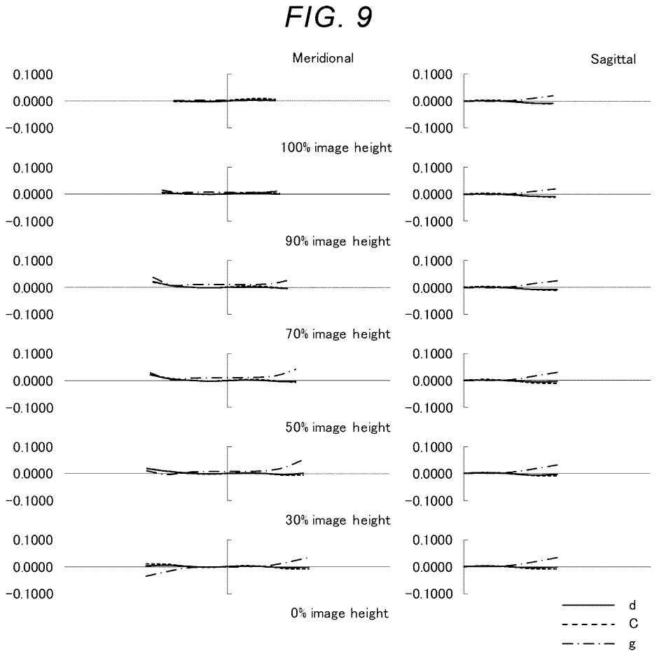

FIG. 10 is a lateral aberration diagram of the telephoto end in a case of focusing at an object distance of 2.5 m in Example 1 of the variable magnification imaging optical system according to the present invention.

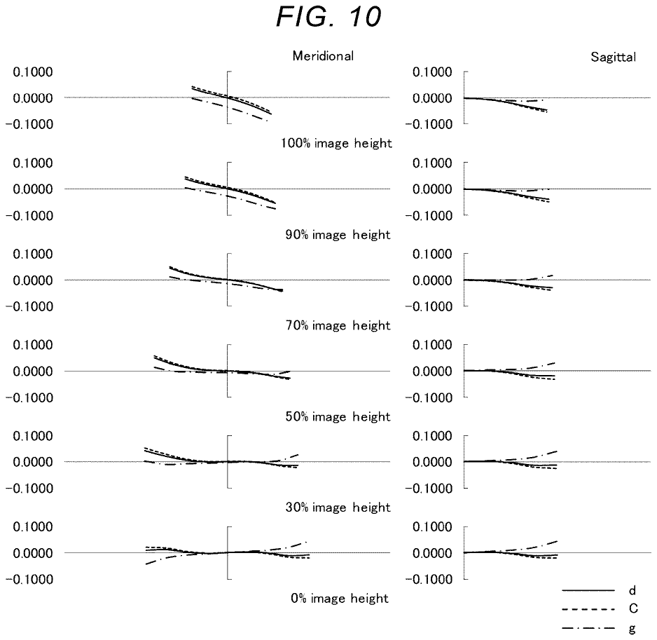

FIG. 11 is a lens configuration diagram of a wide-angle end in a case of focusing on infinity in Example 2 of the variable magnification imaging optical system according to the present invention.

FIG. 12 is a longitudinal aberration diagram of the wide-angle end in a case of focusing on infinity in Example 2 of the variable magnification imaging optical system according to the present invention.

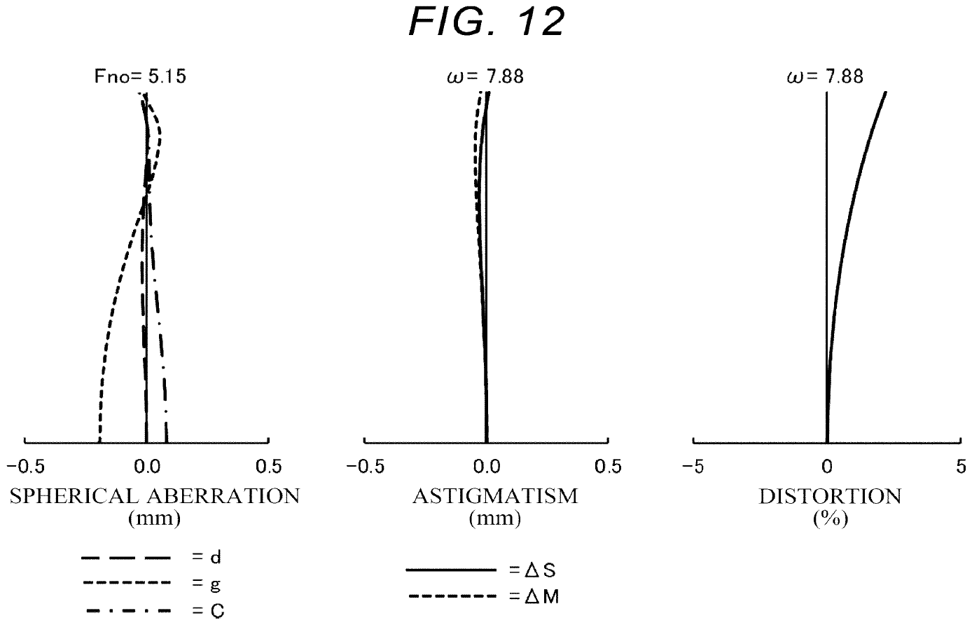

FIG. 13 is a longitudinal aberration diagram of a middle focal length in a case of focusing on infinity in Example 2 of the variable magnification imaging optical system according to the present invention.

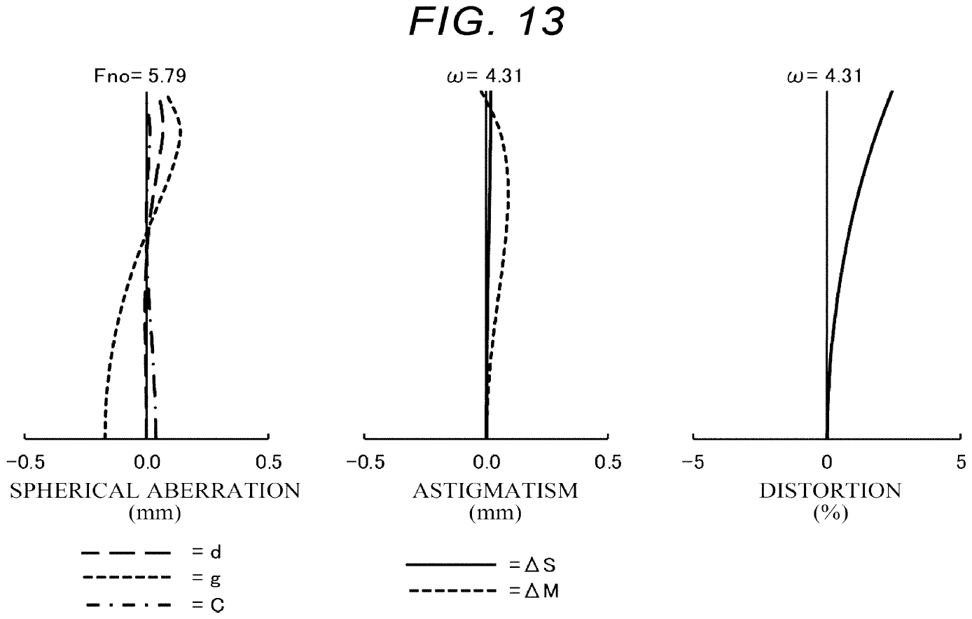

FIG. 14 is a longitudinal aberration diagram of a telephoto end in a case of focusing on infinity in Example 2 of the variable magnification imaging optical system according to the present invention.

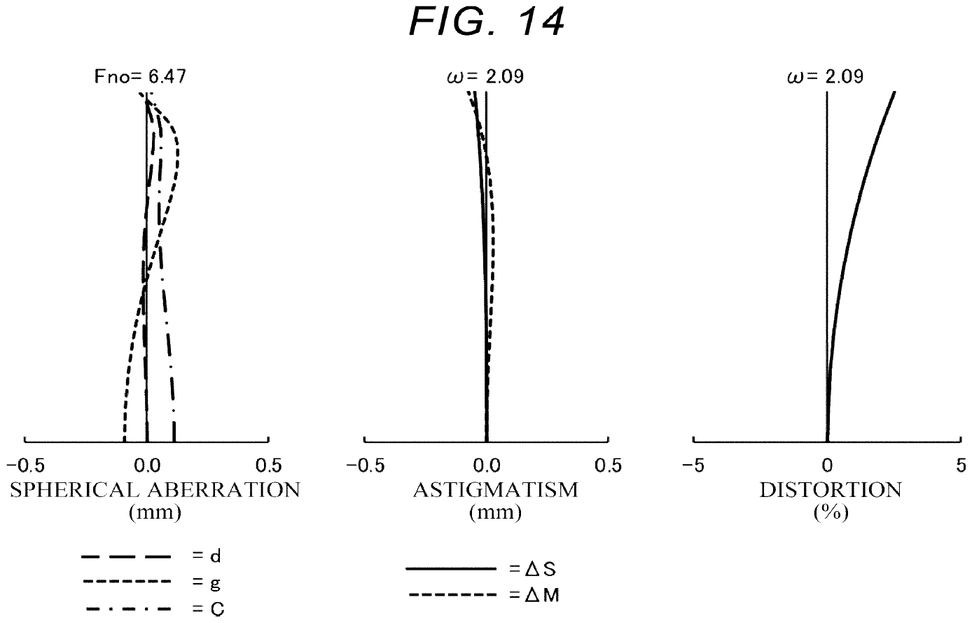

FIG. 15 is a lateral aberration diagram of the wide-angle end in a case of focusing on infinity in Example 2 of the variable magnification imaging optical system according to the present invention.

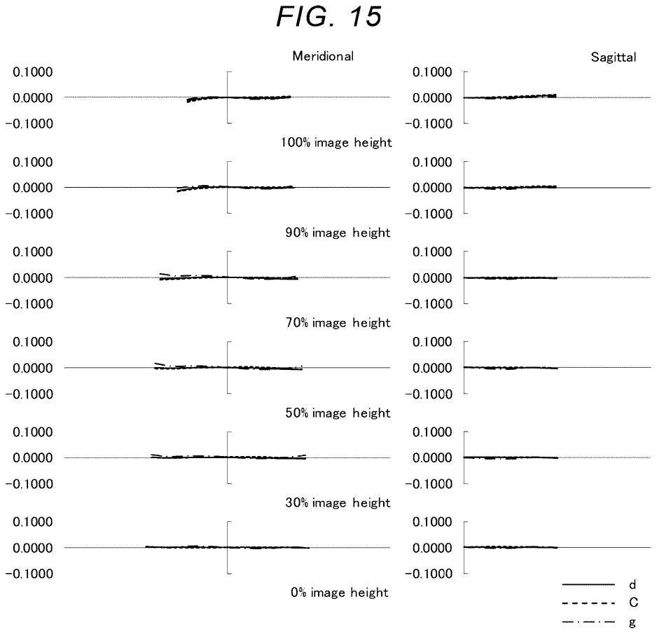

FIG. 16 is a lateral aberration diagram of the middle focal length in a case of focusing on infinity in Example 2 of the variable magnification imaging optical system according to the present invention.

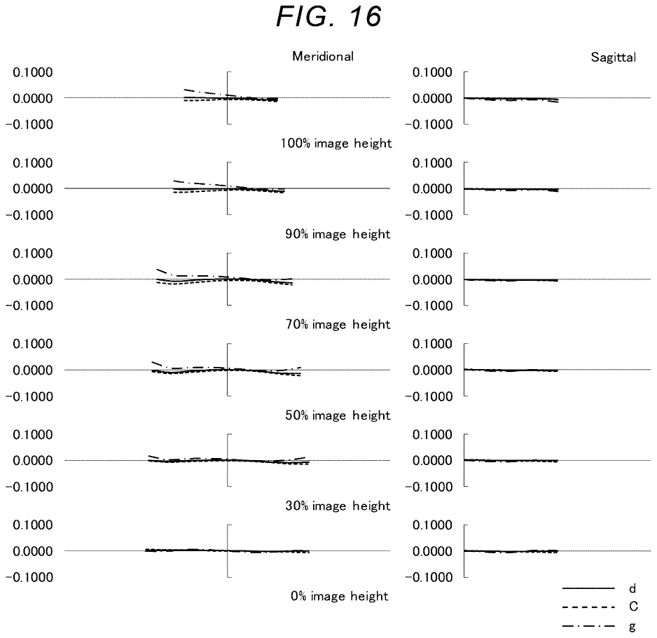

FIG. 17 is a lateral aberration diagram of the telephoto end in a case of focusing on infinity in Example 2 of the variable magnification imaging optical system according to the present invention.

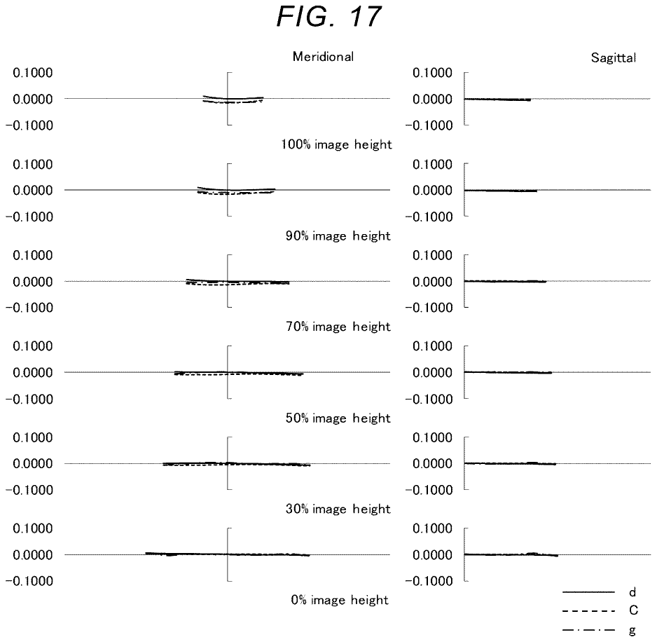

FIG. 18 is a lateral aberration diagram of the wide-angle end in a case of focusing at an object distance of 2.5 m in Example 2 of the variable magnification imaging optical system according to the present invention.

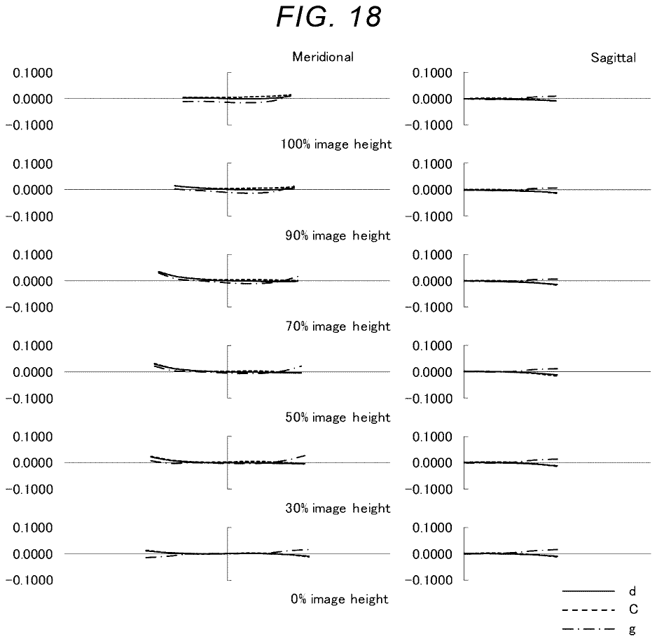

FIG. 19 is a lateral aberration diagram of the middle focal length in a case of focusing at an object distance of 2.5 m in Example 2 of the variable magnification imaging optical system according to the present invention.

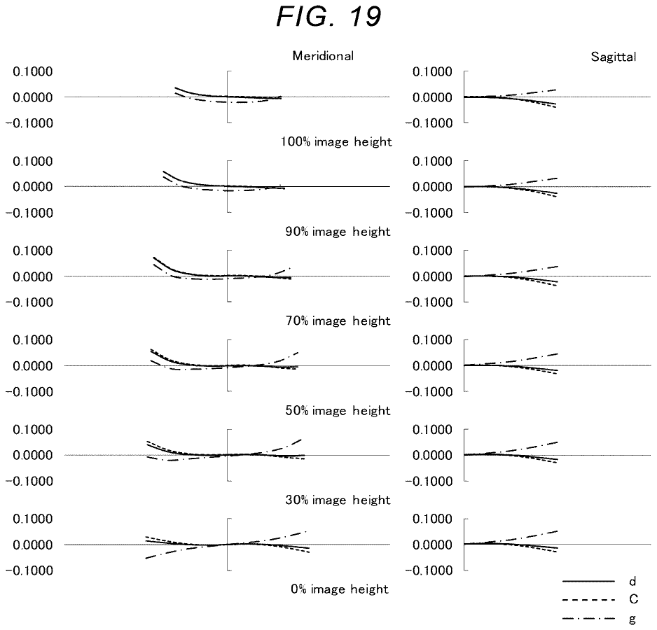

FIG. 20 is a lateral aberration diagram of the telephoto end in a case of focusing at an object distance of 2.5 m in Example 2 of the variable magnification imaging optical system according to the present invention.

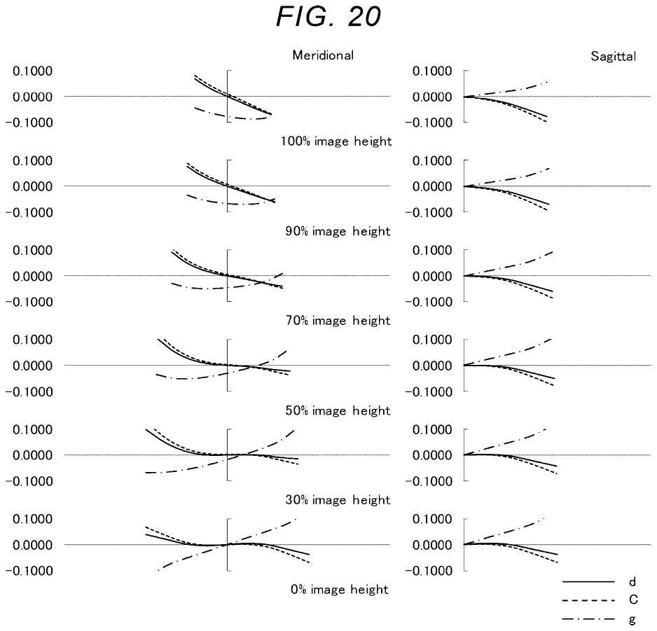

FIG. 21 is a lens configuration diagram of a wide-angle end in a case of focusing on infinity in Example 3 of the variable magnification imaging optical system according to the present invention.

FIG. 22 is a longitudinal aberration diagram of the wide-angle end in a case of focusing on infinity in Example 3 of the variable magnification imaging optical system according to the present invention.

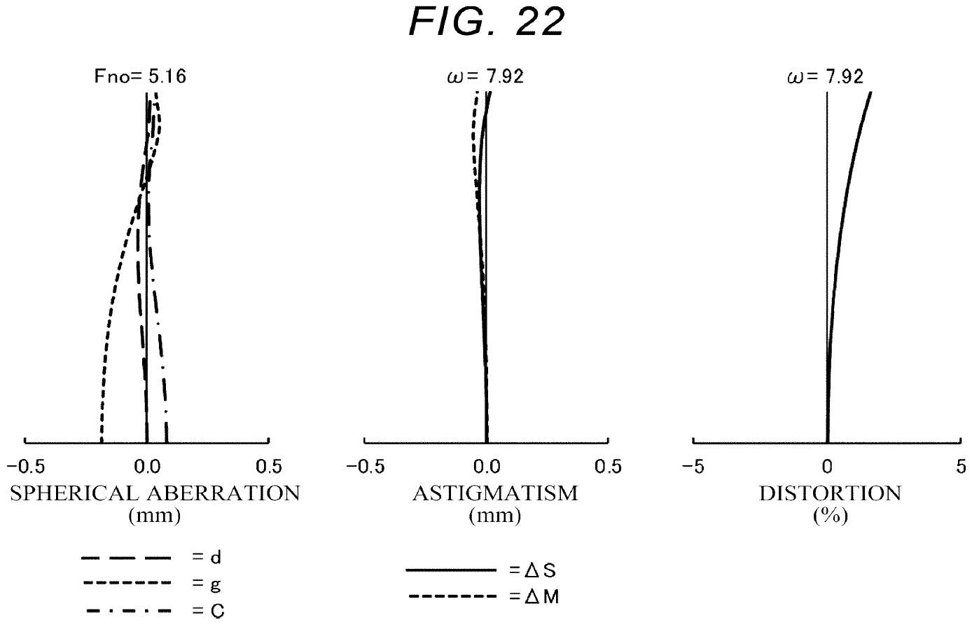

FIG. 23 is a longitudinal aberration diagram of a middle focal length in a case of focusing on infinity in Example 3 of the variable magnification imaging optical system according to the present invention.

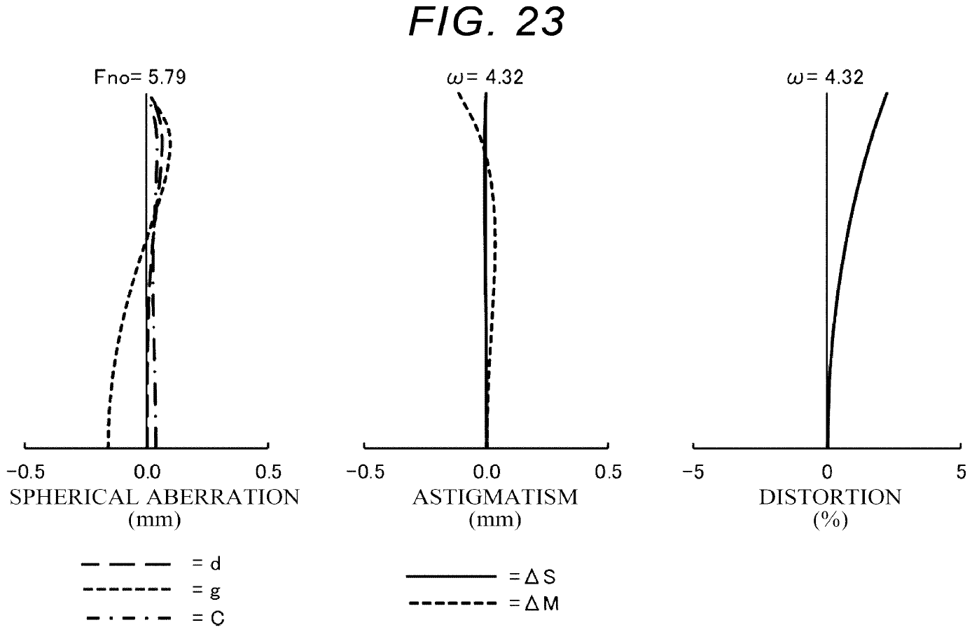

FIG. 24 is a longitudinal aberration diagram of a telephoto end in a case of focusing on infinity in Example 3 of the variable magnification imaging optical system according to the present invention.

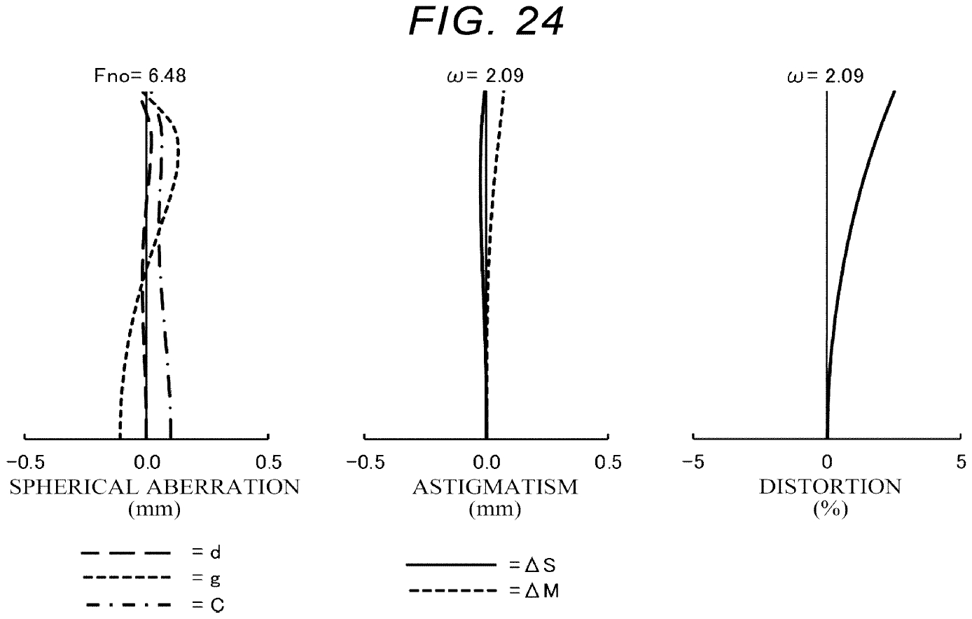

FIG. 25 is a lateral aberration diagram of the wide-angle end in a case of focusing on infinity in Example 3 of the variable magnification imaging optical system according to the present invention.

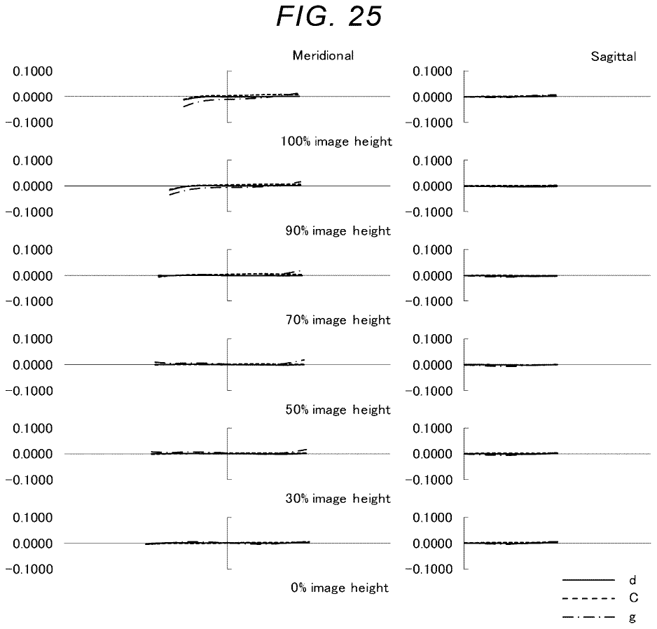

FIG. 26 is a lateral aberration diagram of the middle focal length in a case of focusing on infinity in Example 3 of the variable magnification imaging optical system according to the present invention.

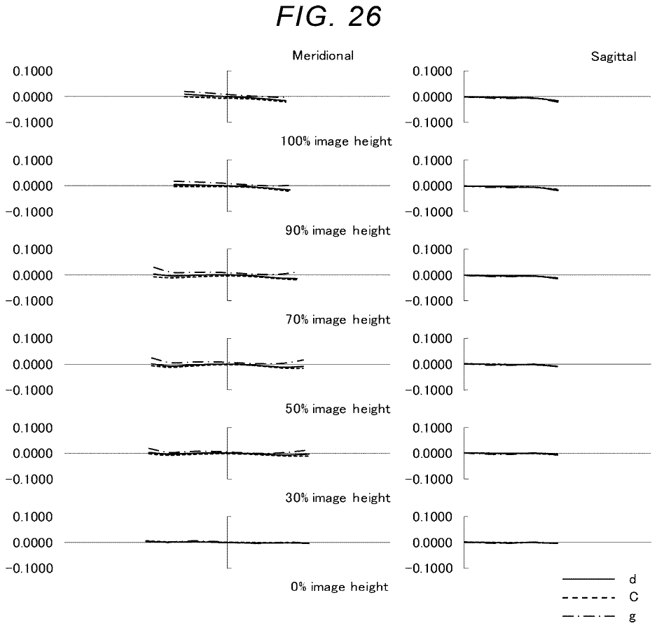

FIG. 27 is a lateral aberration diagram of the telephoto end in a case of focusing on infinity in Example 3 of the variable magnification imaging optical system according to the present invention.

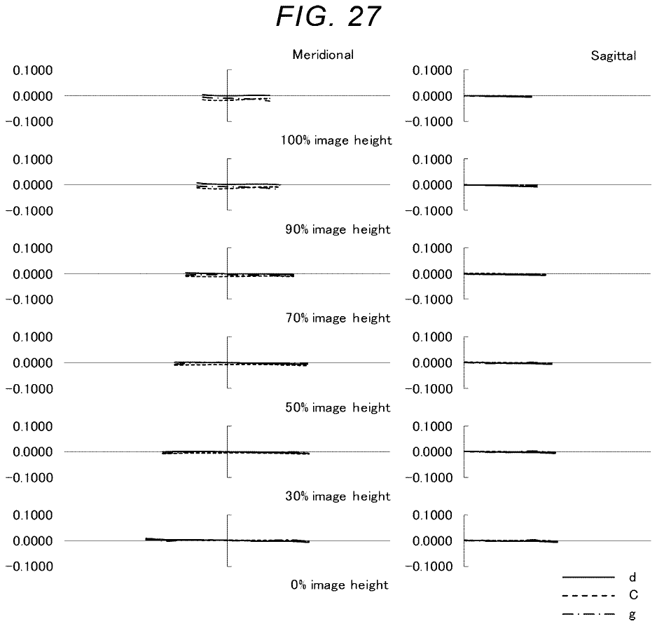

FIG. 28 is a lateral aberration diagram of the wide-angle end in a case of focusing at an object distance of 2.5 m in Example 3 of the variable magnification imaging optical system according to the present invention.

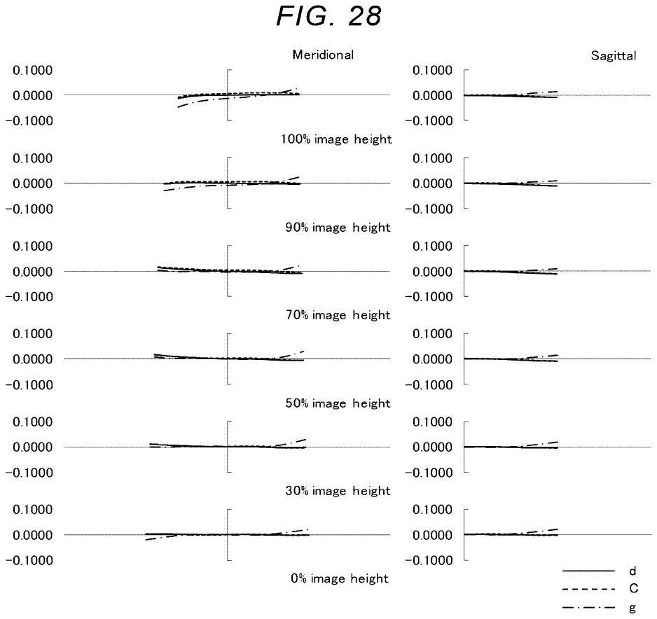

FIG. 29 is a lateral aberration diagram of the middle focal length in a case of focusing at an object distance of 2.5 m in Example 3 of the variable magnification imaging optical system according to the present invention.

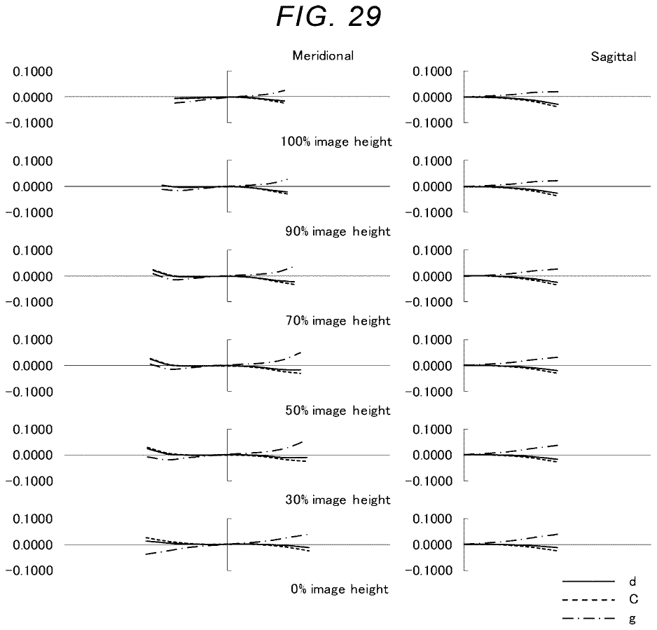

FIG. 30 is a lateral aberration diagram of the telephoto end in a case of focusing at an object distance of 2.5 m in Example 3 of the variable magnification imaging optical system according to the present invention.

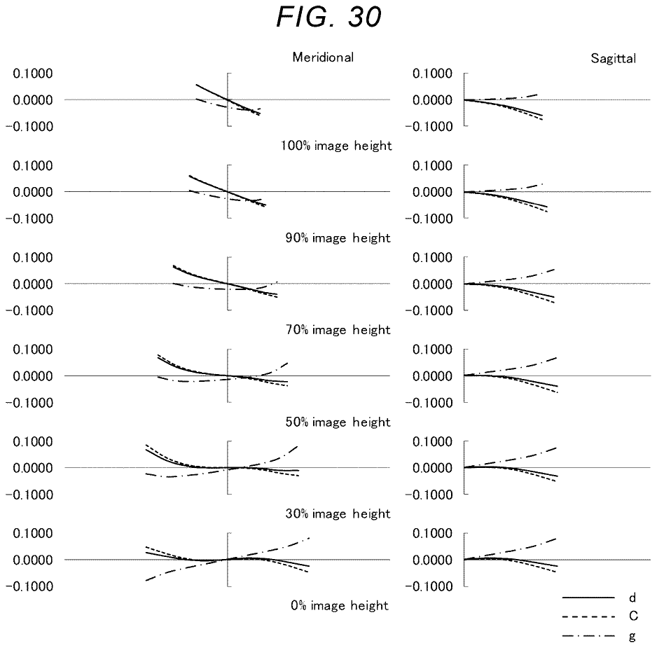

FIG. 31 is a lens configuration diagram of a wide-angle end in a case of focusing on infinity in Example 4 of the variable magnification imaging optical system according to the present invention.

FIG. 32 is a longitudinal aberration diagram of the wide-angle end in a case of focusing on infinity in Example 4 of the variable magnification imaging optical system according to the present invention.

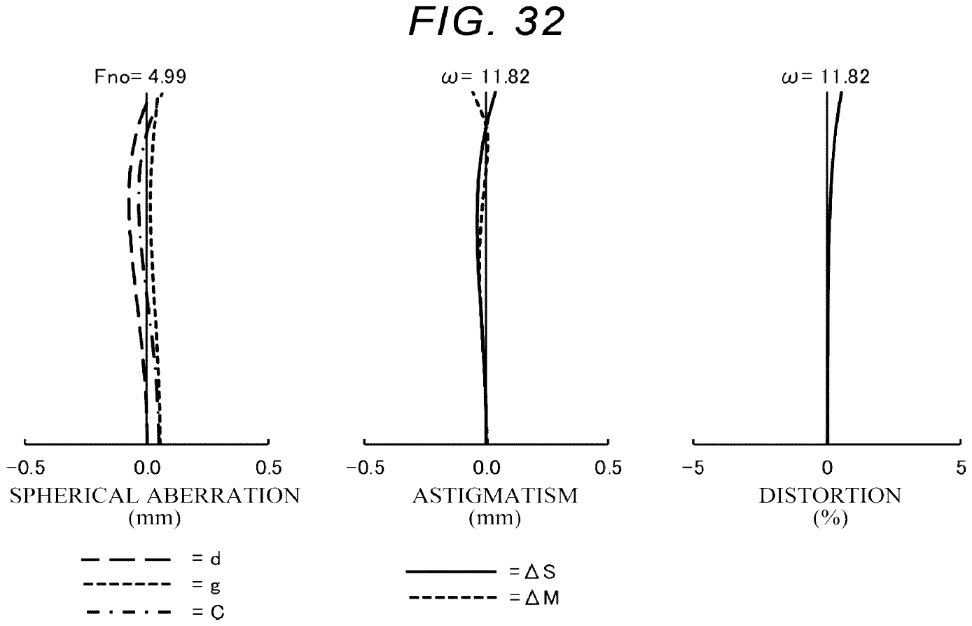

FIG. 33 is a longitudinal aberration diagram of a middle focal length in a case of focusing on infinity in Example 4 of the variable magnification imaging optical system according to the present invention.

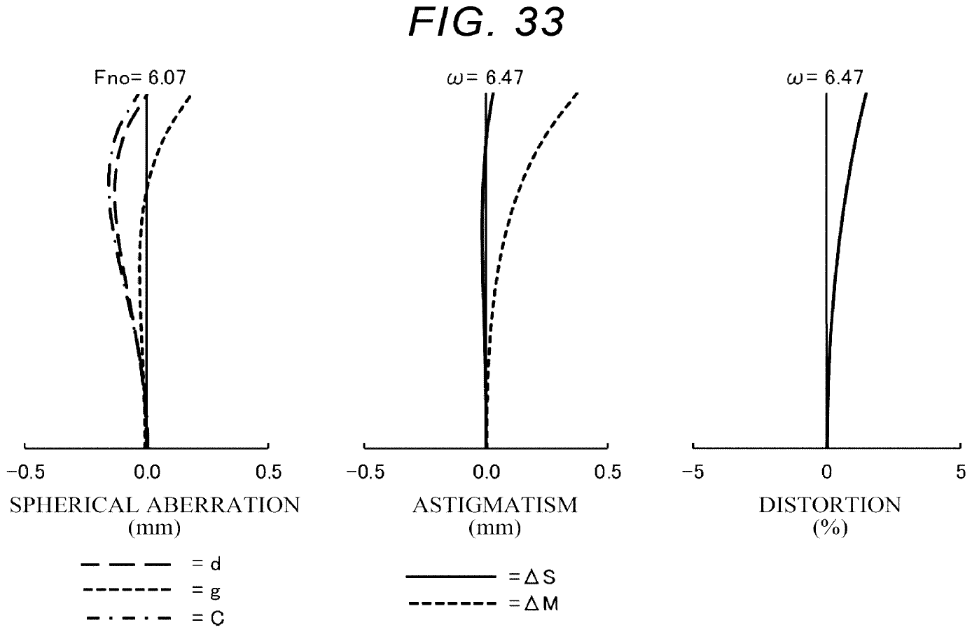

FIG. 34 is a longitudinal aberration diagram of a telephoto end in a case of focusing on infinity in Example 4 of the variable magnification imaging optical system according to the present invention.

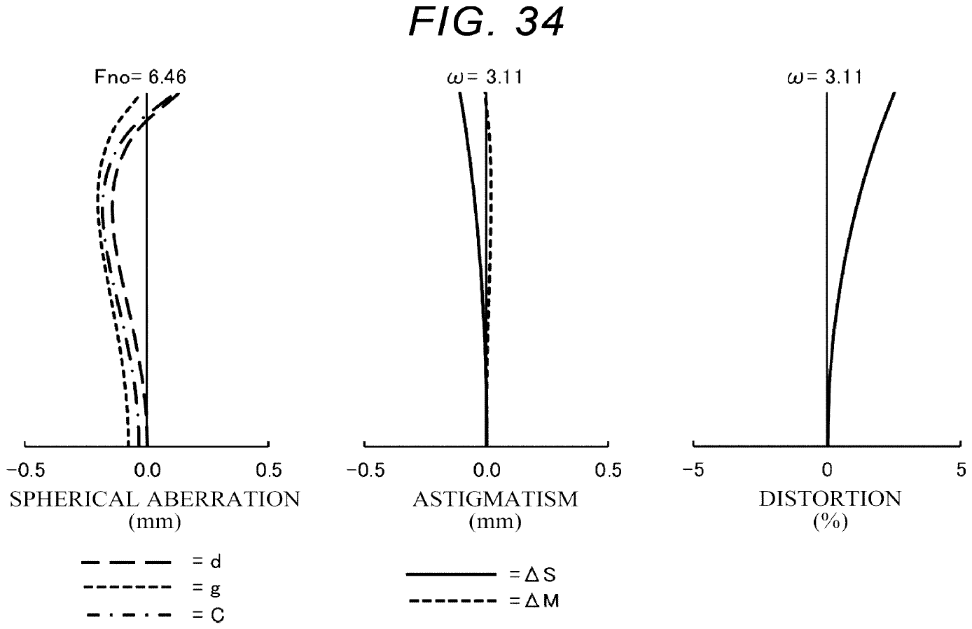

FIG. 35 is a lateral aberration diagram of the wide-angle end in a case of focusing on infinity in Example 4 of the variable magnification imaging optical system according to the present invention.

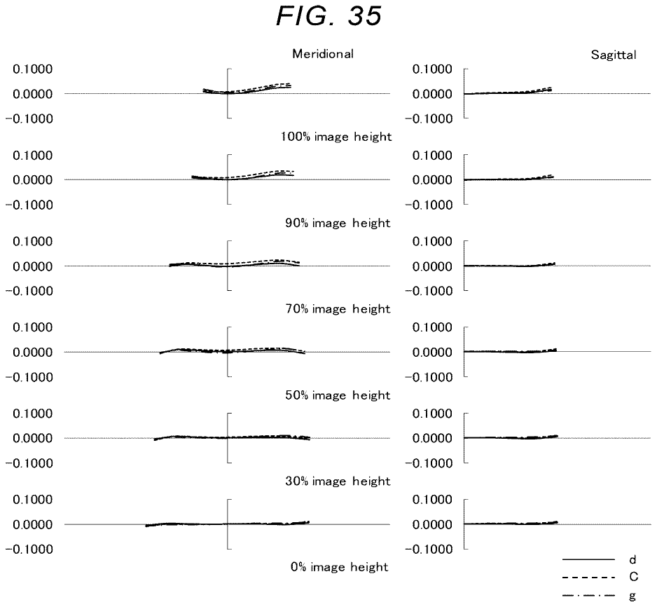

FIG. 36 is a lateral aberration diagram of the middle focal length in a case of focusing on infinity in Example 4 of the variable magnification imaging optical system according to the present invention.

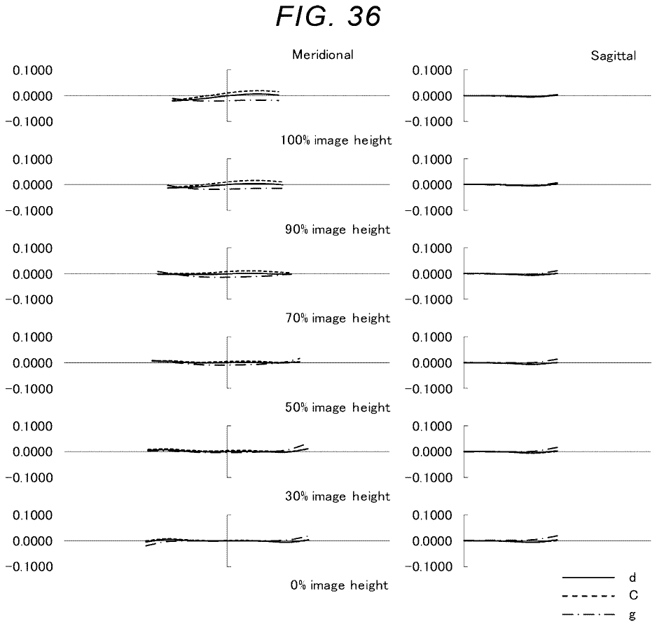

FIG. 37 is a lateral aberration diagram of the telephoto end in a case of focusing on infinity in Example 4 of the variable magnification imaging optical system according to the present invention.

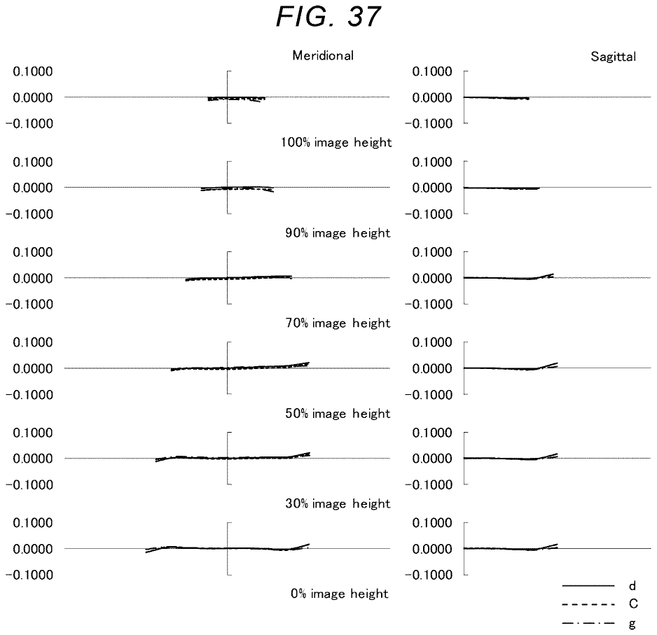

FIG. 38 is a lateral aberration diagram of the wide-angle end in a case of focusing at an object distance of 1.7 m in Example 4 of the variable magnification imaging optical system according to the present invention.

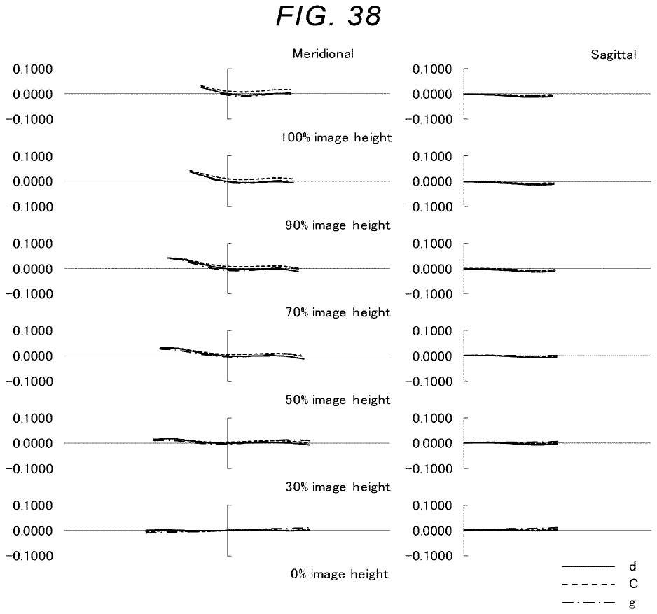

FIG. 39 is a lateral aberration diagram of the middle focal length in a case of focusing at an object distance of 1.7 m in Example 4 of the variable magnification imaging optical system according to the present invention.

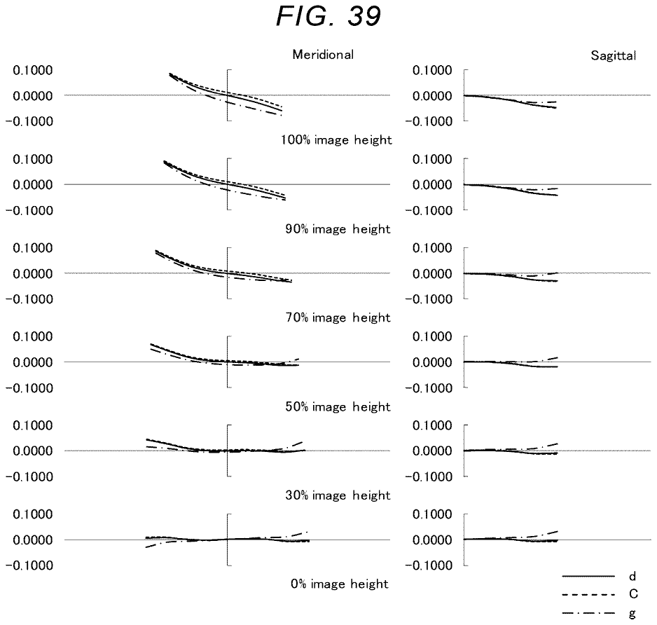

FIG. 40 is a lateral aberration diagram of the telephoto end in a case of focusing at an object distance of 1.7 m in Example 4 of the variable magnification imaging optical system according to the present invention.

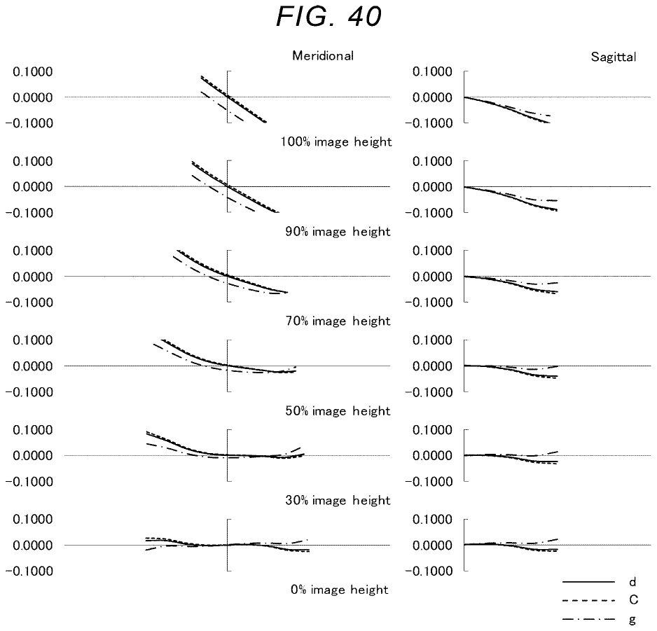

FIG. 41 is a lens configuration diagram of a wide-angle end in a case of focusing on infinity in Example 5 of the variable magnification imaging optical system according to the present invention.

FIG. 42 is a longitudinal aberration diagram of the wide-angle end in a case of focusing on infinity in Example 5 of the variable magnification imaging optical system according to the present invention.

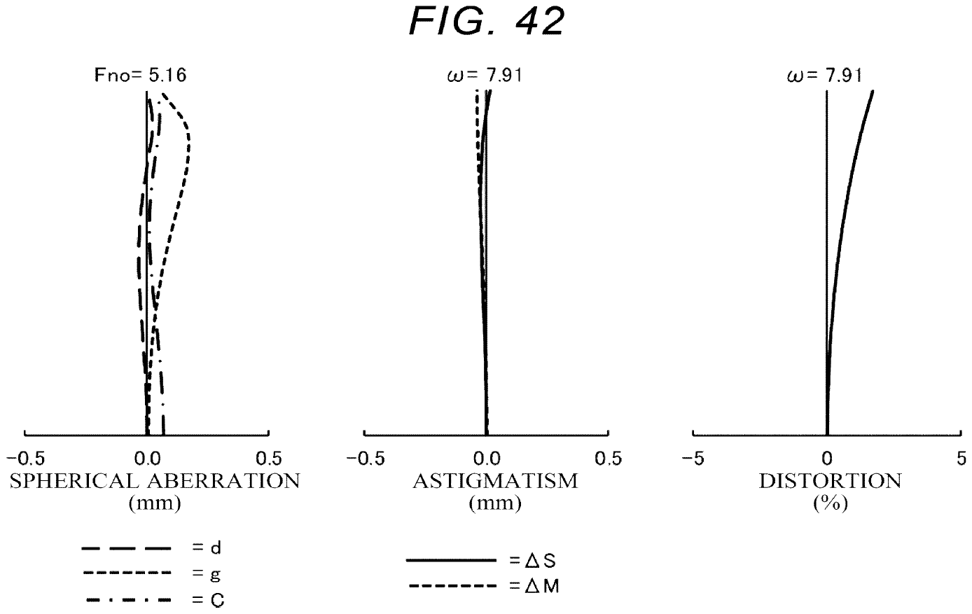

FIG. 43 is a longitudinal aberration diagram of a middle focal length in a case of focusing on infinity in Example 5 of the variable magnification imaging optical system according to the present invention.

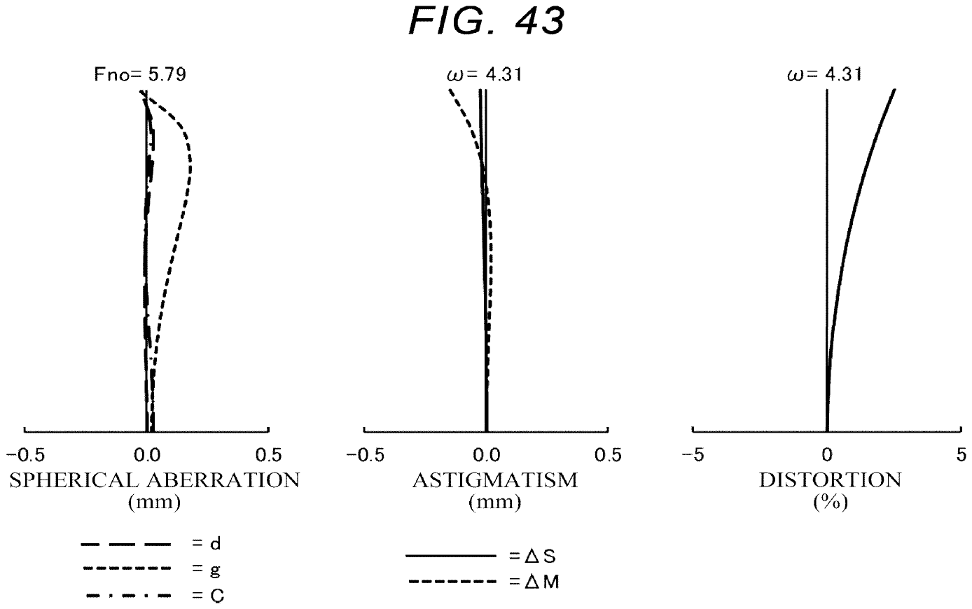

FIG. 44 is a longitudinal aberration diagram of a telephoto end in a case of focusing on infinity in Example 5 of the variable magnification imaging optical system according to the present invention.

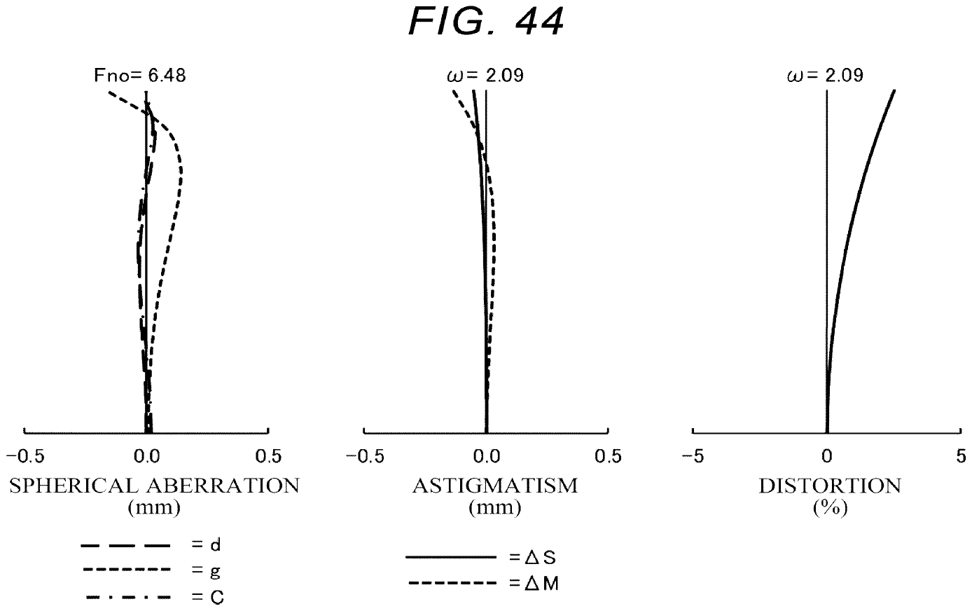

FIG. 45 is a lateral aberration diagram of the wide-angle end in a case of focusing on infinity in Example 5 of the variable magnification imaging optical system according to the present invention.

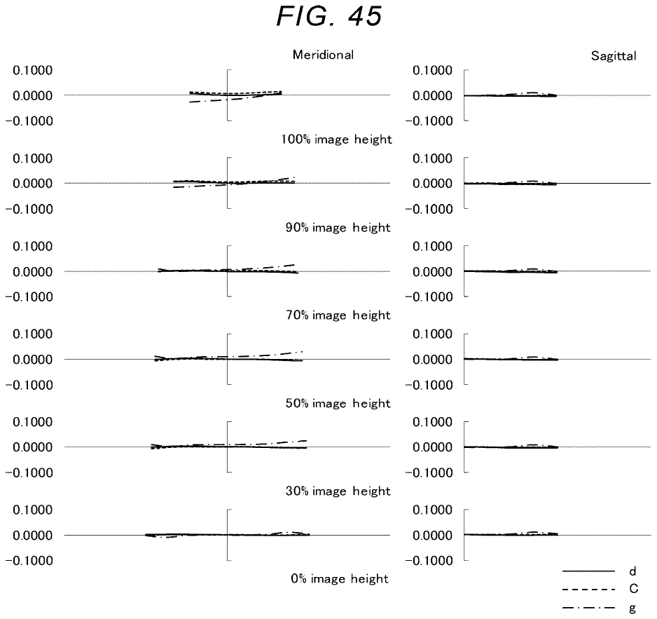

FIG. 46 is a lateral aberration diagram of the middle focal length in a case of focusing on infinity in Example 5 of the variable magnification imaging optical system according to the present invention.

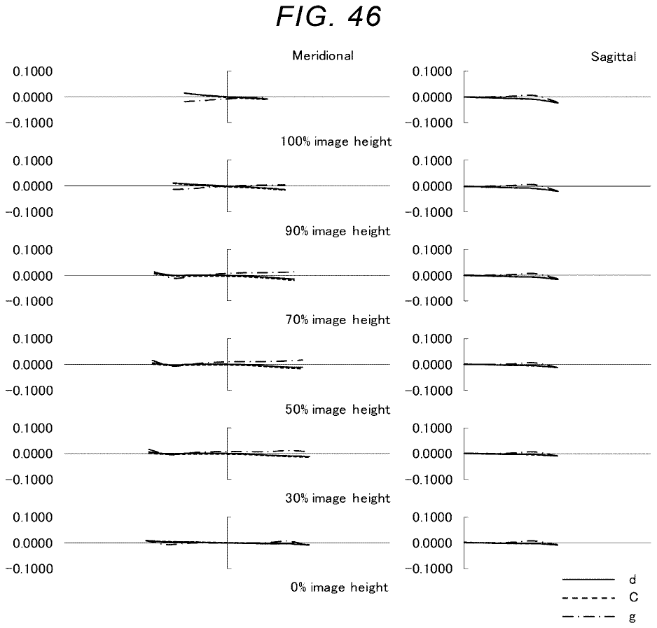

FIG. 47 is a lateral aberration diagram of the telephoto end in a case of focusing on infinity in Example 5 of the variable magnification imaging optical system according to the present invention.

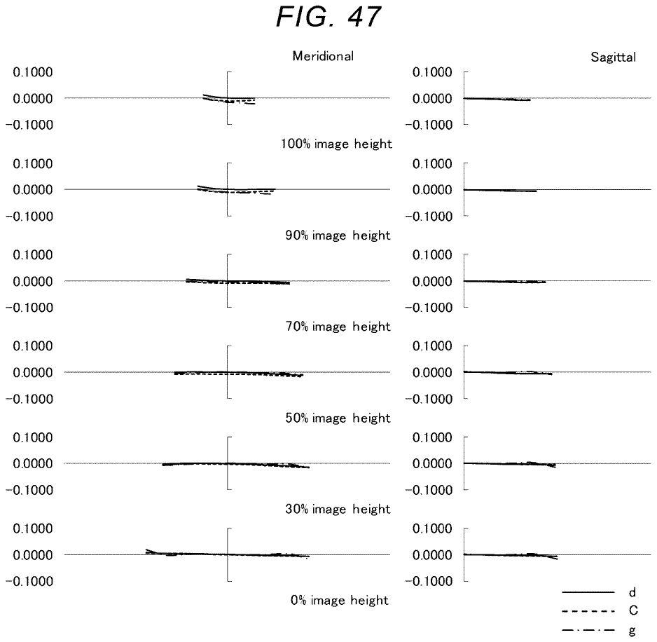

FIG. 48 is a lateral aberration diagram of the wide-angle end in a case of focusing at an object distance of 2.5 m in Example 5 of the variable magnification imaging optical system according to the present invention.

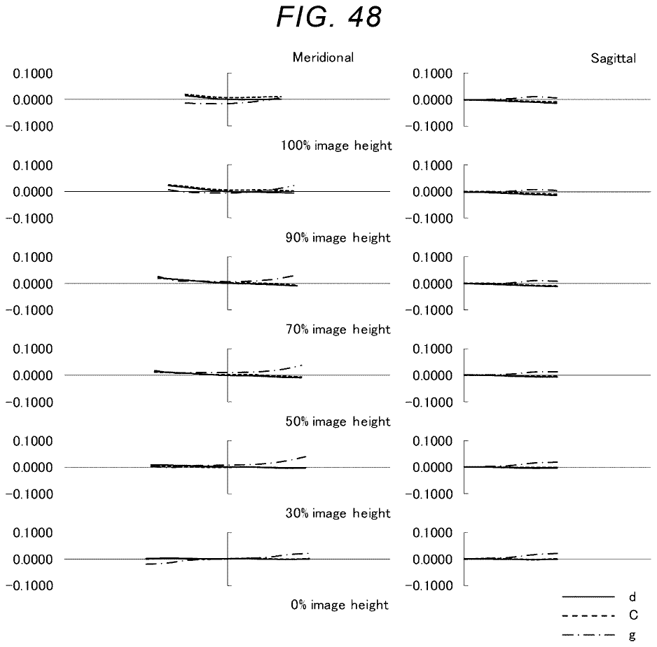

FIG. 49 is a lateral aberration diagram of the middle focal length in a case of focusing at an object distance of 2.5 m in Example 5 of the variable magnification imaging optical system according to the present invention.

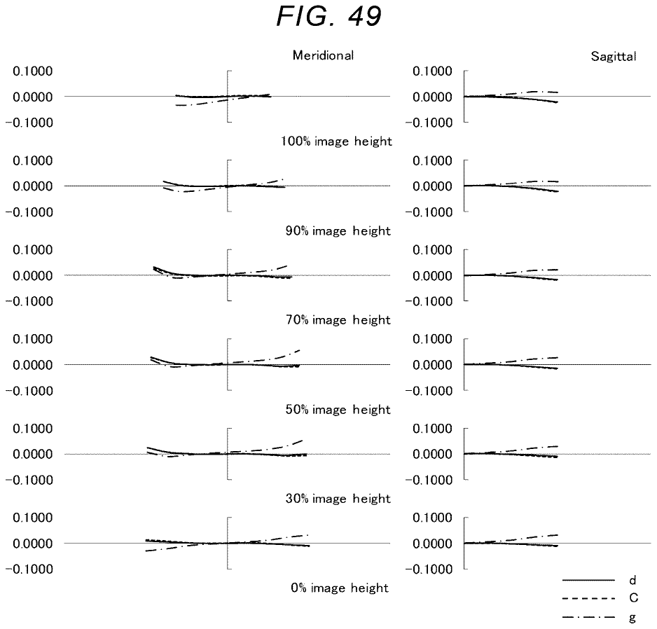

FIG. 50 is a lateral aberration diagram of the telephoto end in a case of focusing at an object distance of 2.5 m in Example 5 of the variable magnification imaging optical system according to the present invention.

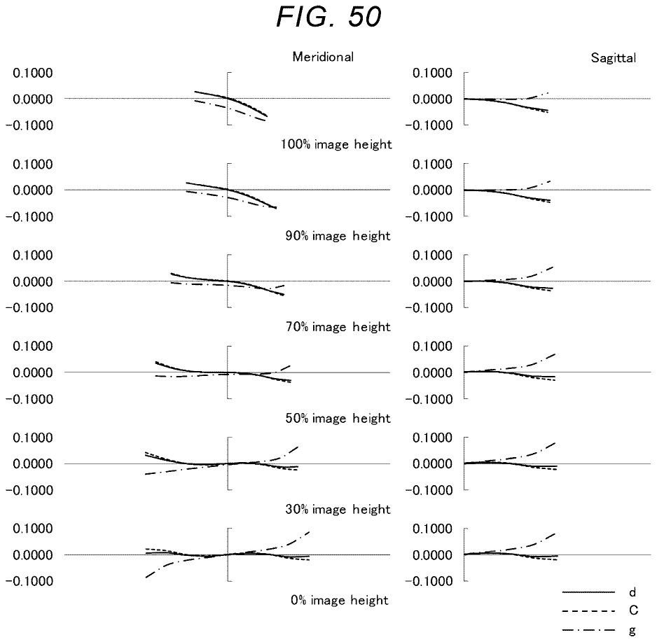

FIG. 51 is a lens configuration diagram of a wide-angle end in a case of focusing on infinity in Example 6 of the variable magnification imaging optical system according to the present invention.

FIG. 52 is a longitudinal aberration diagram of the wide-angle end in a case of focusing on infinity in Example 6 of the variable magnification imaging optical system according to the present invention.

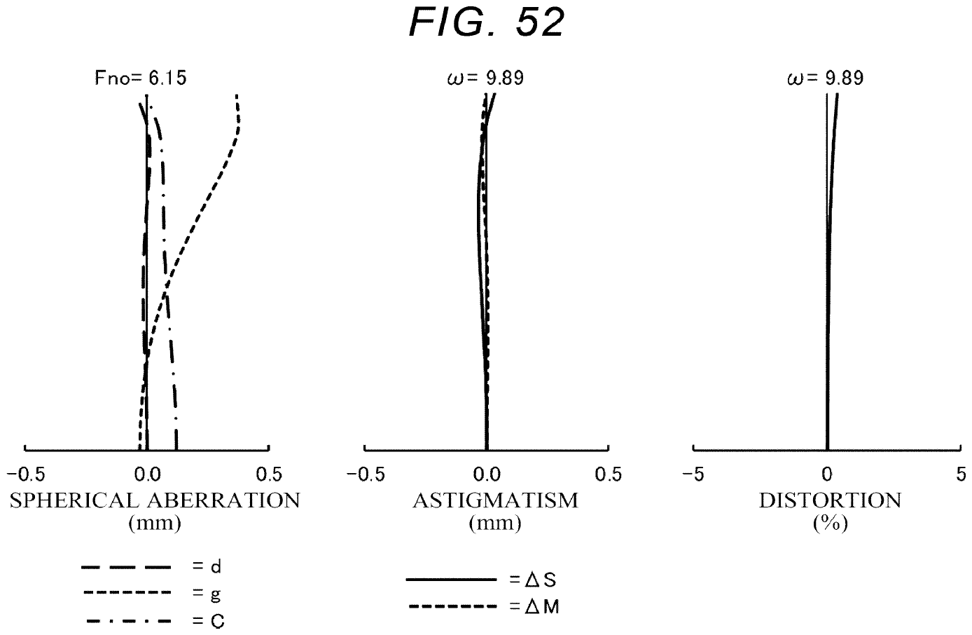

FIG. 53 is a longitudinal aberration diagram of a middle focal length in a case of focusing on infinity in Example 6 of the variable magnification imaging optical system according to the present invention.

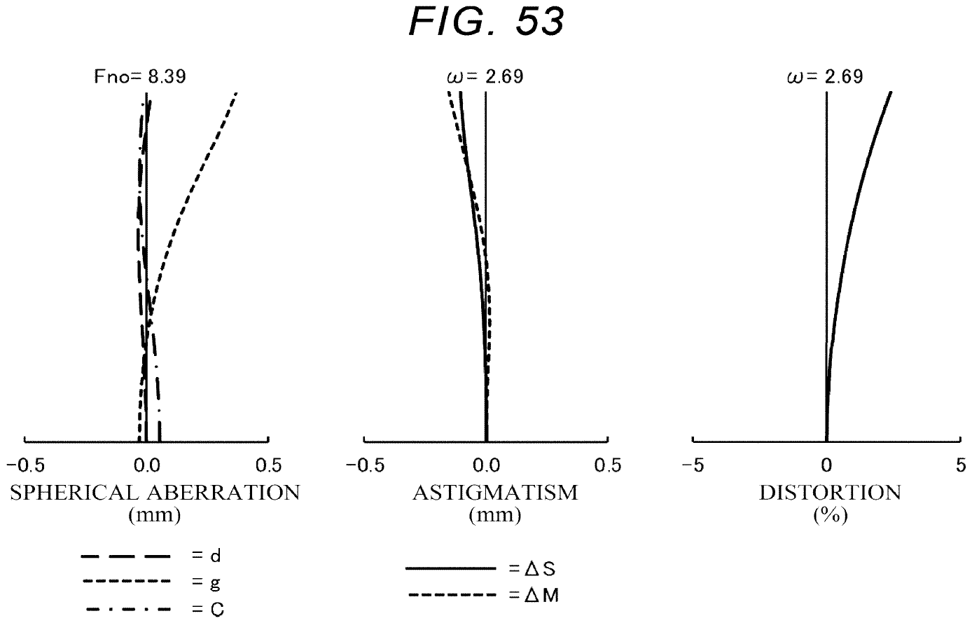

FIG. 54 is a longitudinal aberration diagram of a telephoto end in a case of focusing on infinity in Example 6 of the variable magnification imaging optical system according to the present invention.

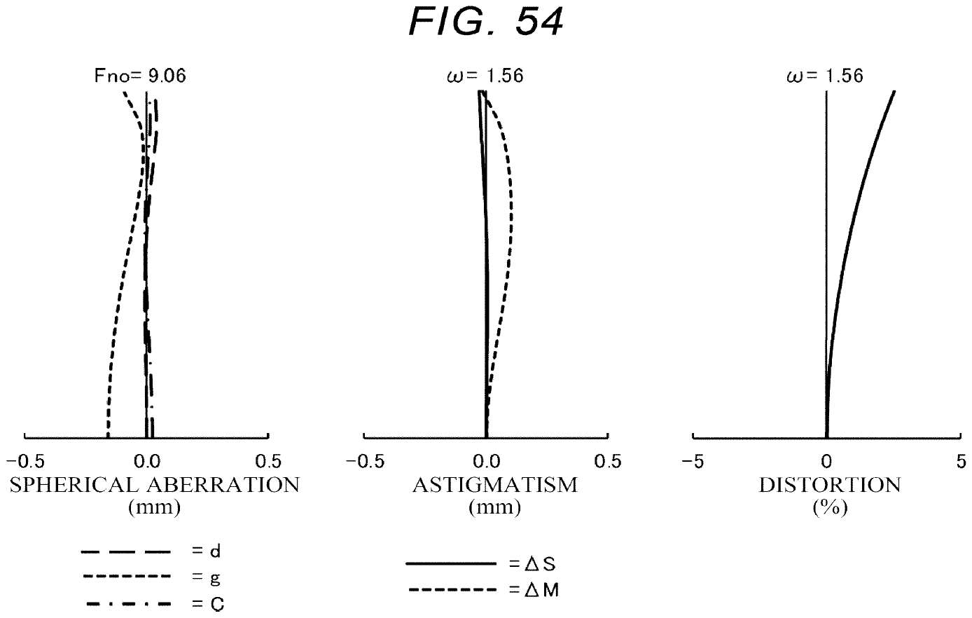

FIG. 55 is a lateral aberration diagram of the wide-angle end in a case of focusing on infinity in Example 6 of the variable magnification imaging optical system according to the present invention.

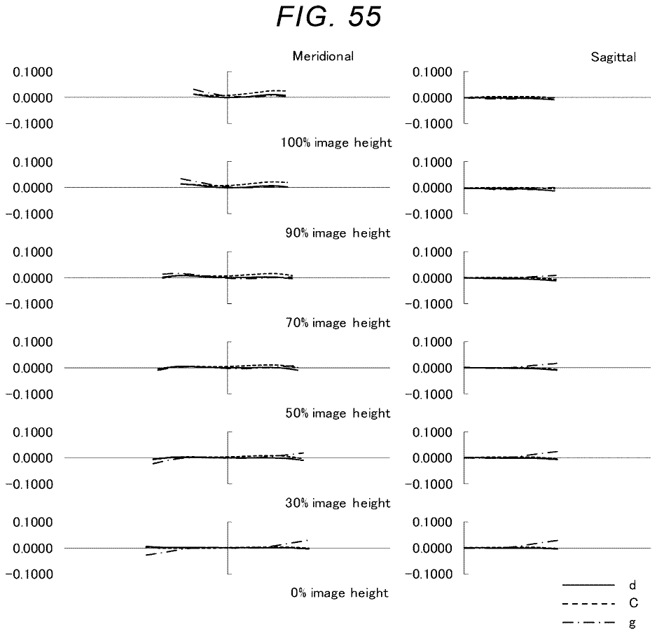

FIG. 56 is a lateral aberration diagram of the middle focal length in a case of focusing on infinity in Example 6 of the variable magnification imaging optical system according to the present invention.

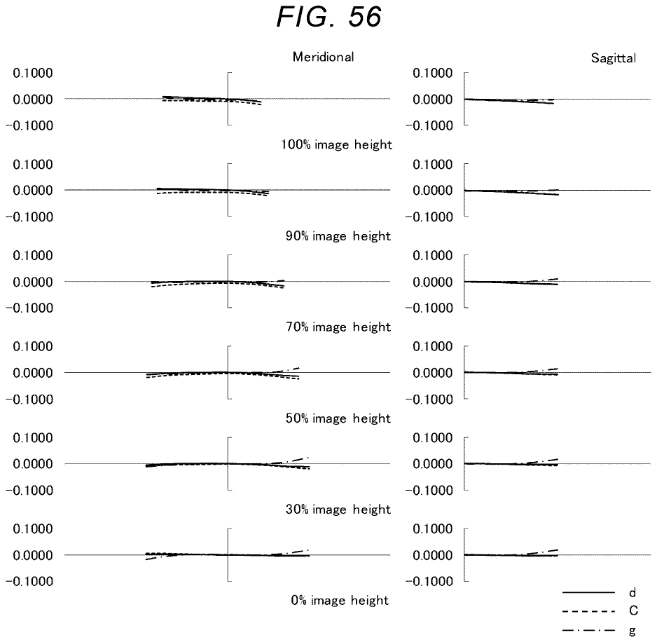

FIG. 57 is a lateral aberration diagram of the telephoto end in a case of focusing on infinity in Example 6 of the variable magnification imaging optical system according to the present invention.

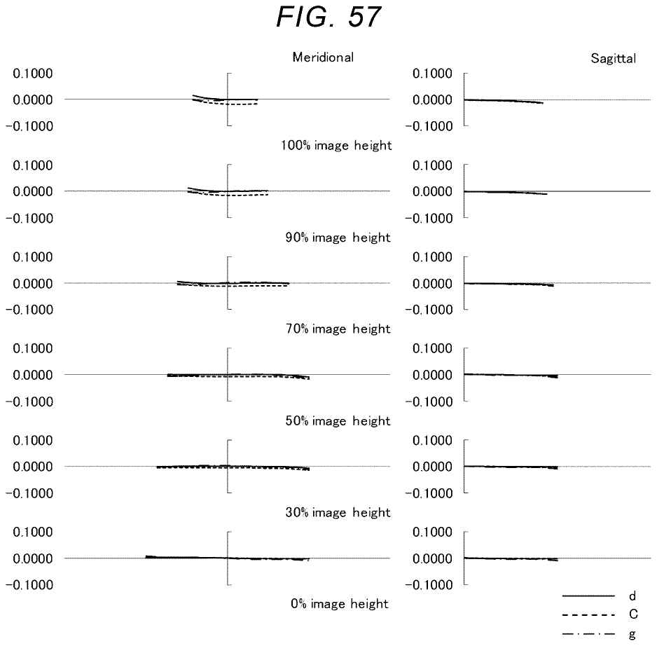

FIG. 58 is a lateral aberration diagram of the wide-angle end in a case of focusing at an object distance of 2.5 m in Example 6 of the variable magnification imaging optical system according to the present invention.

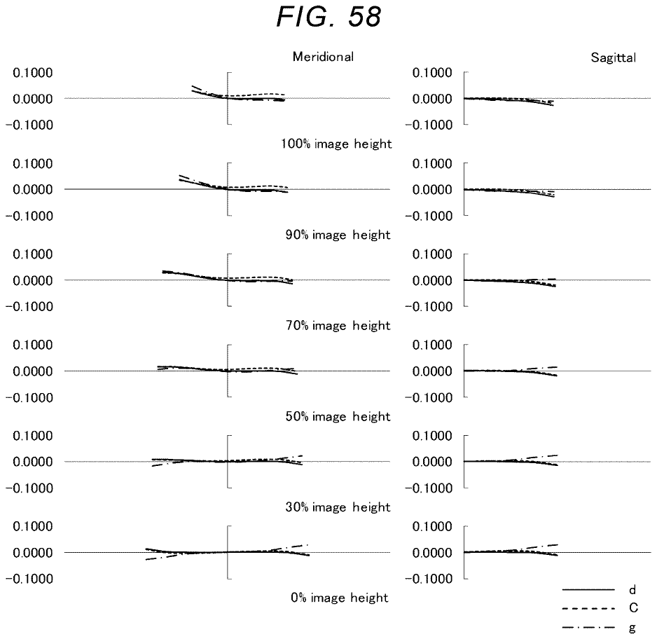

FIG. 59 is a lateral aberration diagram of the middle focal length in a case of focusing at an object distance of 2.5 m in Example 6 of the variable magnification imaging optical system according to the present invention.

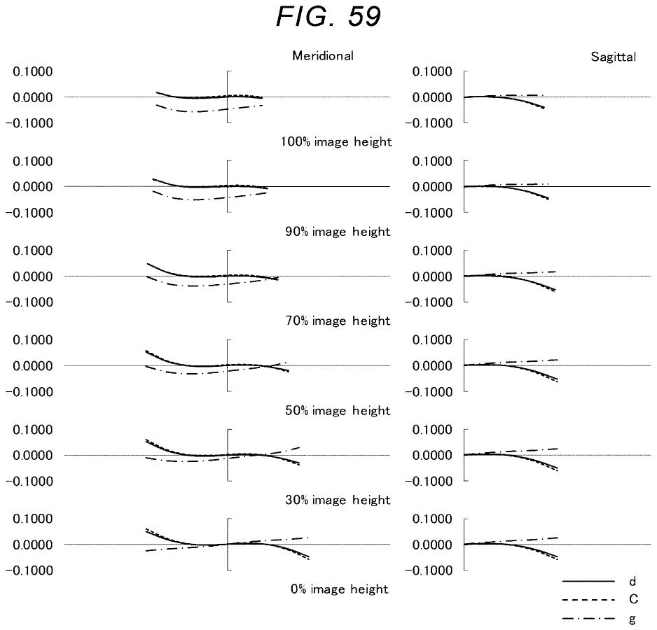

FIG. 60 is a lateral aberration diagram of the telephoto end in a case of focusing at an object distance of 3.3 m in Example 6 of the variable magnification imaging optical system according to the present invention.

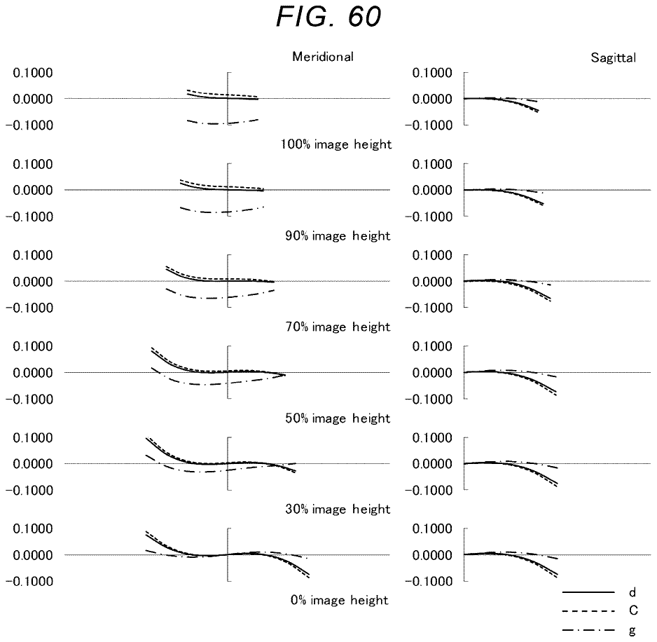

### EMBODIMENTS FOR CARRYING OUT THE INVENTION

Hereinafter, the variable magnification imaging optical system according to the embodiment of the present invention will be described. The following description of examples describes an example of the variable magnification imaging optical system according to the present invention, and the present invention is not limited to the present examples and can be modified within the scope of the gist of the present invention. For example, a surface formed of a sphere or a plane may be aspherical surface, an optical element material to be used may be a crystal material or plastic other than optical glass, a diffractive optical element may be used, or an antireflection film may be applied to a lens surface. In addition, the object side is described as front and the image side is described as rear.

In the description of the embodiment of the present invention, in a case where the number of lenses is counted, a single lens is counted as one lens, and in a case of a cemented lens, each single lens constituting the cemented lens is counted as one lens, unless otherwise specified. For example, in a case of a cemented lens consisting of a convex lens and a concave lens, the cemented lens is counted as two lenses. In a case of a lens having a shape or a structure that has an aberration correction effect with a resin or the like on a lens serving as a substrate, such as a compound aspherical surface or a diffractive optical element, the substrate and the added shape or structure are considered to be integrated, and the lens is counted as one lens. A cemented resin layer of the cemented lens is not counted as a lens. Even in a case where the cemented resin of the cemented lens has an aberration correction effect, the resin portion is not counted as one lens by considering the structure added to one of the lenses to be cemented. A parallel plane plate such as a filter having no refractive power is not counted as a lens.

In addition, in the description of the embodiment of the present invention, the meniscus that specifies the shape of the lens refers to a shape in which surfaces on the object side and the image side have curvature radii of the same sign. For example, a meniscus negative lens having a convex surface toward the object side refers to a lens in which curvature radii of surfaces on the object side and the image side are both positive and the curvature radius of the surface on the image side is smaller. In a case of an aspherical lens, the lens shape is determined by a paraxial curvature radius.

In the description of the embodiment of the present invention, the lens group is defined by defining a surface in which a distance on the optical axis changes by magnification change or focusing as a boundary of each lens group. Accordingly, in a case where the aperture diaphragm S moves independently by magnification change or focusing, the aperture diaphragm S is treated as one lens group.

In the following description of examples, refractive indices of a material with respect to g-rays (wavelength: 435.8 nm), F-rays (486.1 nm), d-rays (587.6 nm), and C-rays (656.3 nm) are denoted by Ng, NF, Nd, and NC, respectively. An Abbe number vd, a partial dispersion ratio PgF, and an anomalous dispersion ΔPgF are represented as follows.

$$v d = ( N d - 1 ) / ( N F - NC )$$

$$PgF = ( N g - N F ) / ( N F - N C )$$

$$Δ PgF = PgF - 0.64833 + 0.0018 \times vd$$

In the description of the embodiment of the present invention, there is a description of a ray height such as an axial marginal ray height and an off-axis chief ray height. Since the ray height basically means a distance from the optical axis, the concept of positive and negative does not occur, and a direction away from the optical axis is treated as positive with the optical axis as 0. However, in a case of the off-axis chief ray of conditional expressions (9) and (10), a relationship between an image height of the off-axis chief ray and a height of the off-axis chief ray passing through the second lens group G2 is handled, and thus the concept of positive and negative arises.

In the super telephoto zoom lens such as the variable magnification imaging optical system according to the present invention, suppressing chromatic aberration is an essential factor for high performance. There are two types of chromatic aberration, that is, on-axis chromatic aberration and lateral chromatic aberration, and in order to suppress both types of chromatic aberration over the entire zoom range, it is important to appropriately select an optical glass material in accordance with the change in power arrangement.

In general, the lateral chromatic aberration of an optical system composed of thin lenses is given by (Reference Expression 1) as a sum of lenses, and can be considered as follows.

$$\sum ( h \cdot hb \cdot φ / v ) \qquad ( Reference Expression 1 )$$

h: axial marginal ray height
hb: off-axis chief ray height
φ: refractive power
v: Abbe number

The axial marginal ray is defined as a ray that passes through the diaphragm at a maximum height from the optical axis among rays included in the on-axis luminous flux, and the chief ray is defined as a ray that passes through a point at which the diaphragm surface and the optical axis intersect.

In a case where a lens having a positive refractive power is disposed on the object side of the diaphragm, a peripheral luminous flux passing through the lens passes through a quadrant opposite to the imaging position, and in a case of general optical glass, the peripheral luminous flux is imaged at a position with a lower image height as the wavelength is longer due to dispersion characteristics, and the C-rays are observed as a lateral chromatic aberration in an under direction. Similarly, in a case where a lens having a negative refractive power is disposed on the object side of the diaphragm, the opposite phenomenon to the above occurs. In addition, in a case where the lens is disposed on the image side of the diaphragm, the peripheral luminous flux passing through the lens passes through the same quadrant as the imaging position, and thus the opposite phenomenon to the case where the lens is disposed on the object side of the stop occurs.

Similarly, the on-axis chromatic aberration of the optical system composed of thin lenses is given by (Reference Expression 2) as a sum of lenses, and can be considered as follows.

$$\sum ( h \cdot h \cdot φ / v ) \qquad ( Reference Expression 2 )$$

h: axial marginal ray height
φ: refractive power
v: Abbe number

The axial marginal ray is defined as a ray that passes through the diaphragm at a maximum height from the optical axis among rays included in the on-axis luminous flux.

In (Reference Expression 2), in a case where the axial marginal ray height is focused on, the amount of on-axis chromatic aberration generated increases as the lens through which the axial marginal ray passes at a higher position with respect to the effective diameter increases, and the on-axis chromatic aberration is small or in the lens through which the axial marginal ray passes at a lower position. Accordingly, in order to suppress the on-axis chromatic aberration and the lateral chromatic aberration over the entire zoom range, it is necessary to appropriately select the optical glass material in accordance with the change in ray height of the axial marginal ray and the off-axis chief ray generated during magnification change.

In the super telephoto zoom lens in which the first lens group has a positive refractive power and the first lens group is largely moved out during magnification change from the wide-angle end to the telephoto end such that the distance between the first lens group and the aperture diaphragm is increased, as in the variable magnification imaging optical system according to the present invention, the lateral chromatic aberration in the C-ray over direction occurs on the wide angle side and in an under direction occurs on the telephoto side in many cases, and the chromatic aberration fluctuates due to magnification change. Therefore, in a case where the color is corrected for the g-rays and the C-rays, in a case where the difference in imaging magnification with respect to other wavelengths is large, color bleeding such as reddish purple appears on the contour of the subject as a secondary spectrum, which is not preferable.

This phenomenon occurs because, during magnification change from the wide angle side to the telephoto side, the first lens group is moved out, the distance between the first lens group and the aperture diaphragm is increased, and the power arrangement is changed such that the lens groups subsequent to the second lens group are closer to the aperture diaphragm, and thus the change in the lateral chromatic aberration in the first lens group is added to a large change in the correction effect of the lateral chromatic aberration in the lens groups subsequent to the second lens group. As the distance from the aperture diaphragm increases, the off-axis chief ray passes through a higher position away from the optical axis, and the change in ray height brings about the change in the lateral chromatic aberration as shown in (Reference Expression 1).

In addition, it is effective to appropriately dispose the glass material having the anomalous dispersion in accordance with the change in the correction effect of the lateral chromatic aberration by magnification change in order to correct the secondary spectrum. For example, in a case where the color is corrected for the g-rays and the C-rays and the secondary spectrum is a problem for the d-rays, in a case where the color is corrected for the d-rays and the C-rays, the g-rays are under-corrected. However, in a case where the glass material having the anomalous dispersion is used, the under-correction of the g-rays can be compensated for, and as a result, the secondary spectrum can be reduced. Hereinafter, the embodiment of the present invention in which the secondary spectrum is suppressed and the lateral chromatic aberration is effectively corrected over the entire zoom range will be described focusing on the correction of the g-rays.

As can be seen from the numerical examples and the configuration diagrams of each example, a variable magnification imaging optical system according to the present invention, the variable magnification imaging optical system consists of, in order from an object side, a first lens group G1 having a positive refractive power, a second lens group G2 having a positive refractive power, a third lens group G3 having a negative refractive power, a middle group GM including an aperture diaphragm S consisting of one or more lens groups, a focusing group GF, and a subsequent group GR consisting of one lens group, in which a distance between adjacent lens groups changes during magnification change, and the focusing group GF moves along an optical axis during focusing from an infinite distance object to a close distance object.

The first lens group G1 having a positive refractive power, the second lens group G2 having a positive refractive power, and the third lens group G3 having a negative refractive power change such that the first lens group G1 moves to the object side, the distance between the first lens group G1 and the second lens group G2 increases, and the distance between the second lens group G2 and the third lens group G3 decreases during magnification change from the wide-angle end to the telephoto end, thereby obtaining a main magnification effect of the variable magnification imaging optical system. In addition, it is preferable that the second lens group G2 moves to the image side during magnification change from the wide-angle end to the telephoto end to increase the correction effect of the lateral chromatic aberration described below.

During magnification change from the wide-angle end to the telephoto end, the first lens group G1 having a positive refractive power moves to the object side, the distance between the first lens group G1 and the second lens group G2 increases, the distance between the second lens group G2 and the third lens group G3 decreases, the lens group including the aperture diaphragm S moves to the object side, and the distance between the second lens group G2 and the aperture diaphragm S decreases, so that the off-axis chief ray that passes through a high position at the wide-angle end in the second lens group G2 changes to pass through a low position at the telephoto end, and the correction effect of lateral chromatic aberration of the second lens group G2 increases at the wide-angle end and decreases at the telephoto end.

On the other hand, the first lens group G1 moves to the object side on the telephoto side, and the distance between the first lens group G1 and the second lens group G2 increases, so that the axial marginal ray height in a case of focusing on infinity is lower in the second lens group G2 than in the first lens group G1, and the axial marginal ray height at the telephoto end is lower than the off-axis chief ray height at the maximum angle of view at the wide-angle end in the second lens group G2.

In addition, in the second lens group G2, the glass material having the positive anomalous dispersion is used for the concave lens, and the glass material having the negative anomalous dispersion is used for the convex lens, so that the g-rays can be corrected in the under direction on the wide angle side, and the lateral chromatic aberration is easily corrected.

The middle group GM including the aperture diaphragm S consisting of one or more lens groups has an effect of converging the luminous flux diverged in the third lens group G3, and has an effect of controlling the ray height of the rays incident on the focusing group GF to an appropriate height, contributes to weight reduction of the focusing group GF, and also plays a role of compensating for the image surface during magnification change.

The focusing group GF moves along the optical axis during focusing from the infinite distance object to the close distance object, and corrects a deviation of the imaging position in a case where the object distance changes.

The subsequent group GR consisting of one lens group plays a role of compensating for the image surface and correcting the lateral chromatic aberration that increases on the telephoto side. By using the glass material having the positive anomalous dispersion for the concave lens of the subsequent group GR and using the glass material having the negative anomalous dispersion for the convex lens, the effect of correcting the g-rays in the over direction occurs, and the lateral chromatic aberration on the telephoto side can be corrected. In addition, in the subsequent group GR, since the axial marginal ray passes through at a lower ray height than the off-axis chief ray, the correction effect of the lateral chromatic aberration has a characteristic of being larger at a higher image height while the on-axis chromatic aberration is minimized.

On the other hand, in a case where the lateral chromatic aberration on the telephoto side is corrected by using the glass material having the positive anomalous dispersion for the concave lens and using the glass material having the negative anomalous dispersion for the convex lens in the subsequent group GR, the g-rays are excessively corrected on the over side on the wide angle side, and the lateral chromatic aberration is deteriorated. The deterioration of the lateral chromatic aberration on the wide angle side is offset by the correction effect of the lateral chromatic aberration in the second lens group G2 having a large effect of correcting the g-rays in the under direction on the wide angle side, and thus the lateral chromatic aberration can be favorably corrected over the entire range from the wide-angle end to the telephoto end.

In the variable magnification imaging optical system according to the present invention, in order to effectively correct the lateral chromatic aberration generated on the telephoto side, it is desirable that one or more concave lenses satisfying the following conditional expression (1) are disposed between the aperture diaphragm S and the subsequent group GR.

$$Δ PgFLnSr > 0.013 \qquad ( 1 )$$

ΔPgFLnSr: anomalous dispersion of the concave lens disposed between the aperture diaphragm S and the subsequent group GR

In the variable magnification imaging optical system according to the present invention, the rays on the short wavelength side, particularly on the short wavelength side of the g-rays, are under-corrected on the telephoto side, and the imaging magnification is reduced, and the lateral chromatic aberration in the under direction remains. In order to effectively correct this, it is desirable that the concave lens in the group behind the aperture diaphragm S uses the glass material having a large ΔPgF and strong positive anomalous dispersion. By satisfying conditional expression (1), it is possible to effectively correct the lateral chromatic aberration generated on the telephoto side.

In a case where the value of conditional expression (1) is below the lower limit and the anomalous dispersion of the concave lens disposed between the aperture diaphragm S and the subsequent group GR becomes small, the effect of correcting the g-rays in the over direction at the peripheral image height on the telephoto side is reduced, and it is difficult to correct the lateral chromatic aberration over the entire zoom range.

By setting the lower limit value of conditional expression (1) to 0.015 in a desirable manner and to 0.020 in a more desirable manner, it is possible to more reliably obtain the above-described effect.

In the variable magnification imaging optical system according to the present invention, in order to achieve both reduction in total length of the optical system and high performance, it is desirable that the first lens group G1 includes a concave lens satisfying conditional expression (2).

$$ndLN 1 < 1.8 \qquad ( 2 )$$

ndLN1: refractive index of concave lens having a highest refractive index included in first lens group G1

Conditional expression (2) specifies the refractive index of the concave lens having the highest refractive index included in the first lens group G1. In the super telephoto zoom lens having a narrow angle of view, such as the variable magnification imaging optical system according to the present invention, suppressing chromatic aberration is essential for high performance. In order to suppress chromatic aberration generated in the first lens group having a positive refractive power, a special low dispersion lens having a large positive anomalous dispersion or glass material such as a fluorite is used for the convex lens, and the concave lens is combined therewith to have a color correction effect. However, in a case where a high refractive index glass material is used for the concave lens, a Petzval sum is deteriorated, and it is difficult to ensure flatness of the image surface. By including the concave lens satisfying conditional expression (2) in the first lens group G1, it is possible to achieve both reduction in total length of the optical system and high performance.

In a case where the upper limit value of conditional expression (2) is exceeded and the refractive index of the concave lens having the highest refractive index included in the first lens group G1 becomes large, the Petzval sum is deteriorated, and it is difficult to ensure flatness of the image surface, which is not preferable.

By setting the upper limit value of conditional expression (2) to 1.75 in a desirable manner and to 1.73 in a more desirable manner, it is possible to more reliably obtain the above-described effect.

In addition, in the variable magnification imaging optical system according to the present invention, conditional expressions (3) to (6) specify a relationship between distances between the second lens group G2 and lens groups before and after the second lens group G2, which is required to effectively correct the lateral chromatic aberration of the second lens group G2 that fluctuates due to zooming from the wide-angle end to the telephoto end.

In the variable magnification imaging optical system according to the present invention, it is desirable that the following conditional expression (3) is satisfied in order to effectively correct the lateral chromatic aberration of the second lens group G2 that fluctuates due to zooming from the wide-angle end to the telephoto end.

$$0.005 < DG 1 G 2 W / DG 1 G 2 T < 0.400 \qquad ( 3 )$$

DG1G2W: distance between first lens group G1 and second lens group G2 on optical axis at infinity wide-angle end
DG1G2T: distance between first lens group G1 and second lens group G2 on optical axis at infinity telephoto end

Conditional expression (3) specifies a ratio of distances between the first lens group G1 and the second lens group G2 on the optical axis at the infinity wide-angle end and the infinity telephoto end. It is desirable that the second lens group G2 has a correction effect of the lateral chromatic aberration that corrects the g-rays in the under direction on the wide angle side, it is desirable that the off-axis chief ray height is higher on the wide angle side to increase the effect, and it is desirable that the axial marginal ray height passes through a lower position on the telephoto side as described above. Accordingly, it is desirable that the distance between the first lens group G1 and the second lens group G2 becomes smaller at the wide-angle end and larger at the telephoto end. By satisfying conditional expression (3), it is possible to achieve reduction in size while effectively correcting the lateral chromatic aberration.

In a case where the upper limit value of conditional expression (3) is exceeded and the ratio of the distances between the first lens group G1 and the second lens group G2 on the optical axis at the infinity wide-angle end and the infinity telephoto end becomes large, the distance between the first lens group G1 and the second lens group G2 at the telephoto end is reduced, the axial marginal ray height is not sufficiently reduced on the telephoto side, and the on-axis chromatic aberration is deteriorated, which is not preferable. In addition, in a case where the distance between the first lens group G1 and the second lens group G2 becomes large at the wide-angle end, it acts in a direction in which a total length of a product increases, which is also not preferable.

In a case where the value of conditional expression (3) is below the lower limit and the ratio of the distances between the first lens group G1 and the second lens group G2 on the optical axis at the infinity wide-angle end and the infinity telephoto end becomes small, the change in the off-axis chief ray in the second lens group G2 is excessively large during zooming from the infinity wide-angle end to the infinity telephoto end, and it is difficult to correct astigmatism and field curvature, which is not preferable.

By setting the lower limit value of conditional expression (3) to 0.009 in a desirable manner and setting the upper limit value to 0.250 in a desirable manner, it is possible to more reliably obtain the above-described effect.

In addition, in the variable magnification imaging optical system according to the present invention, it is desirable that the following conditional expression (4) is satisfied in order to effectively correct the lateral chromatic aberration of the second lens group G2 that fluctuates due to zooming from the wide-angle end to the telephoto end.

$$1. < D G 2 G 3 W / D G 2 G 3 T < 80.00 \qquad ( 4 )$$

DG2G3W: distance between second lens group G2 and third lens group G3 on optical axis at infinity wide-angle end
DG2G3T: distance between second lens group G2 and third lens group G3 on optical axis at infinity telephoto end

Conditional expression (4) specifies a ratio of distances between the second lens group G2 and the third lens group G3 on the optical axis at the infinity wide-angle end and the infinity telephoto end. It is desirable that the second lens group G2 has a correction effect of the lateral chromatic aberration that corrects the g-rays in the under direction on the wide angle side, it is desirable that the off-axis chief ray height is higher on the wide angle side to increase the effect, and it is desirable that the axial marginal ray height passes through a lower position on the telephoto side as described above. Accordingly, it is desirable that the distance between the second lens group G2 and the third lens group G3 becomes large at the wide-angle end and small at the telephoto end. By satisfying conditional expression (4), it is possible to effectively correct the lateral chromatic aberration.

In a case where the upper limit value of conditional expression (4) is exceeded and the ratio of the distances between the second lens group G2 and the third lens group G3 on the optical axis at the infinity wide-angle end and the infinity telephoto end becomes large, the change in the off-axis chief ray in the second lens group G2 is excessively large during zooming from the infinity wide-angle end to the infinity telephoto end, and it is difficult to correct astigmatism and field curvature, which is not preferable.

In a case where the value of conditional expression (4) is below the lower limit and the ratio of the distances between the second lens group G2 and the third lens group G3 on the optical axis at the infinity wide-angle end and the infinity telephoto end becomes small, the distance between the second lens group G2 and the third lens group G3 on the optical axis at the wide-angle end is reduced, the off-axis chief ray height is not sufficiently high on the wide angle side, and the correction effect of the lateral chromatic aberration that corrects the g-rays in the under direction is reduced, which is not preferable. In addition, in a case where the distance between the second lens group G2 and the third lens group G3 on the optical axis is large at the telephoto end, the axial marginal ray height passing through the second lens group G2 is not sufficiently reduced on the telephoto side, and the on-axis chromatic aberration is deteriorated, which is not preferable.

By setting the lower limit value of conditional expression (4) to 2.00 in a desirable manner and setting the upper limit value to 40.00 in a desirable manner, it is possible to more reliably obtain the above-described effect.

In addition, in the variable magnification imaging optical system according to the present invention, it is desirable that conditional expression (5) is satisfied in order to effectively correct the lateral chromatic aberration of the second lens group G2 that fluctuates during movement of the second lens group G2 due to zooming from the wide-angle end to the telephoto end.

$$0.01 < DG 1 G 2 W / DG 2 G 3 W < 2. \qquad ( 5 )$$

DG1G2W: distance between first lens group G1 and second lens group G2 on optical axis at infinity wide-angle end
DG2G3W: distance between second lens group G2 and third lens group G3 on optical axis at infinity wide-angle end

Conditional expression (5) specifies a ratio of the distance between the first lens group G1 and the second lens group G2 on the optical axis at the infinity wide-angle end and the distance between the second lens group G2 and the third lens group G3 on the optical axis. It is desirable that the second lens group G2 has a correction effect of the lateral chromatic aberration that corrects the g-rays in the under direction on the wide angle side, it is desirable that the off-axis chief ray height is higher on the wide angle side to increase the effect, and it is desirable that the axial marginal ray height passes through a lower position on the telephoto side as described above. Accordingly, at the infinity wide-angle end, the second lens group G2 is closer to the first lens group G1, the distance between the second lens group G2 and the first lens group G1 is reduced, and the distance between the second lens group G2 and the third lens group G3 is increased, so that the off-axis chief ray height passing through the second lens group G2 is higher, and the lateral chromatic aberration is effectively corrected. By satisfying conditional expression (5), it is possible to effectively correct the lateral chromatic aberration of the second lens group G2 that fluctuates during movement of the second lens group G2 due to zooming from the wide-angle end to the telephoto end.

In a case where the upper limit value of conditional expression (5) is exceeded and the ratio of the distance between the first lens group G1 and the second lens group G2 on the optical axis at the infinity wide-angle end and the distance between the second lens group G2 and the third lens group G3 on the optical axis becomes large, the second lens group G2 is too close to the third lens group G3 at the infinity wide-angle end, the off-axis chief ray passing through the second lens group G2 passes through a low position, and it is difficult to effectively correct the lateral chromatic aberration, which is not preferable.

In a case where the value of conditional expression (5) is below the lower limit and the ratio of the distance between the first lens group G1 and the second lens group G2 on the optical axis at the infinity wide-angle end and the distance between the second lens group G2 and the third lens group G3 on the optical axis becomes small, the second lens group G2 is too close to the first lens group G1 at the infinity wide-angle end, the off-axis chief ray passing through the second lens group G2 passes through a high position, the effective diameter of the second lens group G2 is increased, and the weight of the optical system is increased, which is not preferable.

By setting the lower limit value of conditional expression (5) to 0.03 in a desirable manner and setting the upper limit value to 1.50 in a desirable manner, it is possible to more reliably obtain the above-described effect.

In addition, in the variable magnification imaging optical system according to the present invention, it is desirable that conditional expression (6) is satisfied in order to effectively correct the lateral chromatic aberration of the second lens group G2 that fluctuates during movement of the second lens group G2 due to zooming from the wide-angle end to the telephoto end.

$$2. < DG 1 G 2 T / DG 2 G 3 T < 200.0 \qquad ( 6 )$$

DG1G2T: distance between first lens group G1 and second lens group G2 on optical axis at infinity telephoto end
DG2G3T: distance between second lens group G2 and third lens group G3 on optical axis at infinity telephoto end

Conditional expression (6) specifies a ratio of the distance between the first lens group G1 and the second lens group G2 on the optical axis at the infinity telephoto end and the distance between the second lens group G2 and the third lens group G3 on the optical axis. It is desirable that the second lens group G2 has a correction effect of the lateral chromatic aberration that corrects the g-rays in the under direction on the wide angle side, it is desirable that the off-axis chief ray height is higher on the wide angle side to increase the effect, and it is desirable that the axial marginal ray height passes through a lower position on the telephoto side as described above. Accordingly, at the infinity telephoto end, the second lens group G2 is closer to the third lens group G3, the distance between the second lens group G2 and the first lens group G1 is increased, and the distance between the second lens group G2 and the third lens group G3 is reduced, so that the axial marginal ray passes through a low position, and it is possible to suppress the deterioration of the on-axis chromatic aberration. By satisfying conditional expression (6), it is possible to effectively correct the lateral chromatic aberration of the second lens group G2 that fluctuates during movement of the second lens group G2 due to zooming from the wide-angle end to the telephoto end.

In a case where the upper limit value of conditional expression (6) is exceeded and the ratio of the distance between the first lens group G1 and the second lens group G2 on the optical axis at the infinity telephoto end and the distance between the second lens group G2 and the third lens group G3 on the optical axis becomes large, the distance between the first lens group G1 and the second lens group G2 on the optical axis at the infinity telephoto end is excessively large, and the optical system is excessively enlarged, which is not preferable.

In a case where the value of conditional expression (6) is below the lower limit and the ratio of the distance between the first lens group G1 and the second lens group G2 on the optical axis at the infinity telephoto end and the distance between the second lens group G2 and the third lens group G3 on the optical axis becomes small, the distance between the second lens group G2 and the third lens group G3 on the optical axis at the infinity telephoto end is not reduced, and the axial marginal ray passes through a high position, which leads to deterioration of the on-axis chromatic aberration, which is not preferable.

By setting the lower limit value of conditional expression (6) to 3.0 in a desirable manner and setting the upper limit value to 150.0 in a desirable manner, or by setting the lower limit value to 4.0 in a more desirable manner and setting the upper limit value to 120.0 in a more desirable manner, it is possible to more reliably obtain the above-described effect.

In addition, in the variable magnification imaging optical system according to the present invention, it is desirable that the following conditional expression (7) is satisfied in order to achieve effective correction of the lateral chromatic aberration over the entire zoom range.

$$1.2 < DG 2 Sw / DG 2 St < 5. \qquad ( 7 )$$

DG2Sw: distance from surface vertex of lens closest to object side in second lens group G2 at wide-angle end to aperture diaphragm S
DG2St: distance from surface vertex of lens closest to object side in second lens group G2 at telephoto end to aperture diaphragm S

Conditional expression (7) specifies a desirable range of a ratio of the distance from the surface vertex of the lens closest to the object side in the second lens group G2 at the wide-angle end and the distance from the surface vertex of the lens closest to the object side in the second lens group G2 at the telephoto end to the aperture diaphragm S. As described above, in the second lens group G2 of the variable magnification imaging optical system according to the present invention, during magnification change from the wide-angle end to the telephoto end, the second lens group G2 moves to the image side and the distance between the second lens group G2 and the third lens group G3 is reduced, so that the distance between the second lens group G2 and the aperture diaphragm S included in the middle group GM is reduced. It is desirable that the correction effect of the lateral chromatic aberration of the second lens group G2 becomes large on the wide angle side and small on the telephoto side, and thus it is desirable that the second lens group G2 is close to the aperture diaphragm S on the telephoto side and the height of the off-axis chief ray passing through the second lens group G2 becomes low. By satisfying conditional expression (7), it is possible to effectively correct the lateral chromatic aberration over the entire zoom range.

In a case where the value of conditional expression (7) is below the lower limit and the ratio of the distance from the surface vertex of the lens closest to the object side in the second lens group G2 at the wide-angle end and the distance from the surface vertex of the lens closest to the object side in the second lens group G2 at the telephoto end to the aperture diaphragm becomes small, the amount of change in the distance between the second lens group G2 and the aperture diaphragm due to magnification change is reduced, and the change in the off-axis chief ray passing through the second lens group G2 due to magnification change is reduced, so that the change in the correction effect of the lateral chromatic aberration is reduced, and it is difficult to effectively correct the lateral chromatic aberration over the entire zoom range, which is not preferable.

In a case where the upper limit value of conditional expression (7) is exceeded and the ratio of the distance from the surface vertex of the lens closest to the object side in the second lens group G2 at the wide-angle end and the distance from the surface vertex of the lens closest to the object side in the second lens group G2 at the telephoto end to the aperture diaphragm becomes large, the amount of change in the distance between the second lens group G2 and the aperture diaphragm due to magnification change is large, and the peripheral luminous flux at the wide-angle end needs to pass through a higher position, which leads to an increase in the outer diameter of the second lens group G2, which is not preferable.

By setting the lower limit value of conditional expression (7) to 1.4 in a desirable manner and setting the upper limit value to 3.5 in a desirable manner, it is possible to more reliably obtain the above-described effect.

In addition, in the variable magnification imaging optical system according to the present invention, it is desirable that the following conditional expression (8) is satisfied in order to effectively correct the on-axis chromatic aberration and the lateral chromatic aberration over the entire zoom range.

$$0.2 < g 2 AXhW / g 2 AXhT < 1.5 \qquad ( 8 )$$

g2AXhW: height of axial marginal ray at front surface of second lens group G2 at infinity wide-angle end with diaphragm open
g2AXhT: height of axial marginal ray at front surface of second lens group G2 at infinity telephoto end with diaphragm open

The axial marginal ray is defined as a ray that passes through the diaphragm at a maximum height from the optical axis among rays included in the on-axis luminous flux.

Conditional expression (8) specifies a ratio of the height of the axial marginal ray at front surface of the second lens group G2 at the infinity wide-angle end with the diaphragm open and the height of the axial marginal ray at front surface of the second lens group G2 at the infinity telephoto end with the diaphragm open. In the second lens group G2, as described above, it is desirable that the glass material having the positive anomalous dispersion is used for the concave lens in order to correct the g-rays in the under direction on the wide angle side and suppress the lateral chromatic aberration. On the other hand, in a case where glass material having a large ΔPgF and strong positive anomalous dispersion is used for the concave lens of the second lens group G2, the imaging positions of the g-rays and the C-rays in the on-axis luminous flux move to the image side, and thus the secondary spectrum acts in an increasing direction, which is disadvantageous for correcting the on-axis chromatic aberration. Furthermore, since the on-axis chromatic aberration is more noticeable as the angle of view is narrower on the telephoto side, the deterioration of the on-axis chromatic aberration also needs to be suppressed in order to achieve high image quality. Accordingly, in order to prevent the deterioration of the on-axis chromatic aberration while using the glass material having a strong positive anomalous dispersion that is advantageous for correcting the lateral chromatic aberration on the wide angle side, it is necessary to control the axial marginal ray height to be small with respect to the effective diameter of the second lens group G2 (in a case of the second lens group G2, the height of the off-axis luminous flux at the maximum angle of view at the wide-angle end determines the effective diameter), and it is particularly important to control the axial marginal ray height on the telephoto side. By satisfying conditional expression (8), it is possible to effectively correct the on-axis chromatic aberration and the lateral chromatic aberration over the entire zoom range.

In a case where the upper limit value of conditional expression (8) is exceeded and the ratio of the height of the axial marginal ray at the front surface of the second lens group G2 at the infinity wide-angle end with the diaphragm open and the height of the axial marginal ray at the front surface of the second lens group G2 at the infinity telephoto end with the diaphragm open becomes large, the height of the axial marginal ray at the front surface of the second lens group G2 at the infinity wide-angle end with the diaphragm open is excessively large, and it is difficult to correct the on-axis chromatic aberration on the wide angle side. In addition, it is necessary to increase the refractive power of the first lens group G1 in order to reduce the axial marginal ray height on the telephoto side, which deteriorates various aberrations and makes it difficult to achieve high performance.

In a case where the value of conditional expression (8) is below the lower limit and the ratio of the height of the axial marginal ray at the front surface of the second lens group G2 at the infinity wide-angle end with the diaphragm open and the height of the axial marginal ray at the front surface of the second lens group G2 at the infinity telephoto end with the diaphragm open becomes small, the height of the axial marginal ray at the front surface of the second lens group G2 at the infinity telephoto end with the diaphragm open becomes large, and it is difficult to correct the on-axis chromatic aberration and to achieve high performance.

By setting the lower limit value of conditional expression (8) to 0.3 in a desirable manner and setting the upper limit value to 1.3 in a desirable manner, or by setting the lower limit value to 0.4 in a more desirable manner and setting the upper limit value to 1.1 in a more desirable manner, it is possible to more reliably obtain the above-described effect.

In addition, in the variable magnification imaging optical system according to the present invention, the second lens group G2 in which the change in ray height of the off-axis chief ray is large during zooming from the wide-angle end to the telephoto end plays an important role in effectively correcting the lateral chromatic aberration that fluctuates due to zooming, and it is desirable that the following conditional expressions (9) and (10) are satisfied in order to achieve high performance of the optical system.

$$- 1.58 < ( g 2 OAhW / Wih ) - ( g 2 OAhT / Tih ) < - 0.3 \qquad ( 9 )$$

$$0.6 < \vert g 2 OAhW / g 2 AXhT \vert < 2.5 \qquad ( 10 )$$

Wih: image height of off-axis chief ray at maximum angle of view at infinity wide-angle end
Tih: image height of off-axis chief ray at maximum angle of view at infinity telephoto end
g2OAhW: height of off-axis chief ray at maximum angle of view at front surface of second lens group G2 at the infinity wide-angle end
g2OAhT: height of off-axis chief ray at maximum angle of view at front surface of second lens group G2 at infinity telephoto end
g2AXhT: height of axial marginal ray at front surface of second lens group G2 at infinity telephoto end with diaphragm open

A ray of g2OAhW corresponds to Wih, and a ray of g2OAhT corresponds to Tih. The second lens group G2 is present on the object side of the aperture diaphragm S, and the quadrant through which the ray passes is reversed. Therefore, g2OAhW and g2OAhT have different signs with respect to Wih and Tih. The axial marginal ray is defined as a ray that passes through the diaphragm at a maximum height from the optical axis among rays included in the on-axis luminous flux.

Conditional expression (9) specifies a desirable range of a difference between a ratio of the height of the off-axis chief ray at the maximum angle of view at the front surface of the second lens group G2 at the infinity wide-angle end and the imaging image height of the off-axis chief ray at the maximum angle of view at the wide-angle end, and a ratio of the height of the off-axis chief ray at the maximum angle of view at the front surface of the second lens group G2 at the infinity telephoto end and the imaging image height of the off-axis chief ray at the maximum angle of view at the telephoto end. In a case where the difference approaches 0 and increases, it means that the change in the off-axis chief ray in the second lens group G2 is small during zooming from the infinity wide-angle end to the infinity telephoto end. On the other hand, in a case where the difference decreases in a direction away from 0, it means that the change in the off-axis chief ray in the second lens group G2 is large during zooming from the infinity wide-angle end to the infinity telephoto end. By satisfying conditional expression (9), it is possible to effectively correct the lateral chromatic aberration that fluctuates due to zooming.

In a case where the upper limit value of conditional expression (9) is exceeded and the difference between the ratio of the height of the off-axis chief ray at the maximum angle of view at the front surface of the second lens group G2 at the infinite distance wide-angle end and the imaging image height of the off-axis chief ray at the maximum angle of view at the wide-angle end, and the ratio of the height of the off-axis chief ray at the maximum angle of view at the front surface of the second lens group G2 at the infinity telephoto end and the imaging image height of the off-axis chief ray at the maximum angle of view at the telephoto end becomes large so as to approach 0, the change in the off-axis chief ray in the second lens group G2 becomes small during zooming from the infinity wide-angle end to the infinity telephoto end, and the correction effect of the lateral chromatic aberration becomes small, and the lateral chromatic aberration cannot be sufficiently corrected on either the wide angle side or the telephoto side, which is not preferable.

In a case where the value of conditional expression (9) is below the lower limit and the difference between the ratio of the height of the off-axis chief ray at the maximum angle of view at the front surface of the second lens group G2 at the infinity wide-angle end and the imaging image height of the off-axis chief ray at the maximum angle of view at the wide-angle end, and the ratio of the height of the off-axis chief ray at the maximum angle of view at the front surface of the second lens group G2 at the infinity telephoto end and the imaging image height of the off-axis chief ray at the maximum angle of view at the telephoto end becomes small in a direction away from 0, the change in the off-axis chief ray in the second lens group G2 is excessively large during zooming from the infinity wide-angle end to the infinity telephoto end, and it is difficult to correct astigmatism and field curvature, which is not preferable.

By setting the lower limit value of conditional expression (9) to −1.5 in a desirable manner and setting the upper limit value to −0.4 in a desirable manner, it is possible to more reliably obtain the above-described effect.

Conditional expression (10) specifies an absolute value of a ratio of the height of the off-axis chief ray at the maximum angle of view at the front surface of the second lens group G2 at the infinity wide-angle end and the height of the axial marginal ray at the front surface of the second lens group G2 at the infinity telephoto end with the diaphragm open. The off-axis chief ray specified by conditional expression (10) means the off-axis chief ray at the maximum angle of view at the infinity wide-angle end specified by conditional expression (9). By satisfying conditional expression (10), it is possible to effectively correct the lateral chromatic aberration that fluctuates due to zooming.

In a case where the upper limit value of conditional expression (10) is exceeded and the absolute value of the ratio of the height of the off-axis chief ray at the maximum angle of view at the front surface of the second lens group G2 at the infinity wide-angle end and the height of the axial marginal ray at the front surface of the second lens group G2 at the infinity telephoto end with the diaphragm open becomes large, it is necessary to increase the refractive power of the first lens group G1 in order to reduce the axial marginal ray height on the telephoto side, which deteriorates various aberrations and makes it difficult to achieve high performance.

In a case where the value of conditional expression (10) is below the lower limit and the absolute value of the ratio of the height of the off-axis chief ray at the maximum angle of view at the front surface of the second lens group G2 at the infinity wide-angle end and the height of the axial marginal ray at the front surface of the second lens group G2 at the infinity telephoto end with the diaphragm open becomes small, the axial marginal ray height is not sufficiently reduced on the telephoto side, and the on-axis chromatic aberration generated in the second lens group G2 is increased, which makes it difficult to achieve high performance. In addition, the absolute value of the height of the off-axis chief ray at the maximum angle of view at the infinity wide-angle end is reduced (which is synonymous with simply reducing the height of the off-axis chief ray from the optical axis without considering the concept of the sign), and it is difficult to correct the lateral chromatic aberration on the wide angle side, which makes it difficult to achieve high performance.

By setting the lower limit value of conditional expression (10) to 0.8 in a desirable manner and setting the upper limit value to 1.9 in a desirable manner, it is possible to more reliably obtain the above-described effect.

In addition, in the variable magnification imaging optical system according to the present invention, the second lens group G2 in which the change in ray height of the off-axis chief ray is large during zooming from the wide-angle end to the telephoto end plays an important role in effectively correcting the lateral chromatic aberration that fluctuates due to zooming, and it is desirable that at least one concave lens is included.

It is important to employ the glass material having the effect of correcting the g-rays in the under direction on the wide angle side in the second lens group G2 in order to effectively correct the lateral chromatic aberration on the wide angle side. It is desirable to select the glass material having the negative anomalous dispersion in a case of the convex lens and the glass material having the positive anomalous dispersion in a case of the concave lens. As the glass material having the negative anomalous dispersion, a high refractive index and low dispersion glass material such as TAFD30 or a Kurz-Flint-type glass (Short Flint Special glass) material such as LAF45 of HOYA Corporation is applicable. As the glass material having the positive anomalous dispersion, a low refractive index and low dispersion glass material such as FCD1 or a high refractive index and high dispersion glass material such as E-FDS1-W or a high dispersion glass material such as FD270 of HOYA Corporation is applicable. In a case of comparing both, the glass material having the positive anomalous dispersion has a large number of types of optical glass, a high degree of freedom in selecting the glass material, and a large anomalous dispersion. Therefore, it is desirable to dispose at least one or more concave lenses in the second lens group G2, and it is desirable that the concave lens uses the glass material having a large positive anomalous dispersion. In the second lens group G2, at least one concave lens is included, and thus it is possible to effectively correct the lateral chromatic aberration that fluctuates due to zooming.

In addition, in the variable magnification imaging optical system according to the present invention, the second lens group G2 in which the change in ray height of the off-axis chief ray is large during zooming from the wide-angle end to the telephoto end plays an important role in effectively correcting the lateral chromatic aberration that fluctuates due to zooming, and it is desirable to include at least one or more concave lenses satisfying the following conditional expression (11) for this purpose.

$$Δ PgFLg 2 > 0.009 \qquad ( 11 )$$

ΔPgFLg2: anomalous dispersion of concave lens having largest anomalous dispersion among concave lenses included in second lens group G2

Conditional expression (11) specifies a desirable range of the anomalous dispersion of the one or more concave lens included in the second lens group G2. The concave lens shown here may be a lens disposed alone or a concave lens disposed as a part of a cemented lens.

As described above, the second lens group G2 moves to the image side with respect to the image surface during zooming from the wide-angle end to the telephoto end, and the off-axis chief ray passing through the second lens group G2 passes through a high position on the wide angle side and a low position on the telephoto side. In order to suppress the lateral chromatic aberration over the entire zoom range and to achieve high performance, the second lens group G2 needs to correct the g-rays more in the under direction on the wide angle side. Accordingly, a large ΔPgF and a strong positive anomalous dispersion are advantageous for correcting the g-rays. By satisfying conditional expression (11), it is possible to effectively correct the lateral chromatic aberration that fluctuates due to zooming.

In a case where the value of conditional expression (11) is below the lower limit and the anomalous dispersion of the concave lens having the largest anomalous dispersion among the concave lenses included in the second lens group G2 becomes small, the effect of correcting the g-rays in the under direction on the wide angle side is reduced, and it is difficult to suppress the lateral chromatic aberration over the entire zoom range and to achieve high performance.

By setting the lower limit value of conditional expression (11) to 0.0095 in a desirable manner, to 0.0100 in a more desirable manner, or to 0.0150 in a still more desirable manner, it is possible to more reliably obtain the above-described effect.

In addition, in the variable magnification imaging optical system according to the present invention, it is desirable that the subsequent group GR includes at least one or more concave lenses satisfying the following conditional expression (12). The concave lens shown here may be a lens disposed alone or a concave lens disposed as a part of a cemented lens.

$$Δ PgFnLr > 0.009 \qquad ( 12 )$$

ΔPgFnLr: anomalous dispersion of concave lens of subsequent group GR

Conditional expression (12) specifies the anomalous dispersion of the concave lens that is desirable to include one or more in the subsequent group GR of the variable magnification imaging optical system according to the present invention. In the variable magnification imaging optical system according to the present invention, the rays on the short wavelength side, particularly on the short wavelength side of the g-rays, are under-corrected on the telephoto side, and the imaging magnification is reduced, and the lateral chromatic aberration in the under direction remains. In order to effectively correct this, it is desirable that the concave lens in the group behind the aperture diaphragm S uses the glass material having a large ΔPgF and strong positive anomalous dispersion. By satisfying conditional expression (12), it is possible to effectively correct the lateral chromatic aberration over the entire zoom range.

In a case where the value of conditional expression (12) is below the lower limit and the anomalous dispersion of the concave lens constituting the subsequent group GR becomes small, the effect of correcting the g-rays in the over direction at the peripheral image height on the telephoto side is reduced, and it is difficult to correct the lateral chromatic aberration over the entire zoom range.

By setting the lower limit value of conditional expression (12) to 0.010 in a desirable manner, to 0.011 in a more desirable manner, or to 0.013 in a still more desirable manner, it is possible to more reliably obtain the above-described effect.

In addition, in the variable magnification imaging optical system according to the present invention, it is desirable that the subsequent group GR includes at least one or more concave lenses satisfying the following conditional expression (13). The concave lens shown here may be a lens disposed alone or a concave lens disposed as a part of a cemented lens.

$$vdmLr \times Δ PgFnLr > 0.8 \qquad ( 13 )$$

vdnLr: Abbe number of concave lens included in subsequent group GR
ΔPgFnLr: anomalous dispersion of concave lens included in subsequent group GR

Conditional expression (13) specifies a relationship between the Abbe number and the anomalous dispersion of the concave lens that is desirable to include one or more in the subsequent group GR of the variable magnification imaging optical system according to the present invention. In the variable magnification imaging optical system according to the present invention, the rays on the short wavelength side, particularly on the short wavelength side of the g-rays, are under-corrected on the telephoto side, and the imaging magnification is reduced, and the lateral chromatic aberration in the under direction remains. In order to effectively correct this, it is desirable that the concave lens in the group behind the aperture diaphragm S uses the glass material having a large ΔPgF and a large positive anomalous dispersion. In addition, the glass material satisfying conditional expression (12) is generally a glass material having a relatively low refractive index of about 1.7 or less, and has not only the desirable anomalous dispersion for correcting the lateral chromatic aberration but also an advantage in correcting the Petzval sum because of the low refractive index. By satisfying conditional expression (13), it is possible to effectively correct the lateral chromatic aberration over the entire zoom range.

In a case where the value of conditional expression (13) is below the lower limit and the anomalous dispersion of at least one concave lens that is included in the subsequent group GR becomes small, the effect of correcting the g-rays in the over direction at the peripheral image height on the telephoto side is reduced, and it is difficult to correct the lateral chromatic aberration over the entire zoom range.

By setting the lower limit value of conditional expression (13) to 0.85 in a desirable manner or to 0.90 in a more desirable manner, it is possible to more reliably obtain the above-described effect.

In addition, in the variable magnification imaging optical system according to the present invention, it is desirable that the subsequent group GR includes at least one or more convex lenses satisfying the following conditional expression (14). The convex lens shown here may be a lens disposed alone or a convex lens disposed as a part of a cemented lens.

$$Δ PgFpLr < - 0.001 \qquad ( 14 )$$

ΔPgFpLr: anomalous dispersion of convex lens included in subsequent group GR

Conditional expression (14) specifies the anomalous dispersion of at least one convex lens that is included in the subsequent group GR of the variable magnification imaging optical system according to the present invention. In the variable magnification imaging optical system according to the present invention, the imaging magnification of the rays on the short wavelength side, particularly on the short wavelength side of the g-rays, is reduced on the telephoto side, and the lateral chromatic aberration in the under direction remains. In order to effectively correct this, it is desirable that the convex lens in the group behind the aperture diaphragm S uses the glass material having a small ΔPgF and a strong negative anomalous dispersion. By satisfying conditional expression (14), it is possible to effectively correct the lateral chromatic aberration over the entire zoom range.

In a case where the upper limit value of conditional expression (14) is exceeded and the anomalous dispersion of at least one convex lens that is included in the subsequent group GR becomes large, the effect of correcting the g-rays in the over direction on the telephoto side is reduced, and it is difficult to suppress the lateral chromatic aberration over the entire zoom range.

By setting the upper limit value of conditional expression (14) to −0.0020 in a desirable manner, to −0.0030 in a more desirable manner, or to −0.0040 in a still more desirable manner, it is possible to more reliably obtain the above-described effect.

In addition, in the variable magnification imaging optical system according to the present invention, it is desirable that an average value of the anomalous dispersion of two convex lenses from the image side satisfies a range of conditional expression (15). The convex lens shown here may be a lens disposed alone or a convex lens disposed as a part of a cemented lens.

$$Δ PgFprAVE < - 0.001 \qquad ( 15 )$$

ΔPgFprAVE: average value of anomalous dispersion of two convex lenses from image side

Conditional expression (15) specifies the average value of the anomalous dispersion of two convex lenses from the image side in the variable magnification imaging optical system according to the present invention. In the variable magnification imaging optical system according to the present invention, the imaging magnification of the rays on the short wavelength side, particularly on the short wavelength side of the g-rays, is reduced on the telephoto side, and the lateral chromatic aberration in the under direction remains. In order to effectively correct this, it is desirable that the convex lens in the group behind the aperture diaphragm S uses the glass material having a small ΔPgF and a strong negative anomalous dispersion. In addition, the correction effect of the lateral chromatic aberration is higher as the lens is closer to the image side because the off-axis ray passes through a high position.

In a case where the upper limit value of conditional expression (15) is exceeded and the average value of the anomalous dispersion of two convex lenses from the image side becomes large, the effect of correcting the g-rays in the over direction on the telephoto side is reduced, and it is difficult to suppress the lateral chromatic aberration over the entire zoom range.

By setting the upper limit value of conditional expression (15) to −0.0020 in a desirable manner, to −0.0030 in a more desirable manner, or to −0.0040 in a still more desirable manner, it is possible to more reliably obtain the above-described effect.

In addition, in the variable magnification imaging optical system according to the present invention, it is desirable that the following conditional expression (16) is satisfied in order to achieve both reduction in total length of the optical system and high performance.

$$0.18 < f 1 / fT < 1. \qquad ( 16 )$$

f1: focal length of first lens group G1
fT: focal length of variable magnification imaging optical system at infinity telephoto end

Conditional expression (16) specifies a ratio of the focal length of the first lens group G1 to the focal length of the variable magnification imaging optical system at the infinity telephoto end, and shows a desirable range for reducing the total length of the optical system and reducing the weight of the lens barrel. By satisfying conditional expression (16), it is possible to achieve both reduction in total lens length and high performance.

In a case where the upper limit value of conditional expression (16) is exceeded and the focal length of the first lens group G1 is longer than the focal length of the variable magnification imaging optical system at the infinity telephoto end, the total lens length at the telephoto end is excessively long, the movement amount of the first lens group G1 due to zooming is increased, and the movement mechanism is complicated and the lens barrel is enlarged.

In a case where the value of conditional expression (16) is below the lower limit and the focal length of the first lens group G1 is shorter relative to the focal length of the variable magnification imaging optical system at the infinity telephoto end, the imaging magnification of the combined system subsequent to the second lens group G2 at the telephoto end is excessively high, and it is difficult to correct various aberrations such as on-axis chromatic aberration at the telephoto end.

By setting the lower limit value of conditional expression (16) to 0.20 in a desirable manner and setting the upper limit value to 0.85 in a desirable manner, or by setting the lower limit value to 0.24 in a more desirable manner and setting the upper limit value to 0.70 in a more desirable manner, it is possible to more reliably obtain the above-described effect.

In addition, in the variable magnification imaging optical system according to the present invention, it is desirable that the following conditional expression (17) is satisfied in order to achieve both reduction in total length of the optical system and high performance.

$$0.1 < f 2 / fT < 1.4 \qquad ( 17 )$$

f2: focal length of second lens group G2
fT: focal length of variable magnification imaging optical system at infinity telephoto end

Conditional expression (17) specifies a ratio of the focal length of the second lens group G2 to the focal length of the variable magnification imaging optical system at the infinity telephoto end, and shows a desirable range for reducing the total length of the optical system and reducing the weight of the lens barrel. By satisfying conditional expression (17), it is possible to reduce the total lens length and reduce the weight of the lens barrel.

In a case where the upper limit value of conditional expression (17) is exceeded and the focal length of the second lens group G2 becomes longer relative to the focal length of the variable magnification imaging optical system at the infinity telephoto end, the combined positive refractive power of the first lens group G1 and the second lens group G2 is reduced, and it is difficult to reduce the total length of the optical system. In addition, in a case where the combined refractive power of the first lens group G1 and the second lens group G2 is increased by increasing the refractive power of the first lens group G1 to compensate for the deficiency, it is difficult to use a low refractive index and low dispersion glass such as fluorite for the convex lens of the first lens group G1 that plays an important role in correcting the on-axis chromatic aberration, and it is difficult to achieve high performance.

In a case where the value of conditional expression (17) is below the lower limit and the focal length of the second lens group G2 becomes shorter relative to the focal length of the variable magnification imaging optical system at the infinity telephoto end, the refractive power of the second lens group G2 is increased, and it is difficult to suppress astigmatism, particularly at the wide-angle end where the off-axis chief ray passes through a high position, and it is difficult to achieve high performance.

By setting the lower limit value of conditional expression (17) to 0.20 in a desirable manner and setting the upper limit value to 1.10 in a desirable manner, it is possible to more reliably obtain the above-described effect.

In addition, in the variable magnification imaging optical system according to the present invention, it is desirable that the following conditional expression (18) is satisfied in order to achieve both reduction in total length of the optical system and high performance.

$$0.6 < f 1 / f 2 < 2.2 \qquad ( 18 )$$

f1: focal length of first lens group G1
f2: focal length of second lens group G2

Conditional expression (18) shows a desirable range of a ratio of the focal length of the first lens group G1 to the focal length of the second lens group G2. By satisfying conditional expression (18), it is possible to achieve both reduction in total lens length and high performance.

In a case where the upper limit value of conditional expression (18) is exceeded and the ratio of the focal length of the first lens group G1 to the focal length of the second lens group G2 becomes large, it means that the refractive power of the first lens group G1 is smaller relative to the refractive power of the second lens group G2, and the refractive power of the first lens group G1 is deficient, which leads to an increase in the size of the optical system, which is not preferable.

In a case where the value of conditional expression (18) is below the lower limit and the ratio of the focal length of the first lens group G1 to the focal length of the second lens group G2 becomes small, it means that the refractive power of the first lens group G1 is larger relative to the refractive power of the second lens group G2, and the imaging magnification of the combined system subsequent to the second lens group G2 at the telephoto end is excessively high, and it is difficult to correct various aberrations such as on-axis chromatic aberration at the telephoto end.

By setting the lower limit value of conditional expression (18) to 0.7 in a desirable manner and setting the upper limit value to 1.8 in a desirable manner, it is possible to more reliably obtain the above-described effect.

In addition, in the variable magnification imaging optical system according to the present invention, it is desirable that the following conditional expression (19) is satisfied in order to achieve both reduction in total length of the optical system and high performance.

$$1. 0 < f 1 / fW < 5. \qquad ( 19 )$$

f1: focal length of first lens group G1
fW: focal length of variable magnification imaging optical system at infinity wide-angle end

Conditional expression (19) specifies a ratio of the focal length of the variable magnification imaging optical system at the infinity wide-angle end to the focal length of the first lens group G1, and shows a desirable range for achieving both reduction in total length of the optical system and high performance. By satisfying conditional expression (19), it is possible to achieve both reduction in total lens length and high performance.

In a case where the upper limit value of conditional expression (19) is exceeded and the focal length of the first lens group G1 becomes larger relative to the focal length of the variable magnification imaging optical system at the infinity wide-angle end, the refractive power of the first lens group G1 is deficient, and it is difficult to reduce the total length of the optical system, which is not preferable.

In a case where the value of conditional expression (19) is below the lower limit and the focal length of the first lens group G1 becomes shorter relative to the focal length of the variable magnification imaging optical system at the infinity wide-angle end, the refractive power of the first lens group G1 is excessively strong, and it is difficult to correct various aberrations such as spherical aberration and astigmatism, and it is difficult to achieve high performance, which is not preferable.

By setting the lower limit value of conditional expression (19) to 1.3 in a desirable manner and setting the upper limit value to 4.0 in a desirable manner, it is possible to more reliably obtain the above-described effect.

In addition, in the variable magnification imaging optical system according to the present invention, it is desirable that the following conditional expression (20) is satisfied in order to achieve both reduction in total length of the optical system and high performance.

$$0.5 < f 2 / fW < 8.5 \qquad ( 20 )$$

f2: focal length of second lens group G2
fW: focal length of variable magnification imaging optical system at infinity wide-angle end

Conditional expression (20) specifies a ratio of the focal length of the variable magnification imaging optical system at the infinity wide-angle end to the focal length of the second lens group G2, and shows a desirable range for achieving both reduction in total length of the optical system and high performance. By satisfying conditional expression (20), it is possible to achieve both reduction in total lens length and high performance.

In a case where the upper limit value of conditional expression (20) is exceeded and the focal length of the second lens group G2 becomes larger relative to the focal length of the variable magnification imaging optical system at the infinity wide-angle end, the refractive power of the second lens group G2 is deficient, and it is difficult to reduce the total length of the optical system. At the same time, it is necessary to compensate for the deficient refractive power by increasing the refractive power of the first lens group G1, and aberrations generated in the first lens group G1 are increased, making it difficult to achieve high performance, which is not preferable.

In a case where the value of conditional expression (20) is below the lower limit and the focal length of the second lens group G2 becomes shorter relative to the focal length of the variable magnification imaging optical system at the infinity wide-angle end, the refractive power of the second lens group G2 is excessively strong, and the coma aberration and the astigmatism generated in the second lens group G2 are increased, making it difficult to achieve high performance, which is not preferable.

By setting the lower limit value of conditional expression (20) to 0.7 in a desirable manner and setting the upper limit value to 7.5 in a desirable manner, it is possible to more reliably obtain the above-described effect.

In addition, in the variable magnification imaging optical system according to the present invention, it is desirable that the following conditional expression (21) is satisfied.

$$0.04 < \vert fF / fT \vert < 0.35 \qquad ( 21 )$$

fF: focal length of focusing group GF
fT: focal length of variable magnification imaging optical system at infinity telephoto end

In a case where the movement distance of the focusing group GF from the infinity to the closest distance is short, there is an advantage in improving the focusing speed, but the refractive power of the focusing group GF needs to be increased, and the performance deterioration during focusing is large, which is not preferable. In consideration of this point, conditional expression (21) specifies a desirable range of an absolute value of a ratio of the focal length of the focusing group GF to the focal length of the variable magnification imaging optical system at the infinity telephoto end in order to achieve high-speed focusing and to suppress the performance deterioration during focusing. By satisfying conditional expression (21), it is possible to achieve high-speed focusing while effectively correcting various aberrations.

In a case where the value of conditional expression (21) is below the lower limit and the absolute value of the ratio of the focal length of the focusing group GF to the focal length of the variable magnification imaging optical system at the infinity telephoto end becomes small, the refractive power of the focusing group GF is excessively strong, and the performance variation due to the deterioration of various aberrations during focusing is excessively large, which is not preferable.

In a case where the upper limit value of conditional expression (21) is exceeded and the absolute value of the ratio of the focal length of the focusing group GF to the focal length of the variable magnification imaging optical system at the infinity telephoto end becomes large, the refractive power of the focusing group GF is deficient, and the movement amount of the focusing group GF from the infinity to the closest distance is large, which leads to a decrease in the focusing speed, which is not preferable.

By setting the lower limit value of conditional expression (21) to 0.06 in a desirable manner and setting the upper limit value to 0.20 in a desirable manner, it is possible to more reliably obtain the above-described effect.

In addition, in the variable magnification imaging optical system according to the present invention, it is desirable that the following conditional expression (22) is satisfied.

$$2. < \vert \{ 1 - ( β FT ) \hat{} 2 \} \times ( β RT ) \hat{} 2 \vert < 20. \qquad ( 22 )$$

βFT: lateral magnification of focusing group GF at infinity telephoto end
βRT: lateral magnification of all lens groups disposed on image side of focusing group GF at infinity telephoto end

Conditional expression (22) specifies an absolute value of a focus sensitivity of the focusing group GF. The focus sensitivity is a ratio (ΔL/Δd) of a movement amount Δd of the focusing group GF in the optical axis direction to a movement amount ΔL of the imaging position in the optical axis direction due to the movement of the focusing group GF. As the absolute value of the focus sensitivity is larger, the imaging point can be moved in the optical axis direction by a small movement amount of the focusing group. By satisfying conditional expression (22), it is possible to achieve high-speed focusing while effectively correcting various aberrations.

In a case where the value of conditional expression (22) is below the lower limit and the absolute value of the focus sensitivity of the focusing group GF becomes small, the movement amount of the focusing group GF increases during focusing, which leads to a decrease in the focusing speed, which is not preferable.

In a case where the upper limit value of conditional expression (22) is exceeded and the absolute value of the focus sensitivity of the focusing group GF becomes large, the refractive power of the focusing group GF is excessively strong, and the performance variation due to the deterioration of various aberrations during focusing is excessively large, which is not preferable.

By setting the lower limit value of conditional expression (22) to 2.5 in a desirable manner and setting the upper limit value to 15.0 in a desirable manner, or by setting the lower limit value to 3.0 in a more desirable manner and setting the upper limit value to 12.5 in a more desirable manner, it is possible to more reliably obtain the above-described effect.

In addition, in the variable magnification imaging optical system according to the present invention, the mechanism is prevented from being complicated by fixing the third lens group G3 to the image surface during magnification change. This is because, in a case where a part of the third lens group G3 is moved in a direction substantially perpendicular to the optical axis to form a vibration reduction group, the driving unit and the wiring do not move during magnification change, and thus the mechanism can be simplified, which is preferable. The position of the vibration reduction group is not necessarily limited to a part of the third lens group G3. For example, a part of the lens group on the image side of the diaphragm can be moved in a direction substantially perpendicular to the optical axis to form a vibration reduction group.

In addition, in the variable magnification imaging optical system according to the present invention, in order to prevent the mechanical mechanism from being complicated, it is desirable that the lens group closest to the image side in the subsequent group GR is fixed to the image surface during zooming.

Next, lens configurations of examples of the imaging optical system according to the present invention will be described, and specific numerical data will be shown. In the following description, the lens configurations will be described in order from the object side to the image side.

In [surface data], the surface number is a number of a lens surface or the aperture diaphragm S counted from the object side, r is a curvature radius of each lens surface, d is a distance between each lens surface, nd is a refractive index with respect to a d line (wavelength: 587.56 nm), vd is an Abbe number with respect to the d line, and ΔPgF is a numerical value calculated from an expression of PgF−0.64833+0.00180×vd. In addition, as an example of the glass material corresponding to the refractive index, the Abbe number, and ΔPgF described in [surface data], glass material names of glass of HOYA Corporation, OHARA Inc., and Hikari Glass Co., Ltd. are described.

An asterisk (*) attached to a surface number indicates that the lens surface shape is an aspherical surface shape. In addition, BF is a back focus, and the distance from the object surface is a distance from the subject to the first surface of the lens.

The (diaphragm) attached to the surface number indicates that the aperture diaphragm S is located at that position. A curvature radius with respect to the plane or the aperture diaphragm S is denoted by ∞ (infinity).

[Aspherical surface data] shows values of each coefficient for giving the aspherical shape of the lens surface denoted by * in [Surface data]. The shape of the aspherical surface is expressed by the following equation. In the following equation, the displacement from the optical axis in the direction perpendicular to the optical axis is represented by y, the displacement (sag) from the intersection of the aspherical surface and the optical axis in the optical axis direction is represented by z, the curvature radius of the reference spherical surface is represented by r, and the conic constant is represented by K. In addition, aspherical surface coefficients of the fourth order, the sixth order, the eighth order, and the tenth order are represented by A4, A6, A8, and A10, respectively.

$$z = \frac{( 1 / r ) {y}^{2}}{1 + \sqrt{1 - ( 1 + K ) {( y / r )}^{2}}} + A 4 {y}^{4} + A 6 {y}^{6} + A 8 {y}^{8} + A 10 {y}^{10}$$

[Various types of data] shows values such as a zoom ratio and a focal length in each focusing distance-focusing state.

The [Variable distance data] shows the variable distance and the BF value in each focusing distance-focusing state.

The [Lens group data] shows the surface number closest to the object side in each lens group and the total focal length of the entire group.

In addition, in the aberration diagrams corresponding to the respective examples, d, g, and C represent a d ray, a g ray, and a C ray, respectively, and ΔS and ΔM represent a sagittal image surface and a meridional image surface, respectively.

In addition, in all the values of the specifications described below, unless otherwise noted, the units of the focal length f, the curvature radius r, the lens surface distance d, and other lengths are millimeters (mm), but the present invention is not limited thereto since the same optical performance can be obtained in both the proportional magnification and the proportional reduction in the optical system.

In addition, as for lens names, a lens disposed closest to the object side will be referred to as L1, and a second lens disposed on an image side thereof is referred to as L2, a third lens disposed on an image side thereof is referred to as L3, and so on in order toward the image side.

In addition, in the lens configuration diagrams of each example, I is an image surface, F is an optical filter, and a single-dot chain line passing through the center is the optical axis.

### Example 1

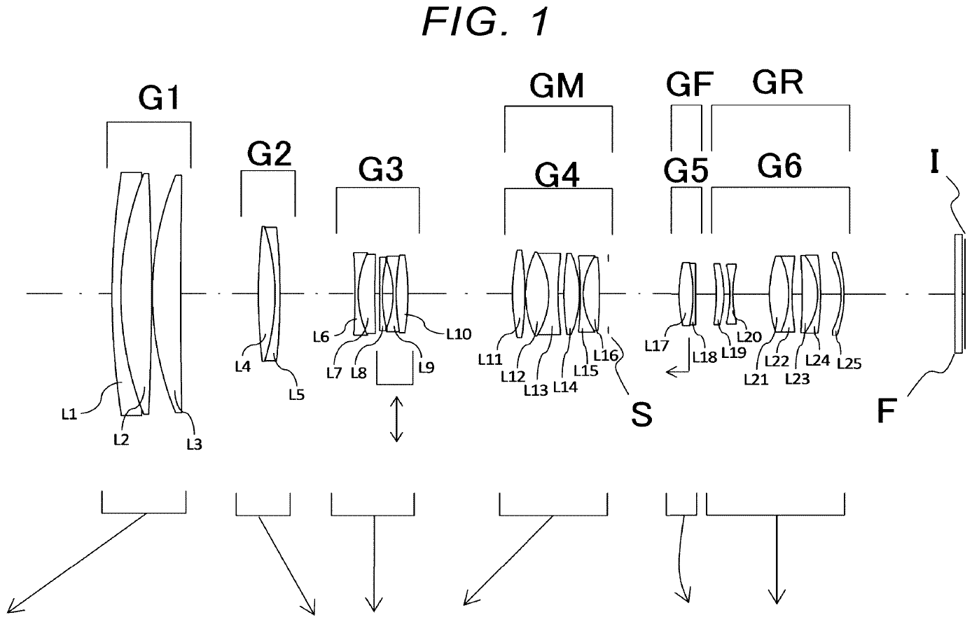

FIG. 1 is a lens configuration diagram of the variable magnification imaging optical system according to Example 1 in a case of focusing on infinity at the wide-angle end.

The variable magnification imaging optical system of FIG. 1 consists of, in order from the object side, a first lens group G1 having a positive refractive power, a second lens group G2 having a positive refractive power, a third lens group G3 having a negative refractive power, a middle group GM consisting of a fourth lens group G4, a focusing group GF consisting of a fifth lens group G5 that moves along the optical axis during focusing from an infinite distance object to a close distance object, and a subsequent group GR consisting of a sixth lens group G6.

The first lens group G1 consists of a cemented lens of a meniscus negative lens L1 having a convex surface toward the object side and a biconvex lens L2 and a meniscus positive lens L3 having a convex surface toward the object side. The second lens group G2 consists of: a cemented lens of a biconvex lens L4 and a meniscus negative lens L5 having a convex surface toward the image side. The third lens group G3 consists of a cemented lens of a biconcave lens L6 and a meniscus positive lens L7 having a convex surface toward the object side, a meniscus negative lens L8 having a convex surface toward the object side, and a cemented lens of a biconcave lens L9 and a biconvex lens L10. In addition, the third lens group G3 may also function as a vibration reduction group by moving L8 to L10 integrally in a direction substantially perpendicular to the optical axis, but lenses other than L8 to L10 may also function as the vibration reduction group. The fourth lens group G4 consists of: a biconvex lens L11, a cemented lens of a biconvex lens L12 and a biconcave lens L13, a biconvex lens L14, a cemented lens of a biconcave lens L15 and a biconvex lens L16, and the aperture diaphragm S. The fifth lens group G5 consists of a cemented lens of a biconvex lens L17 and a meniscus negative lens L18 having a convex surface toward the image side. The sixth lens group G6 consists of: a meniscus positive lens L19 having a convex surface toward the image side, a biconcave lens L20, a cemented lens of a biconvex lens L21 and a biconcave lens L22, a cemented lens of a meniscus positive lens L23 having a convex surface toward the image side and a meniscus negative lens L24 having a convex surface toward the image side, and a meniscus negative lens L25 having a convex surface toward the image side.

During magnification change from the wide-angle end to the telephoto end, the third lens group G3 and the sixth lens group G6 are fixed to the image surface, the first lens group G1 moves to the object side, the second lens group G2 moves to the image side, the fourth lens group G4 moves to the object side, the fifth lens group G5 moves to the object side and then moves to the image side, the distance between the first lens group G1 and the second lens group G2 increases, the distance between the second lens group G2 and the third lens group G3 decreases, the distance between the third lens group G3 and the fourth lens group G4 decreases, the distance between the fourth lens group G4 and the fifth lens group G5 increases, and the distance between the fifth lens group G5 and the sixth lens group G6 increases and then decreases, and the distance at the telephoto end is smaller than the distance at the wide-angle end. During focusing from the infinite distance object to the close distance object, the fifth lens group G5 moves to the object side.

L18 is a concave lens corresponding to conditional expression (1).

L1 is a concave lens corresponding to conditional expression (2).

L5 is a concave lens corresponding to conditional expression (11).

L22 and L24 are concave lenses corresponding to conditional expression (12).

L22 and L24 are concave lenses corresponding to conditional expression (13).

L21 and L23 are convex lenses corresponding to conditional expression (14).

L21 and L23 are convex lenses corresponding to conditional expression (15).

The following shows numerical values of the variable magnification imaging optical system according to Example 1.

### Numerical Example 1

Unit: mm
[Surface data]

| Surface | | | | | | Glass |
|---|---|---|---|---|---|---|
| number | r | d | nd | vd | ΔPgF | material |
| Object | ∞ | (d0) | | | | |
| surface | | | | | | |
| 1 | 345.9465 | 3.0000 | 1.62205 | 41.09 | −0.0051 | S-NBM52 |
| 2 | 140.9130 | 10.5135 | 1.49700 | 81.61 | 0.0373 | FCD1 |
| 3 | −1128.2312 | 0.3000 | | | | |
| 4 | 134.8320 | 9.7064 | 1.43700 | 95.10 | 0.0564 | FCD100 |
| 5 | 2787.0673 | (d5) | | | | |
| 6 | 264.3969 | 5.7045 | 1.74077 | 27.76 | 0.0093 | E-FD13 |
| 7 | −94.9663 | 1.7000 | 1.92286 | 20.88 | 0.0281 | E-FDS1-W |
| 8 | −277.3703 | (d8) | | | | |
| 9 | −265.8088 | 1.1000 | 1.90366 | 31.32 | 0.0027 | TAFD25 |
| 10 | 42.3251 | 5.5864 | 1.80809 | 22.76 | 0.0212 | FD225 |
| 11 | 375.1338 | 1.6610 | | | | |
| 12 | 2722.3332 | 1.0000 | 1.85150 | 40.78 | −0.0055 | S-LAH89 |
| 13 | 65.4454 | 3.7639 | | | | |
| 14 | −38.2291 | 1.0000 | 1.76385 | 48.49 | −0.0022 | S-LAH96 |
| 15 | 96.7123 | 4.0500 | 1.85451 | 25.15 | 0.0071 | NBFD25 |
| 16 | −103.1166 | (d16) | | | | |
| 17 | 90.7216 | 4.2035 | 1.95375 | 32.32 | −0.0002 | TAFD45 |
| 18 | −134.5523 | 0.3000 | | | | |
| 19 | 41.8225 | 8.0651 | 1.43700 | 95.10 | 0.0564 | FCD100 |
| 20 | −33.5158 | 3.1409 | 1.91082 | 35.25 | −0.0017 | AFD35L |
| 21 | 128.5130 | 2.0000 | | | | |
| 22 | 115.2168 | 5.3307 | 1.78880 | 28.43 | 0.0036 | S-NBH58 |
| 23 | −44.4459 | 0.3000 | | | | |
| 24 | −178.6582 | 1.0000 | 1.85883 | 30.00 | 0.0035 | NBFD30 |
| 25 | 29.2459 | 5.6004 | 1.43700 | 95.10 | 0.0564 | FCD100 |
| 26 | −159.6203 | 3.0000 | | | | |
| 27 | (Diaphragm) ∞ | (d27) | | | | |
| 28 | 58.2157 | 4.7813 | 1.76182 | 26.61 | 0.0117 | FD140 |
| 29 | −60.1979 | 0.8996 | 1.94594 | 17.98 | 0.0385 | FDS18-W |
| 30 | −654.0263 | (d30) | | | | |
| 31 | −76.3851 | 2.7042 | 1.85451 | 25.15 | 0.0071 | NBFD25 |
| 32 | −44.8928 | 2.0780 | | | | |
| 33 | −50.6789 | 1.0000 | 1.76385 | 48.49 | −0.0022 | S-LAH96 |
| 34 | 51.3733 | 12.5744 | | | | |
| 35 | 52.4424 | 6.6039 | 1.61396 | 44.29 | −0.0055 | LAF45 |
| 36 | −40.0023 | 1.0999 | 1.43700 | 95.10 | 0.0564 | FCD100 |
| 37 | 98.2579 | 3.5590 | | | | |
| 38 | −189.9223 | 5.2514 | 1.61396 | 44.29 | −0.0055 | LAF45 |
| 39 | −27.1949 | 1.0001 | 1.59282 | 68.62 | 0.0192 | FCD515 |
| 40 | −123.8366 | 7.0234 | | | | |
| 41 | −33.9240 | 1.0003 | 2.05090 | 26.94 | 0.0052 | TAFD65 |
| 42 | −53.1149 | 38.0000 | | | | |
| 43 | ∞ | 2.5000 | 1.51680 | 64.20 | 0.0014 | BSC7 |
| 44 | ∞ | (BF) | | | | |
| Image surface | ∞ | | | | | |

[Various types of data]
Zoom ratio 3.78

| | Wide angle | Middle | Telephoto |
|---|---|---|---|
| Focal length | 153.00 | 280.00 | 577.80 |
| F number | 5.16 | 5.79 | 6.48 |
| Total angle of view 2ω | 15.78 | 8.63 | 4.18 |
| Image height Y | 21.63 | 21.63 | 21.63 |
| Total lens length | 292.66 | 330.78 | 377.11 |

[Variable distance data]

| | | |
|---|---|---|
| Wide angle | Middle | Telephoto |

During focusing on infinity

| | | | |
|---|---|---|---|
| d0 | ∞ | ∞ | ∞ |
| d5 | 26.6891 | 66.7920 | 133.7564 |
| d8 | 25.7840 | 23.7989 | 3.1654 |
| d16 | 35.7986 | 19.5283 | 2.0000 |
| d27 | 24.2472 | 39.1282 | 60.9559 |
| d30 | 7.0431 | 8.4323 | 4.1330 |
| BF | 1.0000 | 1.0000 | 1.0000 |

During focusing on close distance object

| | | | |
|---|---|---|---|
| d0 | 2500.0000 | 2500.0000 | 2500.0000 |
| d5 | 26.6891 | 66.7920 | 133.7564 |
| d8 | 25.7840 | 23.7989 | 3.1654 |
| d16 | 35.7986 | 19.5283 | 2.0000 |
| d27 | 22.0146 | 32.3613 | 37.0986 |
| d30 | 9.2757 | 15.1992 | 27.9903 |
| BF | 1.0000 | 1.0000 | 1.0000 |

[Lens group data]

| Group | Starting surface | Focal length |
|---|---|---|
| G1 | 1 | 226.88 |
| G2 | 6 | 238.33 |
| G3 | 9 | −31.22 |
| G4 | 17 | 59.67 |
| G5 | 28 | 86.77 |
| G6 | 31 | −53.28 |

### Example 2

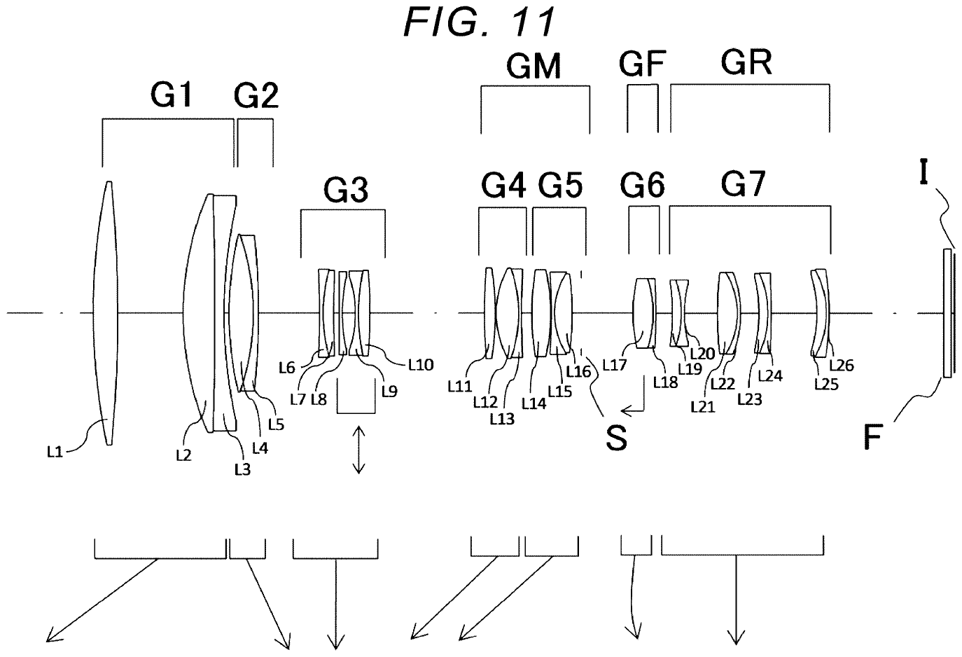

FIG. 11 is a lens configuration diagram of the variable magnification imaging optical system according to Example 2 in a case of focusing on infinity at the wide-angle end.

The variable magnification imaging optical system of FIG. 11 consists of, in order from the object side, a first lens group G1 having a positive refractive power, a second lens group G2 having a positive refractive power, a third lens group G3 having a negative refractive power, a middle group GM consisting of a fourth lens group G4 and a fifth lens group G5, a focusing group GF consisting of a sixth lens group G6, and a subsequent group GR consisting of a seventh lens group G7.

The first lens group G1 consists of: a biconvex lens L1, and a cemented lens of a biconvex lens L2 and a biconcave lens L3. The second lens group G2 consists of a cemented lens of a biconvex lens L4 and a meniscus negative lens L5 having a convex surface toward the image side. The third lens group G3 consists of: a cemented lens of a biconcave lens L6 and a meniscus positive lens L7 having a convex surface toward the object side, a biconcave lens L8, and a cemented lens of a biconcave lens L9 and a biconvex lens L10. In addition, the third lens group G3 may also function as a vibration reduction group by moving L8 to L10 integrally in a direction substantially perpendicular to the optical axis, but lenses other than L8 to L10 may also function as the vibration reduction group. The fourth lens group G4 consists of: a biconvex lens L11 and a cemented lens of a biconvex lens L12 and a biconcave lens L13. The fifth lens group G5 consists of: a biconvex lens L14, a cemented lens of a biconcave lens L15 and a biconvex lens L16, and the aperture diaphragm S. The sixth lens group G6 consists of a cemented lens of a biconvex lens L17 and a meniscus negative lens L18 having a convex surface toward the image side. The seventh lens group G7 consists of: a cemented lens of a meniscus positive lens L19 having a convex surface toward the image side and a biconcave lens L20, a cemented lens of a biconvex lens L21 and a meniscus negative lens L22 having a convex surface toward the image side, a cemented lens of a meniscus positive lens L23 having a convex surface toward the image side and a meniscus negative lens L24 having a convex surface toward the image side, and a cemented lens of a meniscus positive lens L25 having a convex surface toward the image side and a meniscus negative lens L26 having a convex surface toward the image side.

During magnification change from the wide-angle end to the telephoto end, the third lens group G3 and the seventh lens group G7 are fixed to the image surface, the first lens group G1 moves to the object side, the second lens group G2 moves to the image side, the fourth lens group G4 and the fifth lens group G5 move to the object side, the sixth lens group G6 moves to the object side and then moves to the image side, the distance between the first lens group G1 and the second lens group G2 increases, the distance between the second lens group G2 and the third lens group G3 decreases, the distance between the third lens group G3 and the fourth lens group G4 decreases, the distance between the fourth lens group G4 and the fifth lens group G5 decreases, the distance between the fifth lens group G5 and the sixth lens group G6 increases, and the distance between the sixth lens group G6 and the seventh lens group G7 increases and then decreases, and the distance at the telephoto end is smaller than the distance at the wide-angle end. During focusing from the infinite distance object to the close distance object, the sixth lens group G6 moves to the object side.

L18 is a concave lens corresponding to conditional expression (1).

L3 is a concave lens corresponding to conditional expression (2).

L5 is a concave lens corresponding to conditional expression (11).

L22 and L24 are concave lenses corresponding to conditional expression (12).

L22 and L24 are concave lenses corresponding to conditional expression (13).

L21, L23, and L25 are convex lenses corresponding to conditional expression (14).

L23 and L25 are convex lenses corresponding to conditional expression (15).

The following shows numerical values of the variable magnification imaging optical system according to Example 2.

### Numerical Example 2

Unit: mm
[Surface data]

| Surface number | r | d | nd | vd | ΔPgF | Glass material |
|---|---|---|---|---|---|---|
| Object surface | ∞ | (d0) | | | | |
| 1 | 246.3262 | 8.0991 | 1.48749 | 70.44 | 0.0090 | FC5 |
| 2 | −521.9818 | 21.6806 | | | | |
| 3 | 113.3245 | 10.6205 | 1.49700 | 81.61 | 0.0373 | FCD1 |
| 4 | −1379.8535 | 3.0000 | 1.62205 | 41.09 | −0.0051 | S-NBM52 |
| 5 | 187.3779 | (d5) | | | | |
| 6 | 130.3929 | 8.0135 | 1.72825 | 28.32 | 0.0101 | E-FD10L |
| 7 | −90.8458 | 1.7000 | 1.92286 | 20.88 | 0.0281 | E-FDS1-W |
| 8 | −289.4240 | (d8) | | | | |
| 9 | −342.1128 | 1.1871 | 1.90366 | 31.32 | 0.0027 | TAFD25 |
| 10 | 61.1799 | 3.5455 | 1.80809 | 22.76 | 0.0212 | FD225 |
| 11 | 289.8002 | 1.8879 | | | | |
| 12 | −1350.9782 | 1.0000 | 1.91082 | 35.25 | −0.0017 | TAFD35L |
| 13 | 64.7567 | 4.3236 | | | | |
| 14 | −44.2797 | 1.0000 | 1.75500 | 52.32 | −0.0069 | TAC6 |
| 15 | 76.6115 | 3.8563 | 1.85451 | 25.15 | 0.0071 | NBFD25 |
| 16 | −174.2122 | (d16) | | | | |
| 17 | 213.6019 | 3.5839 | 1.76385 | 48.49 | −0.0022 | S-LAH96 |
| 18 | −109.2397 | 0.3000 | | | | |
| 19 | 35.8827 | 7.5362 | 1.43700 | 95.10 | 0.0564 | FCD100 |
| 20 | −50.1883 | 1.0000 | 1.88300 | 40.81 | −0.0094 | TAFD30 |
| 21 | 394.3367 | (d21) | | | | |
| 22 | 103.0473 | 6.2284 | 1.84666 | 23.84 | 0.0145 | FDS90-SGP |
| 23 | −76.3576 | 0.3000 | | | | |
| 24 | −192.1579 | 1.0000 | 1.90366 | 31.32 | 0.0027 | TAFD25 |
| 25 | 29.1129 | 5.8898 | 1.43700 | 95.10 | 0.0564 | FCD100 |
| 26 | −103.2647 | 3.0000 | | | | |
| 27 (Diaphragm) | ∞ | (d27) | | | | |
| 28 | 57.2282 | 6.6864 | 1.80000 | 29.84 | 0.0070 | S-NBH55 |
| 29 | −43.9330 | 0.8997 | 1.94594 | 17.98 | 0.0385 | FDS18-W |
| 30 | −208.6497 | (d30) | | | | |
| 31 | −73.3698 | 2.8737 | 1.85451 | 25.15 | 0.0071 | NBFD25 |
| 32 | −38.8116 | 1.0000 | 1.76385 | 48.49 | −0.0022 | S-LAH96 |
| 33 | 44.9874 | 11.0319 | | | | |
| 34 | 148.5616 | 6.5851 | 1.62205 | 41.09 | −0.0051 | S-NBM52 |
| 35 | −29.4697 | 1.1001 | 1.43700 | 95.10 | 0.0564 | FCD100 |
| 36 | −43.0593 | 6.0350 | | | | |
| 37 | −58.6201 | 3.0322 | 1.61340 | 44.27 | −0.0054 | S-NBM51 |
| 38 | −36.6823 | 1.0000 | 1.59282 | 68.62 | 0.0192 | FCD515 |
| 39 | −353.4323 | 15.1583 | | | | |
| 40 | −48.8049 | 3.1541 | 1.61340 | 44.27 | −0.0054 | S-NBM51 |
| 41 | −33.4762 | 1.0002 | 1.76385 | 48.49 | −0.0022 | S-LAH96 |
| 42 | −97.3460 | 38.0000 | | | | |
| 43 | ∞ | 2.5000 | 1.51680 | 64.20 | 0.0014 | BSC7 |
| 44 | ∞ | (BF) | | | | |
| Image surface | ∞ | | | | | |

[Various types of data]
Zoom ratio 3.78

| | Wide angle | Wide angle | Wide angle |
|---|---|---|---|
| Focal length | 153.00 | 280.00 | 577.80 |
| F number | 5.15 | 5.79 | 6.47 |
| Total angle of view 2ω | 15.75 | 8.62 | 4.18 |
| Image height Y | 21.63 | 21.63 | 21.63 |
| Total lens length | 285.59 | 334.99 | 385.59 |

[Variable distance data]

| | | |
|---|---|---|
| Wide angle | Middle | Telephoto |

During focusing on infinity

| | | | |
|---|---|---|---|
| d0 | ∞ | ∞ | ∞ |
| d5 | 1.6589 | 54.4346 | 116.6097 |
| d8 | 20.2099 | 16.8330 | 5.2591 |
| d16 | 37.9067 | 21.5640 | 2.0000 |
| d21 | 3.3685 | 2.0000 | 2.9042 |
| d27 | 17.0854 | 34.4725 | 55.1218 |
| d30 | 5.5517 | 5.8757 | 3.8863 |
| BF | 1.0000 | 1.0000 | 1.0000 |

During focusing on close distance object

| | | | |
|---|---|---|---|
| d0 | 2500.0000 | 2500.0000 | 2500.0000 |
| d5 | 1.6589 | 54.4346 | 116.6097 |
| d8 | 20.2099 | 16.8330 | 5.2591 |
| d16 | 37.9067 | 21.5640 | 2.0000 |
| d21 | 3.3685 | 2.0000 | 2.9042 |
| d27 | 15.6470 | 30.0689 | 39.6710 |
| d30 | 6.9901 | 10.2793 | 19.3371 |
| BF | 1.0000 | 1.0000 | 1.0000 |

[Lens group data]

| Group | Starting surface | Focal length |
|---|---|---|
| G1 | 1 | 248.94 |
| G2 | 6 | 151.64 |
| G3 | 9 | −29.60 |
| G4 | 17 | 77.56 |
| G5 | 22 | 317.07 |
| G6 | 28 | 66.20 |
| G7 | 31 | −42.39 |

### Example 3

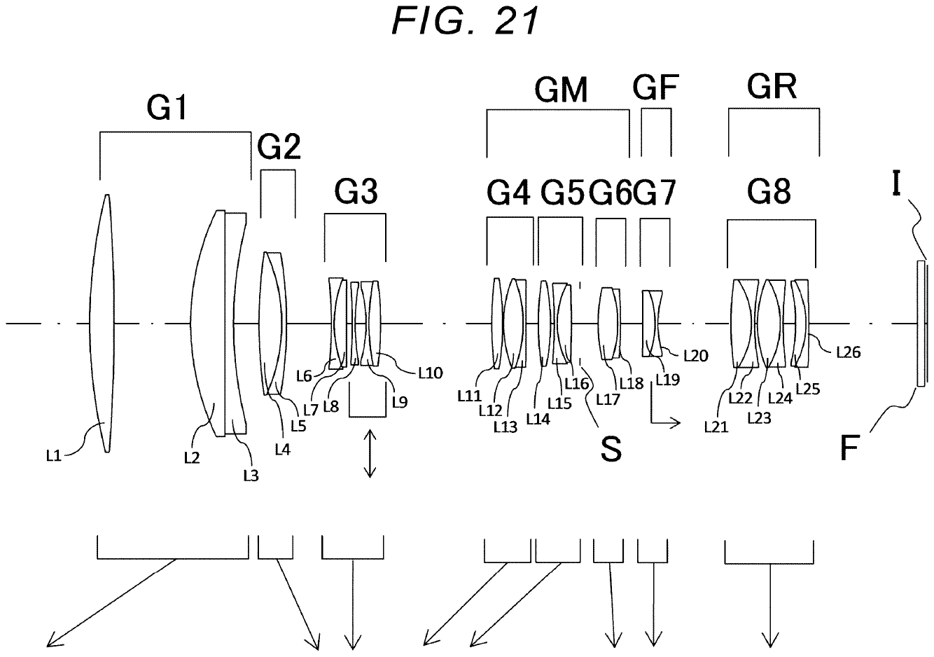

FIG. 21 is a lens configuration diagram of the variable magnification imaging optical system according to Example 3 in a case of focusing on infinity at the wide-angle end.

The variable magnification imaging optical system of FIG. 21 consists of, in order from the object side, a first lens group G1 having a positive refractive power, a second lens group G2 having a positive refractive power, a third lens group G3 having a negative refractive power, a middle group GM consisting of a fourth lens group G4, a fifth lens group G5, and a sixth lens group, a focusing group GF consisting of a seventh lens group G7, and a subsequent group GR consisting of an eighth lens group G8.

The first lens group G1 consists of: a biconvex lens L1, and a cemented lens of a meniscus positive lens L2 having a convex surface toward the object side and a meniscus negative lens L3 having a convex surface toward the object side. The second lens group G2 consists of a cemented lens of a biconvex lens L4 and a meniscus negative lens L5 having a convex surface toward the image side. The third lens group G3 consists of: a cemented lens of a biconcave lens L6 and a meniscus positive lens L7 having a convex surface toward the object side, a biconcave lens L8, and a cemented lens of a biconcave lens L9 and a biconvex lens L10. In addition, the third lens group G3 may also function as a vibration reduction group by moving L8 to L10 integrally in a direction substantially perpendicular to the optical axis, but lenses other than L8 to L10 may also function as the vibration reduction group. The fourth lens group G4 consists of: a biconvex lens L11, and a cemented lens of a biconvex lens L12 and a meniscus negative lens L13 having a convex surface toward the image side. The fifth lens group G5 consists of: a biconvex lens L14, a cemented lens of a biconcave lens L15 and a biconvex lens L16, and the aperture diaphragm S. The sixth lens group G6 consists of a cemented lens of a biconvex lens L17 and a meniscus negative lens L18 having a convex surface toward the image side. The seventh lens group G7 consists of a cemented lens of a meniscus positive lens L19 having a convex surface toward the image side and a biconcave lens L20. The eighth lens group G8 consists of: a cemented lens of a biconvex lens L21 and a biconcave lens L22, a cemented lens of a biconvex lens L23 and a biconcave lens L24, a meniscus positive lens L25 having a convex surface toward the image side, and a meniscus negative lens L26 having a convex surface toward the image side.

During magnification change from the wide-angle end to the telephoto end, the third lens group G3, the seventh lens group G7, and the eighth lens group G8 are fixed to the image surface, the first lens group G1 moves to the object side, the second lens group G2 moves to the image side, the fourth lens group G4 and the fifth lens group G5 move to the object side, the sixth lens group G6 moves to the image side, the distance between the first lens group G1 and the second lens group G2 increases, the distance between the second lens group G2 and the third lens group G3 decreases, the distance between the third lens group G3 and the fourth lens group G4 decreases, the distance between the fourth lens group G4 and the fifth lens group G5 decreases, the distance between the fifth lens group G5 and the sixth lens group G6 increases, and the distance between the sixth lens group G6 and the seventh lens group G7 decreases. During focusing from the infinite distance object to the close distance object, the seventh lens group G7 moves to the image side.

L18 is a concave lens corresponding to conditional expression (1).

L3 is a concave lens corresponding to conditional expression (2).

L5 is a concave lens corresponding to conditional expression (11).

L22 and L24 are concave lenses corresponding to conditional expression (12).

L22 and L24 are concave lenses corresponding to conditional expression (13).

L21, L23, and L25 are convex lenses corresponding to conditional expression (14).

L23 and L25 are convex lenses corresponding to conditional expression (15).

The following shows numerical values of the variable magnification imaging optical system according to Example 3.

### Numerical Example 3

Unit: mm
[Surface data]

| Surface number | r | d | nd | vd | ΔPgF | Glass material |
|---|---|---|---|---|---|---|
| Object surface | ∞ | (d0) | | | | |
| 1 | 201.9201 | 8.5220 | 1.48749 | 70.44 | 0.0090 | FC5 |
| 2 | −620.3600 | 26.8056 | | | | |
| 3 | 98.5807 | 12.0000 | 1.45860 | 90.19 | 0.0491 | FCD10A |
| 4 | 17562.5671 | 3.0000 | 1.62205 | 41.09 | −0.0051 | S-NBM52 |
| 5 | 154.6697 | (d5) | | | | |
| 6 | 190.7861 | 7.9231 | 1.72825 | 28.32 | 0.0101 | E-FD10L |
| 7 | −65.6159 | 1.7000 | 1.92286 | 20.88 | 0.0281 | E-FDS1-W |
| 8 | −158.4359 | (d8) | | | | |
| 9 | −153.6076 | 1.0000 | 1.90366 | 31.32 | 0.0027 | TAFD25 |
| 10 | 47.0924 | 4.2886 | 1.80809 | 22.76 | 0.0212 | FD225 |
| 11 | 3445.6155 | 1.9748 | | | | |
| 12 | −195.3640 | 1.0000 | 1.91082 | 35.25 | −0.0017 | TAFD35L |
| 13 | 83.9103 | 3.9323 | | | | |
| 14 | −47.7254 | 1.0000 | 1.76385 | 48.49 | −0.0022 | S-LAH96 |
| 15 | 81.1278 | 4.0989 | 1.85451 | 25.15 | 0.0071 | NBFD25 |
| 16 | −119.4206 | (d16) | | | | |
| 17 | 146.5472 | 3.9267 | 1.71736 | 29.50 | 0.0087 | E-FD1L |
| 18 | −101.7137 | 0.3000 | | | | |
| 19 | 46.3650 | 6.8510 | 1.43700 | 95.10 | 0.0564 | FCD100 |
| 20 | −46.9487 | 1.0000 | 1.91082 | 35.25 | −0.0017 | TAFD35L |
| 21 | −1334.2238 | (d21) | | | | |
| 22 | 111.7091 | 4.2741 | 1.84666 | 23.84 | 0.0145 | FDS90-SGP |
| 23 | −77.0188 | 1.3107 | | | | |
| 24 | −170.4019 | 1.0152 | 1.85451 | 25.15 | 0.0071 | NBFD25 |
| 25 | 32.3336 | 4.9322 | 1.43700 | 95.10 | 0.0564 | FCD100 |
| 26 | −418.3874 | 3.0000 | | | | |
| 27 (Diaphragm) | ∞ | (d27) | | | | |
| 28 | 62.3581 | 6.9109 | 1.71736 | 29.50 | 0.0087 | E-FD1L |
| 29 | −40.7604 | 0.8998 | 1.86966 | 20.02 | 0.0310 | FDS20-W |
| 30 | −176.1068 | (d30) | | | | |
| 31 | −1785.8064 | 4.2928 | 1.85451 | 25.15 | 0.0071 | NBFD25 |
| 32 | −34.5414 | 1.0000 | 1.80100 | 34.97 | 0.0009 | S-LAM66 |
| 33 | 39.3006 | (d33) | | | | |
| 34 | 121.2362 | 7.1844 | 1.62205 | 41.09 | −0.0051 | S-NBM52 |
| 35 | −29.5373 | 1.1000 | 1.43700 | 95.10 | 0.0564 | FCD100 |
| 36 | 80.7540 | 1.0090 | | | | |
| 37 | 44.1021 | 7.9698 | 1.55298 | 55.07 | −0.0046 | J-KZFH4 |
| 38 | −32.6885 | 1.0000 | 1.59282 | 68.62 | 0.0192 | FCD515 |
| 39 | 133.6593 | 4.3775 | | | | |
| 40 | −62.7216 | 3.6206 | 1.62205 | 41.09 | −0.0051 | S-NBM52 |
| 41 | −32.9941 | 1.0000 | 1.85150 | 40.78 | −0.0055 | S-LAH89 |
| 42 | −369.4182 | 38.0000 | | | | |
| 43 | ∞ | 2.5000 | 1.51680 | 64.20 | 0.0014 | BSC7 |
| 44 | ∞ | (BF) | | | | |
| Image surface | ∞ | | | | | |

[Various types of data]
Zoom ratio 3.78

| | Wide angle | Middle | Telephoto |
|---|---|---|---|
| Focal length | 153.00 | 280.00 | 577.80 |
| F number | 5.16 | 5.79 | 6.48 |
| Total angle of view 2ω | 15.84 | 8.64 | 4.18 |
| Image height Y | 21.63 | 21.63 | 21.63 |
| Total lens length | 293.09 | 334.25 | 383.09 |

[Variable distance data]

| | | |
|---|---|---|
| Wide angle | Middle | Telephoto |

During focusing on infinity

| | | | |
|---|---|---|---|
| d0 | ∞ | ∞ | ∞ |
| d5 | 8.8892 | 50.5572 | 111.4441 |
| d8 | 15.7049 | 15.2045 | 3.1500 |
| d16 | 38.7670 | 21.8715 | 2.0000 |
| d21 | 4.2824 | 2.0000 | 2.0000 |
| d27 | 6.3382 | 26.1318 | 49.9144 |
| d30 | 7.8268 | 7.2111 | 3.3000 |
| d33 | 25.5563 | 25.5565 | 25.5563 |
| BF | 1.0000 | 1.0000 | 1.0000 |

During focusing on close distance object

| | | | |
|---|---|---|---|
| d0 | 2500.0000 | 2500.0000 | 2500.0000 |
| d5 | 8.8892 | 50.5572 | 111.4441 |
| d8 | 15.7049 | 15.2045 | 3.1500 |
| d16 | 38.7670 | 21.8715 | 2.0000 |
| d21 | 4.2824 | 2.0000 | 2.0000 |
| d27 | 6.3382 | 26.1318 | 49.9144 |
| d30 | 9.4866 | 12.5565 | 24.2853 |
| d33 | 23.8965 | 20.2111 | 4.5710 |
| BF | 1.0000 | 1.0000 | 1.0000 |

[Lens group data]

| Group | Starting surface | Focal length |
|---|---|---|
| G1 | 1 | 246.08 |
| G2 | 6 | 151.03 |
| G3 | 9 | −30.96 |
| G4 | 17 | 77.95 |
| G5 | 22 | 438.00 |
| G6 | 28 | 79.17 |
| G7 | 31 | −51.76 |
| G8 | 34 | 627.68 |

### Example 4

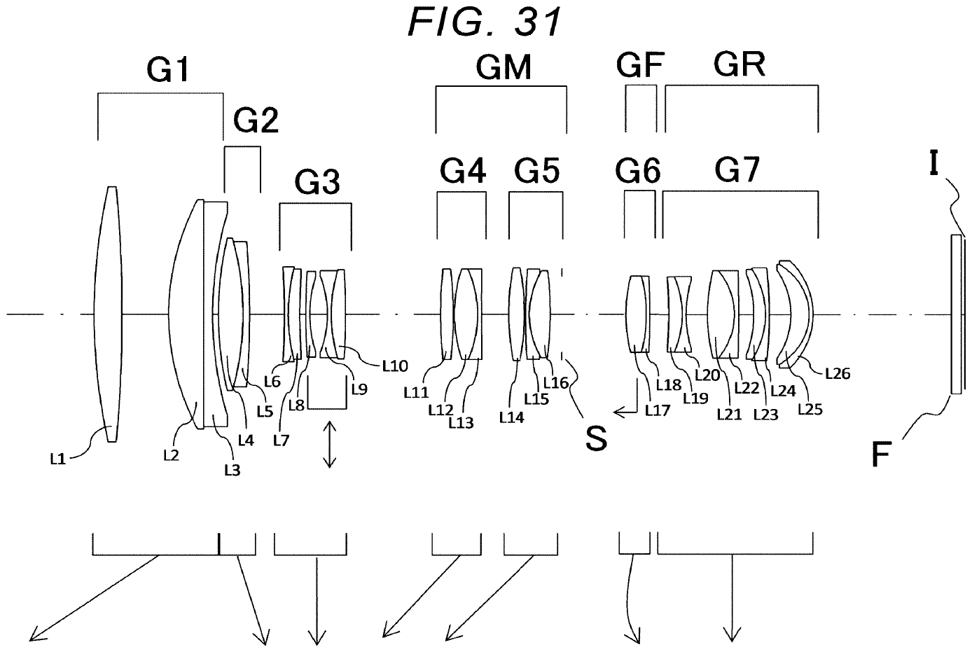

FIG. 31 is a lens configuration diagram of the variable magnification imaging optical system according to Example 4 in a case of focusing on infinity at the wide-angle end.

The variable magnification imaging optical system of FIG. 31 consists of, in order from the object side, a first lens group G1 having a positive refractive power, a second lens group G2 having a positive refractive power, a third lens group G3 having a negative refractive power, a middle group GM consisting of a fourth lens group G4 and a fifth lens group G5, a focusing group GF consisting of a sixth lens group G6, and a subsequent group GR consisting of a seventh lens group G7.

The first lens group G1 consists of a biconvex lens L1 and a cemented lens of a meniscus positive lens L2 having a convex surface toward the object side and a meniscus negative lens L3 having a convex surface toward the object side. The second lens group G2 consists of: a cemented lens of a biconvex lens L4 and a meniscus negative lens L5 having a convex surface toward the image side. The third lens group G3 consists of a cemented lens of a biconcave lens L6 and a meniscus positive lens L7 having a convex surface toward the object side, a meniscus negative lens L8 having a convex surface toward the object side, and a cemented lens of a biconcave lens L9 and a biconvex lens L10. In addition, the third lens group G3 may also function as a vibration reduction group by moving L8 to L10 integrally in a direction substantially perpendicular to the optical axis, but lenses other than L8 to L10 may also function as the vibration reduction group. The fourth lens group G4 consists of: a biconvex lens L11, and a cemented lens of a biconvex lens L12 and a biconcave lens L13. The fifth lens group G5 consists of a biconvex lens L14, a cemented lens of a meniscus negative lens L15 having a convex surface toward the object side and a biconvex lens L16, and the aperture diaphragm S. The sixth lens group G6 consists of a cemented lens of a biconvex lens L17 and a meniscus negative lens L18 having a convex surface toward the image side. The seventh lens group G7 consists of: a cemented lens of a meniscus positive lens L19 having a convex surface toward the image side and a biconcave lens L20, a cemented lens of a biconvex lens L21 and a meniscus negative lens L22 having a convex surface toward the image side, a cemented lens of a meniscus positive lens L23 having a convex surface toward the image side and a meniscus negative lens L24 having a convex surface toward the image side, and a cemented lens of a meniscus positive lens L25 having a convex surface toward the image side and a meniscus negative lens L26 having a convex surface toward the image side.

During magnification change from the wide-angle end to the telephoto end, the third lens group G3 and the seventh lens group G7 are fixed to the image surface, the first lens group G1 moves to the object side, the second lens group G2 moves to the image side, the fourth lens group G4 and the fifth lens group G5 move to the object side, the sixth lens group G6 moves to the object side and then moves to the image side, the distance between the first lens group G1 and the second lens group G2 increases, the distance between the second lens group G2 and the third lens group G3 decreases, the distance between the third lens group G3 and the fourth lens group G4 decreases, the distance between the fourth lens group G4 and the fifth lens group G5 decreases, the distance between the fifth lens group G5 and the sixth lens group G6 increases, and the distance between the sixth lens group G6 and the seventh lens group G7 increases and then decreases, and the distance at the telephoto end is smaller than the distance at the wide-angle end. During focusing from the infinite distance object to the close distance object, the sixth lens group G6 moves to the object side.

L18 is a concave lens corresponding to conditional expression (1).

L3 is a concave lens corresponding to conditional expression (2).

L5 is a concave lens corresponding to conditional expression (11).

L22 and L24 are concave lenses corresponding to conditional expression (12).

L22 and L24 are concave lenses corresponding to conditional expression (13).

L21, L23, and L25 are convex lenses corresponding to conditional expression (14).

L23 and L25 are convex lenses corresponding to conditional expression (15).

The following shows numerical values of the variable magnification imaging optical system according to Example 4.

### Numerical Example 4

Unit: mm
[Surface data]

| Surface number | r | d | nd | vd | ΔPgF | Glass material |
|---|---|---|---|---|---|---|
| Object surface | ∞ | (d0) | | | | |
| 1 | 185.6932 | 7.2164 | 1.55032 | 75.50 | 0.0274 | FCD705 |
| 2 | −439.8661 | 11.9991 | | | | |
| 3 | 75.9499 | 9.1160 | 1.49700 | 81.61 | 0.0373 | FCD1 |
| 4 | 5766.0730 | 2.2991 | 1.62205 | 41.09 | −0.0051 | S-NBM52 |
| 5 | 113.1096 | (d5) | | | | |
| 6 | 105.3273 | 6.3716 | 1.72825 | 28.32 | 0.0101 | E-FD10L |
| 7 | −87.5070 | 1.6991 | 1.92286 | 20.88 | 0.0281 | E-FDS1-W |
| 8 | −273.7133 | (d8) | | | | |
| 9 | −242.8108 | 1.0000 | 1.91082 | 35.25 | −0.0017 | AFD35L |
| 10 | 61.8013 | 2.9767 | 1.86966 | 20.02 | 0.0310 | FDS20-W |
| 11 | 215.8847 | 1.5480 | | | | |
| 12 | 228.6680 | 1.0000 | 1.85150 | 40.78 | −0.0055 | S-LAH89 |
| 13 | 38.4023 | 4.5618 | | | | |
| 14 | −33.2288 | 1.0000 | 1.76385 | 48.49 | −0.0022 | S-LAH96 |
| 15 | 49.1151 | 3.7209 | 1.85451 | 25.15 | 0.0071 | NBFD25 |
| 16 | −188.4172 | (d16) | | | | |
| 17 | 139.8919 | 3.2365 | 1.91650 | 31.60 | −0.0004 | S-LAH88 |
| 18 | −123.1233 | 0.3000 | | | | |
| 19 | 45.7865 | 5.9677 | 1.43700 | 95.10 | 0.0564 | FCD100 |
| 20 | −35.2881 | 1.0000 | 1.91082 | 35.25 | −0.0017 | TAFD35L |
| 21 | 1068.9881 | (d21) | | | | |
| 22 | 77.5041 | 4.1047 | 1.80518 | 25.46 | 0.0131 | FD60-W |
| 23 | −75.5322 | 0.3000 | | | | |
| 24 | 199.0936 | 1.0000 | 1.84666 | 23.84 | 0.0145 | FDS90-SGP |
| 25 | 26.9476 | 5.3854 | 1.43700 | 95.10 | 0.0564 | FCD100 |
| 26 | −102.8073 | 3.0000 | | | | |
| 27(Diaphragm) | ∞ | (d27) | | | | |
| 28 | 48.3995 | 5.2831 | 1.68893 | 31.16 | 0.0066 | E-FD8 |
| 29 | −46.8058 | 0.8988 | 1.92286 | 20.88 | 0.0281 | E-FDS1-W |
| 30 | −199.6440 | (d30) | | | | |
| 31 | −124.7029 | 3.4402 | 1.90110 | 27.06 | 0.0074 | NBFD27 |
| 32 | −29.8333 | 1.0000 | 1.85150 | 40.78 | −0.0055 | S-LAH89 |
| 33 | 37.8096 | 5.5000 | | | | |
| 34 | 56.4605 | 6.9737 | 1.62205 | 41.09 | −0.0051 | S-NBM52 |
| 35 | −21.2086 | 1.0994 | 1.43700 | 95.10 | 0.0564 | FCD100 |
| 36 | −653.8570 | 3.8992 | | | | |
| 37 | −36.6025 | 3.0122 | 1.61340 | 44.27 | −0.0054 | S-NBM51 |
| 38 | −26.0581 | 0.9993 | 1.59282 | 68.62 | 0.0192 | FCD515 |
| 39 | −132.0424 | 5.5510 | | | | |
| 40 | −24.3024 | 4.7405 | 1.55298 | 55.07 | −0.0046 | J-KZFH4 |
| 41 | −17.3134 | 0.9978 | 1.95375 | 32.32 | −0.0002 | TAFD45 |
| 42 | −23.0109 | 35.8318 | | | | |
| 43 | ∞ | 2.5000 | 1.51680 | 64.20 | 0.0014 | BSC7 |
| 44 | ∞ | (BF) | | | | |
| Image surface | ∞ | | | | | |

[Various types of data]
Zoom ratio 3.77

| | Wide angle | Middle | Telephoto |
|---|---|---|---|
| Focal length | 102.80 | 188.00 | 388.00 |
| F number | 4.99 | 6.07 | 6.46 |
| Total angle of view 2ω | 23.64 | 12.94 | 6.23 |
| Image height Y | 21.63 | 21.63 | 21.63 |
| Total lens length | 225.00 | 247.12 | 292.00 |

[Variable distance data]

| | | |
|---|---|---|
| Wide angle | Middle | Telephoto |

During focusing on infinity

| | | | |
|---|---|---|---|
| d0 | ∞ | ∞ | ∞ |
| d5 | 1.5000 | 24.1160 | 75.4942 |
| d8 | 9.0000 | 8.5000 | 2.0058 |
| d16 | 24.5388 | 8.0303 | 2.0000 |
| d21 | 7.0308 | 5.2259 | 2.0000 |
| d27 | 16.5176 | 27.1364 | 45.5207 |
| d30 | 4.8830 | 12.5775 | 3.4494 |
| BF | 1.0000 | 1.0000 | 1.0000 |

During focusing on close distance object

| | | | |
|---|---|---|---|
| d0 | 1680.0000 | 1680.0000 | 1680.0000 |
| d5 | 1.5000 | 24.1160 | 75.4942 |
| d8 | 9.0000 | 8.5000 | 2.0058 |
| d16 | 24.5388 | 8.0303 | 2.0000 |
| d21 | 7.0308 | 5.2259 | 2.0000 |
| d27 | 15.1678 | 23.2492 | 30.8696 |
| d30 | 6.2327 | 16.4647 | 18.1006 |
| BF | 1.0000 | 1.0000 | 1.0000 |

[Lens group data]

| Group | Starting surface | Focal length |
|---|---|---|
| G1 | 1 | 177.94 |
| G2 | 6 | 124.71 |
| G3 | 9 | −21.82 |
| G4 | 17 | 94.01 |
| G5 | 22 | 70.02 |
| G6 | 28 | 72.18 |
| G7 | 31 | −50.84 |

### Example 5

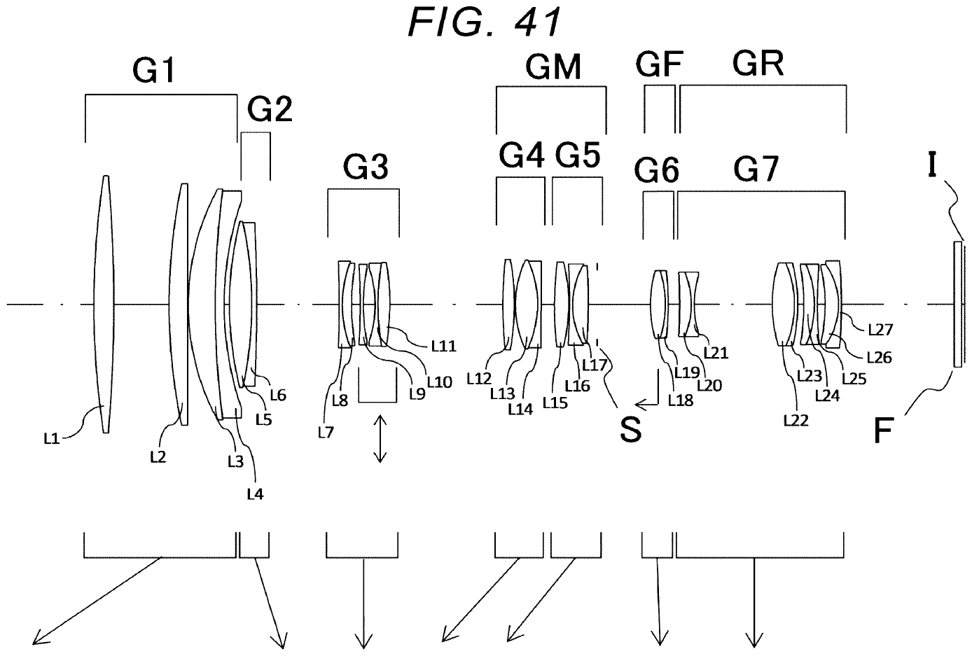

FIG. 41 is a lens configuration diagram of the variable magnification imaging optical system according to Example 5 in a case of focusing on infinity at the wide-angle end.

The variable magnification imaging optical system of FIG. 41 consists of, in order from the object side, a first lens group G1 having a positive refractive power, a second lens group G2 having a positive refractive power, a third lens group G3 having a negative refractive power, a middle group GM consisting of a fourth lens group G4 and a fifth lens group G5, a focusing group GF consisting of a sixth lens group G6, and a subsequent group GR consisting of a seventh lens group G7.

The first lens group G1 consists of: a biconvex lens L1, a meniscus positive lens L2 having a convex surface toward the object side, and a cemented lens of a meniscus positive lens L3 having a convex surface toward the object side and a meniscus negative lens L4 having a convex surface toward the object side. The second lens group G2 consists of a cemented lens of a biconvex lens L5 and a meniscus negative lens L6 having a convex surface toward the image side. The third lens group G3 consists of: a cemented lens of a biconcave lens L7 and a meniscus positive lens L8 having a convex surface toward the object side, a biconcave lens L9, and a cemented lens of a biconcave lens L10 and a biconvex lens L11. In addition, the third lens group G3 may also function as a vibration reduction group by moving L9 to L11 integrally in a direction substantially perpendicular to the optical axis, but lenses other than L9 to L11 may also function as the vibration reduction group. The fourth lens group G4 consists of: a biconvex lens L12, and a cemented lens of a biconvex lens L13 and a biconcave lens L14. The fifth lens group G5 consists of: a biconvex lens L15, a cemented lens of a biconcave lens L16 and a biconvex lens L17, and the aperture diaphragm S. The sixth lens group G6 consists of a cemented lens of a biconvex lens L18 and a meniscus negative lens L19 having a convex surface toward the image side. The seventh lens group G7 consists of: a cemented lens of a meniscus positive lens L20 having a convex surface toward the image side and a biconcave lens L21, a cemented lens of a biconvex lens L22 and a meniscus negative lens L23 having a convex surface toward the image side, a cemented lens of a meniscus positive lens L24 having a convex surface toward the image side and a biconcave lens L25, and a cemented lens of a meniscus positive lens L26 having a convex surface toward the image side and a meniscus negative lens L27 having a convex surface toward the image side.

During magnification change from the wide-angle end to the telephoto end, the third lens group G3 and the seventh lens group G7 are fixed to the image surface, the first lens group G1 moves to the object side, the second lens group G2 moves to the image side, the fourth lens group G4 and the fifth lens group G5 move to the object side, the sixth lens group G6 moves slightly to the image side, the distance between the first lens group G1 and the second lens group G2 increases, the distance between the second lens group G2 and the third lens group G3 decreases, the distance between the third lens group G3 and the fourth lens group G4 decreases, the distance between the fourth lens group G4 and the fifth lens group G5 decreases and then increases, and the distance at the telephoto end is larger than the distance at the wide-angle end. The distance between the fifth lens group G5 and the sixth lens group G6 increases, and the distance between the sixth lens group G6 and the seventh lens group G7 slightly decreases. During focusing from the infinite distance object to the close distance object, the sixth lens group G6 moves to the object side.

L19 is a concave lens corresponding to conditional expression (1).

L4 is a concave lens corresponding to conditional expression (2).

L6 is a concave lens corresponding to conditional expression (11).

L23 and L25 are concave lenses corresponding to conditional expression (12).

L23 and L25 are concave lenses corresponding to conditional expression (13).

L22, L24, and L26 are convex lenses corresponding to conditional expression (14).

L24 and L26 are convex lenses corresponding to conditional expression (15).

The following shows numerical values of the variable magnification imaging optical system according to Example 5.

### Numerical Example 5

Unit: mm
[Surface data]

| Surface number | r | d | nd | vd | ΔPgF | Glass material |
|---|---|---|---|---|---|---|
| Object surface | ∞ | (d0) | | | | |
| 1 | 337.1179 | 6.6999 | 1.49700 | 81.54 | 0.0358 | S-FPL51 |
| 2 | −581.8826 | 18.5972 | | | | |
| 3 | 235.7554 | 6.1028 | 1.43875 | 94.66 | 0.0560 | S-FPL55 |
| 4 | 7101.9638 | 0.3000 | | | | |
| 5 | 93.9288 | 9.1859 | 1.49700 | 81.54 | 0.0358 | S-FPL51 |
| 6 | 349.7573 | 3.0000 | 1.72047 | 34.71 | −0.0025 | S-NBH8 |
| 7 | 126.4244 | (d7) | | | | |
| 8 | 134.1399 | 7.5178 | 1.58144 | 40.89 | 0.0019 | E-FL5 |
| 9 | −148.8086 | 1.7000 | 1.80809 | 22.76 | 0.0212 | FD225 |
| 10 | −598.4548 | (d10) | | | | |
| 11 | −342.8200 | 1.0000 | 1.85150 | 40.78 | −0.0055 | S-LAH89 |
| 12 | 46.2637 | 3.1531 | 1.86966 | 20.02 | 0.0310 | FDS20-W |
| 13 | 95.1303 | 2.9095 | | | | |
| 14 | −219.2346 | 1.0000 | 1.76385 | 48.49 | −0.0022 | S-LAH96 |
| 15 | 72.6713 | 3.9865 | | | | |
| 16 | −45.0373 | 1.0000 | 1.76385 | 48.49 | −0.0022 | S-LAH96 |
| 17 | 104.0425 | 3.9451 | 1.85451 | 25.15 | 0.0071 | BFD25 |
| 18 | −99.8737 | (d18) | | | | |
| 19 | 173.0741 | 3.9090 | 1.83400 | 37.34 | −0.0022 | NBFD10 |
| 20 | −94.4675 | 0.3000 | | | | |
| 21 | 41.0379 | 7.4740 | 1.43700 | 95.10 | 0.0564 | FCD100 |
| 22 | −41.7054 | 1.2500 | 1.91082 | 35.25 | −0.0017 | TAFD35L |
| 23 | 12145.2652 | (d23) | | | | |
| 24 | 133.6881 | 4.8068 | 1.85451 | 25.15 | 0.0071 | NBFD25 |
| 25 | −65.7993 | 0.3000 | | | | |
| 26 | −232.8929 | 1.0000 | 1.90366 | 31.32 | 0.0027 | TAFD25 |
| 27 | 31.3191 | 5.2605 | 1.43700 | 95.10 | 0.0564 | FCD100 |
| 28 | −267.9501 | 3.0000 | | | | |
| 29 (Diaphragm) | ∞ | (d29) | | | | |
| 30 | 48.1447 | 5.1363 | 1.67270 | 32.17 | 0.0058 | E-FD5 |
| 31 | −42.8133 | 0.9001 | 1.94594 | 17.98 | 0.0385 | FDS18-W |
| 32 | −123.1479 | (d32) | | | | |
| 33 | −230.2065 | 3.8721 | 1.90110 | 27.06 | 0.0074 | NBFD27 |
| 34 | −32.6293 | 1.0000 | 1.79952 | 42.24 | −0.0049 | S-LAH52Q |
| 35 | 39.3064 | 26.2619 | | | | |
| 36 | 56.4665 | 7.5034 | 1.61310 | 44.36 | −0.0081 | E-ADF10 |
| 37 | −40.0385 | 1.1000 | 1.48071 | 85.29 | 0.0413 | FCD915 |
| 38 | −62.8720 | 2.0000 | | | | |
| 39 | −89.0940 | 3.6057 | 1.65253 | 39.48 | −0.0042 | NBFD38 |
| 40 | −38.5516 | 1.0000 | 1.59282 | 68.62 | 0.0192 | FCD515 |
| 41 | 194.8441 | 2.5814 | | | | |
| 42 | −63.7426 | 4.5130 | 1.61310 | 44.36 | −0.0081 | E-ADF10 |
| 43 | −26.5259 | 1.0000 | 1.89190 | 37.13 | −0.0035 | S-LAH92 |
| 44 | −203.6607 | 38.0000 | | | | |
| 45 | ∞ | 2.5000 | 1.51680 | 64.20 | 0.0014 | BSC7 |
| 46 | ∞ | (BF) | | | | |
| Image surface | ∞ | | | | | |

[Various types of data]
Zoom ratio 3.78

| | Wide angle | Middle | Telephoto |
|---|---|---|---|
| Focal length | 153.00 | 280.00 | 577.80 |
| F number | 5.16 | 5.79 | 6.48 |
| Total angle of view 2ω | 15.83 | 8.62 | 4.18 |
| Image height Y | 21.63 | 21.63 | 21.63 |
| Total lens length | 293.15 | 325.34 | 372.11 |

[Variable distance data]

| | | |
|---|---|---|
| Wide angle | Middle | Telephoto |

During focusing on infinity

| | | | |
|---|---|---|---|
| d0 | ∞ | ∞ | ∞ |
| d7 | 1.8002 | 33.1380 | 105.3427 |
| d10 | 27.7342 | 28.5792 | 3.1500 |
| d18 | 38.0563 | 22.3685 | 2.0000 |
| d23 | 4.4466 | 3.1063 | 5.6350 |
| d29 | 17.8727 | 35.4733 | 53.3131 |
| d32 | 3.8724 | 3.3000 | 3.3000 |
| BF | 1.0001 | 1.0001 | 1.0001 |

During focusing on close distance object

| | | | |
|---|---|---|---|
| d0 | 2500.0000 | 2500.0000 | 2500.0000 |
| d7 | 1.8002 | 33.1380 | 105.3427 |
| d10 | 27.7342 | 28.5792 | 3.1500 |
| d18 | 38.0563 | 22.3685 | 2.0000 |
| d23 | 4.4466 | 3.1063 | 5.6350 |
| d29 | 16.4652 | 31.0973 | 38.1679 |
| d32 | 5.2800 | 7.6760 | 18.4451 |
| BF | 1.0001 | 1.0001 | 1.0001 |

[Lens group data]

| Group | Starting surface | Focal length |
|---|---|---|
| G1 | 1 | 216.36 |
| G2 | 8 | 240.28 |
| G3 | 11 | −29.85 |
| G4 | 19 | 70.36 |
| G5 | 24 | 400.29 |
| G6 | 30 | 65.84 |
| G7 | 33 | −39.48 |

### Example 6

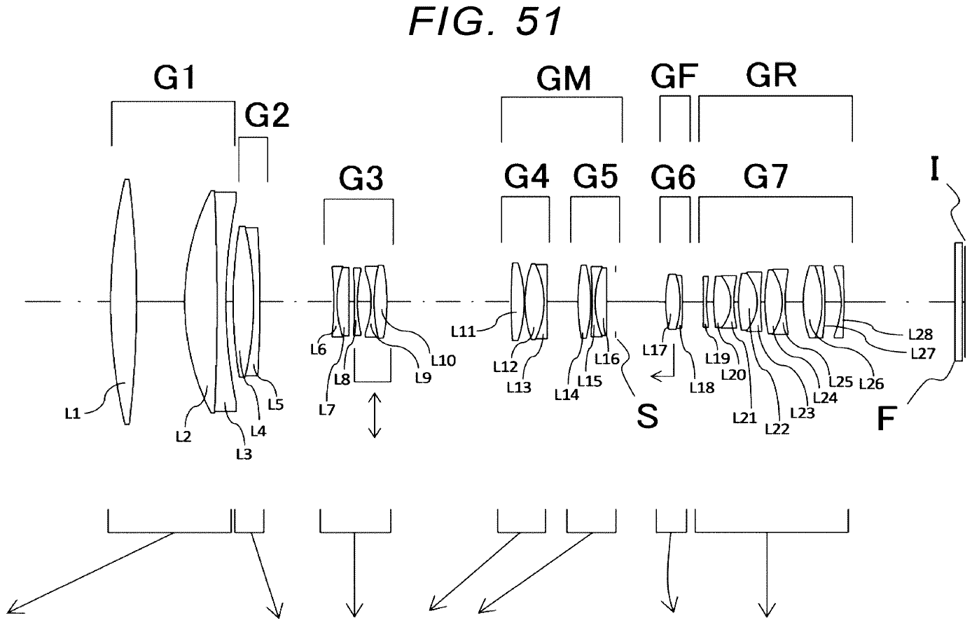

FIG. 51 is a lens configuration diagram of the variable magnification imaging optical system according to Example 6 in a case of focusing on infinity at the wide-angle end.

The variable magnification imaging optical system of FIG. 51 consists of, in order from the object side, a first lens group G1 having a positive refractive power, a second lens group G2 having a positive refractive power, a third lens group G3 having a negative refractive power, a middle group GM consisting of a fourth lens group G4 and a fifth lens group G5, a focusing group GF consisting of a sixth lens group G6, and a subsequent group GR consisting of a seventh lens group G7.

The first lens group G1 consists of: a biconvex lens L1, and a cemented lens of a biconvex lens L2 and a biconcave lens L3. The second lens group G2 consists of a cemented lens of a biconvex lens L4 and a meniscus negative lens L5 having a convex surface toward the image side. The third lens group G3 consists of: a cemented lens of a biconcave lens L6 and a biconvex lens L7, a biconcave lens L8, and a cemented lens of a biconcave lens L9 and a biconvex lens L10. In addition, the third lens group G3 may also function as a vibration reduction group by moving L8 to L10 integrally in a direction substantially perpendicular to the optical axis, but lenses other than L8 to L10 may also function as the vibration reduction group. The fourth lens group G4 consists of: a biconvex lens L11, and a cemented lens of a biconvex lens L12 and a biconcave lens L13. The fifth lens group G5 consists of: a biconvex lens L14, a cemented lens of a biconcave lens L15 and a meniscus positive lens L16 having a convex surface toward the object side, and the aperture diaphragm S. The sixth lens group G6 consists of a cemented lens of a biconvex lens L17 and a meniscus negative lens L18 having a convex surface toward the image side. The seventh lens group G7 consists of: a biconcave aspherical lens L19 in which both surfaces on the object side and the image side are aspherical surface, a cemented lens of a biconvex lens L20 and a biconcave lens L21, a cemented lens of a biconvex lens L22 and a biconcave lens L23, a cemented lens of a biconvex lens L24 and a biconcave lens L25, a cemented lens of a biconvex lens L26 and a meniscus negative lens L27 having a convex surface toward the image side, and a meniscus negative lens L28 having a convex surface toward the image side.

During magnification change from the wide-angle end to the telephoto end, the third lens group G3 and the seventh lens group G7 are fixed to the image surface, the first lens group G1 moves to the object side, the second lens group G2 moves to the image side, the fourth lens group G4 and the fifth lens group G5 move to the object side, the sixth lens group G6 moves to the object side and then moves to the image side, the distance between the first lens group G1 and the second lens group G2 increases, the distance between the second lens group G2 and the third lens group G3 decreases, the distance between the third lens group G3 and the fourth lens group G4 decreases, the distance between the fourth lens group G4 and the fifth lens group G5 decreases, the distance between the fifth lens group G5 and the sixth lens group G6 increases, and the distance between the sixth lens group G6 and the seventh lens group G7 increases and then decreases, and the distance at the telephoto end is smaller than the distance at the wide-angle end. During focusing from the infinite distance object to the close distance object, the sixth lens group G6 moves to the object side.

L18 is a concave lens corresponding to conditional expression (1).

L3 is a concave lens corresponding to conditional expression (2).

L5 is a concave lens corresponding to conditional expression (11).

L25 and L27 are concave lenses corresponding to conditional expression (12).

L25 and L27 are concave lenses corresponding to conditional expression (13).

L24 and L26 are convex lenses corresponding to conditional expression (14).

L24 and L26 are convex lenses corresponding to conditional expression (15).

The following shows numerical values of the variable magnification imaging optical system according to Example 6.

### Numerical Example 6

Unit: mm
[Surface data]

| Surface number | r | d | nd | vd | ΔPgF | Glass material |
|---|---|---|---|---|---|---|
| Object surface | ∞ | (d0) | | | | |
| 1 | 234.3304 | 8.7895 | 1.49700 | 81.61 | 0.0373 | FCD1 |
| 2 | −444.4309 | 16.4201 | | | | |
| 3 | 105.5481 | 11.2111 | 1.43700 | 95.10 | 0.0564 | FCD100 |
| 4 | −1051.9595 | 2.9998 | 1.62205 | 41.09 | −0.0051 | S-NBM52 |
| 5 | 215.8567 | (d5) | | | | |
| 6 | 204.3611 | 6.9940 | 1.69895 | 30.05 | 0.0084 | E-FD15L |
| 7 | −143.7381 | 2.0999 | 1.92286 | 20.88 | 0.0281 | E-FDS1-W |
| 8 | −613.6512 | (d8) | | | | |
| 9 | −156.0722 | 1.0997 | 1.91082 | 35.25 | −0.0017 | TAFD35L |
| 10 | 47.6583 | 4.1019 | 1.80809 | 22.76 | 0.0212 | FD225 |
| 11 | −5107.1670 | 1.8750 | | | | |
| 12 | −216.7389 | 1.0000 | 1.90525 | 35.04 | −0.0005 | S-LAH93 |
| 13 | 61.9481 | 4.6451 | | | | |
| 14 | −37.1044 | 1.0000 | 1.76385 | 48.49 | −0.0022 | S-LAH96 |
| 15 | 67.5560 | 4.5336 | 1.85451 | 25.15 | 0.0071 | NBFD25 |
| 16 | −80.7681 | (d16) | | | | |
| 17 | 263.5469 | 4.3751 | 1.72825 | 28.32 | 0.0101 | E-FD10L |
| 18 | −55.0230 | 0.3000 | | | | |
| 19 | 48.4645 | 6.5294 | 1.43700 | 95.10 | 0.0564 | FCD100 |
| 20 | −36.8526 | 1.0494 | 1.91082 | 35.25 | −0.0017 | AFD35L |
| 21 | 1231.1199 | (d21) | | | | |
| 22 | 93.9243 | 4.3227 | 1.80610 | 33.27 | −0.0001 | NBFD15-W |
| 23 | −63.9916 | 0.5046 | | | | |
| 24 | −213.9541 | 1.0000 | 1.85451 | 25.15 | 0.0071 | NBFD25 |
| 25 | 38.3982 | 3.9687 | 1.43700 | 95.10 | 0.0564 | FCD100 |
| 26 | 1803.9151 | 3.0405 | | | | |
| 27 (Diaphragm) | ∞ | (d27) | | | | |
| 28 | 52.0735 | 4.9684 | 1.67270 | 32.17 | 0.0058 | E-FD5 |
| 29 | −39.8030 | 0.8982 | 1.92286 | 20.88 | 0.0281 | E-FDS1-W |
| 30 | −116.9564 | (d30) | | | | |
| 31* | −494.4630 | 1.0000 | 1.85136 | 40.07 | −0.0076 | MC-TAFD315 |
| 32* | 53.9214 | 2.4713 | | | | |
| 33 | 77.9286 | 5.8550 | 1.73037 | 32.23 | −0.0005 | NBFD32 |
| 34 | −17.1696 | 0.9988 | 1.90525 | 35.04 | −0.0005 | S-LAH93 |
| 35 | 48.5723 | 1.6498 | | | | |
| 36 | 62.4617 | 6.3739 | 1.64769 | 33.84 | 0.0049 | E-FD2 |
| 37 | −18.6020 | 1.0995 | 1.69680 | 55.46 | −0.0060 | LAC14 |
| 38 | 118.0218 | 1.5231 | | | | |
| 39 | 65.7250 | 5.9379 | 1.61396 | 44.29 | −0.0055 | LAF45 |
| 40 | −24.6783 | 1.0001 | 1.49700 | 81.61 | 0.0373 | FCD1 |
| 41 | 72.8157 | 6.1659 | | | | |
| 42 | 46.9437 | 6.3940 | 1.61396 | 44.29 | −0.0055 | LAF45 |
| 43 | −42.7103 | 1.1000 | 1.43700 | 95.10 | 0.0564 | FCD100 |
| 44 | −105.5770 | 5.5000 | | | | |
| 45 | −36.7159 | 1.0000 | 2.05090 | 26.94 | 0.0052 | TAFD65 |
| 46 | −271.3804 | 38.0000 | | | | |
| 47 | ∞ | 2.5000 | 1.51680 | 64.20 | 0.0014 | BSC7 |
| 48 | ∞ | (BF) | | | | |
| Image surface | ∞ | | | | | |

[Aspherical surface data]

| | 31 surfaces | 32 surfaces |
|---|---|---|
| K | 0.00000 | 0.00000 |
| A4 | −5.41588E−06 | −1.22981E−05 |
| A6 | 7.90388E−08 | 6.46908E−08 |
| A8 | −2.58788E−10 | −2.46765E−10 |
| A10 | 2.86921E−13 | 0.00000E+00 |

[Various types of data]
Zoom ratio 6.29

| | Wide angle | Middle | Telephoto |
|---|---|---|---|
| Focal length | 123.60 | 450.00 | 777.00 |
| F number | 6.15 | 8.39 | 9.06 |
| Total angle of view 2ω | 19.78 | 5.38 | 3.11 |
| Image height Y | 21.63 | 21.63 | 21.63 |
| Total lens length | 292.27 | 344.49 | 388.89 |

[Variable distance data]

| | | |
|---|---|---|
| Wide angle | Middle | Telephoto |

During focusing on infinity

| | | | |
|---|---|---|---|
| d0 | ∞ | ∞ | ∞ |
| d5 | 2.5189 | 40.5047 | 120.7136 |
| d8 | 25.2707 | 39.5006 | 3.6968 |
| d16 | 42.4059 | 9.8506 | 2.0000 |
| d21 | 10.6039 | 2.0000 | 1.9996 |
| d27 | 17.0587 | 56.2957 | 69.1748 |
| d30 | 7.1167 | 9.0388 | 4.0108 |
| BF | 1.0000 | 1.0000 | 1.0000 |

During focusing on close distance object

| | | | |
|---|---|---|---|
| | Wide angle | Middle | Telephoto |
| d0 | 2500.0000 | 2500.0000 | 3300.0000 |
| d5 | 2.5189 | 40.5047 | 120.7136 |
| d8 | 25.2707 | 39.5006 | 3.6968 |
| d16 | 42.4059 | 9.8506 | 2.0000 |
| d21 | 10.6039 | 2.0000 | 1.9996 |
| d27 | 16.2689 | 47.8203 | 52.3102 |
| d30 | 7.9065 | 17.5142 | 20.8754 |
| BF | 1.0000 | 1.0000 | 1.0000 |

[Lens group data]

| Group | Starting surface | Focal length |
|---|---|---|
| G1 | 1 | 225.06 |
| G2 | 6 | 297.27 |
| G3 | 9 | −27.86 |
| G4 | 17 | 77.41 |
| G5 | 22 | 156.54 |
| G6 | 28 | 69.27 |
| G7 | 31 | −29.97 |

In addition, a list of corresponding values of the conditional expressions in each of these examples is shown.

[Conditional expression corresponding value]
Conditional expression number

| | Example 1 | Example 2 | Example 3 | Example 4 | Example 5 | Example 6 |
|---|---|---|---|---|---|---|
| (1) | 0.038 | 0.038 | 0.031 | 0.028 | 0.038 | 0.028 |
| (2) | 1.622 | 1.622 | 1.622 | 1.622 | 1.720 | 1.622 |
| (3) | 0.1995 | 0.0142 | 0.0798 | 0.0199 | 0.0171 | 0.0209 |
| (4) | 8.146 | 3.843 | 4.986 | 4.487 | 8.805 | 6.836 |
| (5) | 1.035 | 0.082 | 0.566 | 0.167 | 0.065 | 0.100 |
| (6) | 42.26 | 22.17 | 35.38 | 37.64 | 33.44 | 32.65 |
| (7) | 1.89 | 1.78 | 1.85 | 1.64 | 1.92 | 2.17 |
| (8) | 0.77 | 0.73 | 0.71 | 0.68 | 0.77 | 0.61 |
| (9) | −0.69 | −0.63 | −0.58 | −0.51 | −0.77 | −0.82 |
| (10) | 1.29 | 1.18 | 1.13 | 1.36 | 1.42 | 1.60 |
| (11) | 0.0281 | 0.0281 | 0.0281 | 0.0281 | 0.0212 | 0.0281 |
| (12) | 0.0564 | 0.0564 | 0.0564 | 0.0564 | 0.0413 | 0.0564 |
| (13) | 5.364 | 5.364 | 5.364 | 5.364 | 3.522 | 5.364 |
| (14) | −0.0055 | −0.0054 | −0.0051 | −0.0054 | −0.0081 | −0.0055 |
| (15) | −0.0055 | −0.0054 | −0.0048 | −0.0050 | −0.0061 | −0.0055 |
| (16) | 0.39 | 0.43 | 0.43 | 0.46 | 0.37 | 0.29 |
| (17) | 0.41 | 0.26 | 0.26 | 0.32 | 0.42 | 0.38 |
| (18) | 0.95 | 1.64 | 1.63 | 1.43 | 0.90 | 0.76 |
| (19) | 1.48 | 1.63 | 1.61 | 1.73 | 1.41 | 1.82 |
| (20) | 1.56 | 0.99 | 0.99 | 1.21 | 1.57 | 2.41 |
| (21) | 0.150 | 0.115 | 0.090 | 0.186 | 0.114 | 0.089 |
| (22) | 3.69 | 5.90 | 5.31 | 4.21 | 6.05 | 6.83 |

In addition, the present technology can also take the following configurations.

### [Item 1]

A variable magnification imaging optical system including, in order from an object side, a first lens group G1 having a positive refractive power, a second lens group G2 having a positive refractive power, a third lens group G3 having a negative refractive power, a middle group GM including an aperture diaphragm S consisting of one or more lens groups, a focusing group GF, and a subsequent group GR consisting of one lens group, in which a distance between adjacent lens groups changes during magnification change, and the focusing group GF moves along an optical axis during focusing from an infinite distance object to a close distance object.

### [Item 2]

The variable magnification imaging optical system according to [Item 1], in which one or more concave lenses satisfying the following conditional expression (1) are disposed between the aperture diaphragm S and the subsequent group GR.

$$Δ PgFLnSr > 0.013 \qquad ( 1 )$$

ΔPgFLnSr: anomalous dispersion of the concave lens disposed between the aperture diaphragm S and the subsequent group GR

### [Item 3]

The variable magnification imaging optical system according to according to [Item 1] or [Item 2], in which the first lens group G1 moves to the object side during magnification change from a wide-angle end to a telephoto end, a distance between the first lens group G1 and the second lens group G2 increases, and a distance between the second lens group G2 and the third lens group G3 decreases.

### [Item 4]

The variable magnification imaging optical system according to any one of [Item 1] to [Item 3], in which the second lens group G2 moves to an image side during magnification change from a wide-angle end to a telephoto end, a distance between the first lens group G1 and the second lens group G2 increases, and a distance between the second lens group G2 and the third lens group G3 decreases.

### [Item 5]

The variable magnification imaging optical system according to any one of [Item 1] to [Item 4], in which the first lens group G1 includes a concave lens satisfying the following conditional expression (2).

$$ndLN 1 < 1.8 \qquad ( 2 )$$

ndLN1: refractive index of concave lens having a highest refractive index included in first lens group G1

### [Item 6]

The variable magnification imaging optical system according to any one of [Item 1] to [Item 5], in which conditional expression (3) is satisfied.

$$0.005 < DG 1 G 2 W / DG 1 G 2 T < 0.400 \qquad ( 3 )$$

DG1G2W: distance between first lens group G1 and second lens group G2 on optical axis at infinity wide-angle end
DG1G2T: distance between first lens group G1 and second lens group G2 on optical axis at infinity telephoto end

### [Item 7]

The variable magnification imaging optical system according to any one of [Item 1] to [Item 6], in which conditional expression (4) is satisfied.

$$1. < D G 2 G 3 W / D G 2 G 3 T < 80.00 \qquad ( 4 )$$

DG2G3W: distance between second lens group G2 and third lens group G3 on optical axis at infinity wide-angle end
DG2G3T: distance between second lens group G2 and third lens group G3 on optical axis at infinity telephoto end

### [Item 8]

The variable magnification imaging optical system according to any one of [Item 1] to [Item 7], in which conditional expression (5) is satisfied.

$$0.01 < DG 1 G 2 W / DG 2 G 3 W < 2. \qquad ( 5 )$$

DG1G2W: distance between first lens group G1 and second lens group G2 on optical axis at infinity wide-angle end
DG2G3W: distance between second lens group G2 and third lens group G3 on optical axis at infinity wide-angle end

### [Item 9]

The variable magnification imaging optical system according to any one of [Item 1] to [Item 8], in which conditional expression (6) is satisfied.

$$2. < DG 1 G 2 T / DG 2 G 3 T < 200.0 \qquad ( 6 )$$

DG1G2T: distance between first lens group G1 and second lens group G2 on optical axis at infinity telephoto end
DG2G3T: distance between second lens group G2 and third lens group G3 on optical axis at infinity telephoto end

### [Item 10]

The variable magnification imaging optical system according to any one of [Item 1] to [Item 9], in which the following conditional expression (7) is satisfied.

$$1.2 < D G 2 S w / D G 2 S t < 5. \qquad ( 7 )$$

DG2Sw: distance from surface vertex of lens closest to object side in second lens group G2 at wide-angle end to aperture diaphragm S
DG2St: distance from surface vertex of lens closest to object side in second lens group G2 at telephoto end to aperture diaphragm S

### [Item 11]

The variable magnification imaging optical system according to any one of [Item 1] to [Item 10], in which the second lens group G2 satisfies the following conditional expression (8).

$$0.2 < g 2 AXhW / g 2 AXhT < 1.5 \qquad ( 8 )$$

g2AXhW: height of axial marginal ray at front surface of second lens group G2 at infinity wide-angle end with diaphragm open
g2AXhT: height of axial marginal ray at front surface of second lens group G2 at infinity telephoto end with diaphragm open

### [Item 12]

The variable magnification imaging optical system according to any one of [Item 1] to [Item 11], in which the second lens group G2 satisfies the following conditional expressions (9) and (10).

$$- 1.8 < ( g 2 OAhW / Wih ) - ( g 2 OAhT / Tih ) < - 0.3 \qquad ( 9 )$$

$$0.6 < \vert g 2 OAhW / g 2 AXhT \vert < 2.5 \qquad ( 10 )$$

Wih: image height of off-axis chief ray at maximum angle of view at infinity wide-angle end
Tih: image height of off-axis chief ray at maximum angle of view at infinity telephoto end
g2OAhW: height of off-axis chief ray at maximum angle of view at front surface of second lens group G2 at the infinity wide-angle end
g2OAhT: height of off-axis chief ray at maximum angle of view at front surface of second lens group G2 at infinity telephoto end
g2AXhT: height of axial marginal ray at front surface of second lens group G2 at infinity telephoto end with diaphragm open

### [Item 13]

The variable magnification imaging optical system according to any one of [Item 1] to [Item 12], in which the second lens group G2 includes one or more concave lenses.

### [Item 14]

The variable magnification imaging optical system according to any one of [Item 1] to [Item 13], in which the second lens group G2 includes at least one or more concave lenses satisfying the following conditional expression (11).

$$Δ PgFLg 2 > 0.009 \qquad ( 11 )$$

ΔPgFLg2: anomalous dispersion of concave lens having largest anomalous dispersion among concave lenses included in second lens group G2

### [Item 15]

The variable magnification imaging optical system according to any one of [Item 1] to [Item 14], in which the subsequent group GR includes at least one or more concave lenses satisfying the following conditional expression (12).

$$Δ PgFnLr > 0.009 \qquad ( 12 )$$

ΔPgFnLr: anomalous dispersion of concave lens of subsequent group GR

### [Item 16]

The variable magnification imaging optical system according to any one of [Item 1] to [Item 15], in which the subsequent group GR includes at least one or more concave lenses satisfying the following conditional expression (13).

$$vdnLr \times Δ PgFnLr > 0.8 \qquad ( 13 )$$

vdnLr: Abbe number of concave lens included in subsequent group GR
ΔPgFnLr: anomalous dispersion of concave lens included in subsequent group GR

### [Item 17]

The variable magnification imaging optical system according to any one of [Item 1] to [Item 16], in which the subsequent group GR includes at least one or more convex lenses satisfying the following conditional expression (14).

$$Δ PgFnLr < - 0.001 \qquad ( 14 )$$

ΔPgFpLr: anomalous dispersion of convex lens included in subsequent group GR

### [Item 18]

The variable magnification imaging optical system according to any one of [Item 1] to [Item 17], in which two convex lenses from an image side satisfy the following conditional expression (15).

$$Δ PgFprAVE < - 0.001 \qquad ( 15 )$$

ΔPgFprAVE: average value of anomalous dispersion of two convex lenses from image side

### [Item 19]

The variable magnification imaging optical system according to any one of [Item 1] to [Item 18], in which the first lens group G1 satisfies the following conditional expression (16).

$$0.18 < f 1 / fT < 1. \qquad ( 16 )$$

f1: focal length of first lens group G1
fT: focal length of variable magnification imaging optical system at infinity telephoto end

### [Item 20]

The variable magnification imaging optical system according to any one of [Item 1] to [Item 19], in which the second lens group G2 satisfies the following conditional expression (17).

$$0.1 < f 2 / f T < 1.4 \qquad ( 17 )$$

f2: focal length of second lens group G2
fT: focal length of variable magnification imaging optical system at infinity telephoto end

### [Item 21]

The variable magnification imaging optical system according to any one of [Item 1] to [Item 20], in which the first lens group G1 and the second lens group G2 satisfy the following conditional expression (18).

$$0.6 < f 1 / f 2 < 2.2 \qquad ( 18 )$$

f1: focal length of first lens group G1
f2: focal length of second lens group G2

### [Item 22]

The variable magnification imaging optical system according to any one of [Item 1] to [Item 21], in which the following conditional expression (19) is satisfied.

$$1. < f 1 / fW < 5. \qquad ( 19 )$$

f1: focal length of first lens group G1
fW: focal length of variable magnification imaging optical system at infinity wide-angle end

### [Item 23]

The variable magnification imaging optical system according to any one of [Item 1] to [Item 22], in which the following conditional expression (20) is satisfied.

$$0.5 < f 2 / f W < 8.5 \qquad ( 20 )$$

f2: focal length of second lens group G2
fW: focal length of variable magnification imaging optical system at infinity wide-angle end

### [Item 24]

The variable magnification imaging optical system according to any one of [Item 1] to [Item 23], in which the focusing group GF satisfies the following conditional expression (21).

$$0.04 < \vert fF / fT \vert < 0. 35 \qquad ( 21 )$$

fF: focal length of focusing group GF
fT: focal length of variable magnification imaging optical system at infinity telephoto end

### [Item 25]

The variable magnification imaging optical system according to any one of [Item 1] to [Item 24], in which the following conditional expression (22) is satisfied.

$$2. < \vert \{ 1 - ( β FT ) \hat{} 2 \} \times ( β RT ) \hat{} 2 \vert < 20. \qquad ( 22 )$$

βFT: lateral magnification of focusing group GF at infinity telephoto end
βRT: lateral magnification of all lens groups disposed on image side of focusing group GF at infinity telephoto end

### [Item 26]

The variable magnification imaging optical system according to any one of [Item 1] to [Item 25], in which the third lens group G3 is fixed to an image surface during magnification change.

### [Item 27]

The variable magnification imaging optical system according to any one of [Item 1] to [Item 26], in which the subsequent group GR is fixed to the image surface during magnification change.

### DESCRIPTION OF REFERENCE NUMERALS AND SIGNS

G1: first lens group
G2: second lens group
G3: third lens group
G4: fourth lens group
G5: fifth lens group
G6: sixth lens group
G7: seventh lens group
G8: eighth lens group
GM: middle group
GF: focusing group
GR: subsequent group
S: aperture diaphragm
F: optical filter
I: image surface

What is claimed is:

1. A variable magnification imaging optical system comprising, in order from an object side,
a first lens group G1 having a positive refractive power, a second lens group G2 having a positive refractive power, a third lens group G3 having a negative refractive power, a middle group GM including an aperture diaphragm S consisting of one or more lens groups, a focusing group GF, and a subsequent group GR consisting of one lens group, wherein
a distance between adjacent lens groups changes during magnification change, and the focusing group GF moves along an optical axis during focusing from an infinite distance object to a close distance object.

2. The variable magnification imaging optical system according to claim 1, wherein one or more concave lenses that satisfy the following conditional expression (1) are disposed between the aperture diaphragm S and the subsequent group GR,
$$Δ PgFLnSr > 0.013 \qquad ( 1 )$$
ΔPgFLnSr: anomalous dispersion of the concave lens disposed between the aperture diaphragm S and the subsequent group GR.

3. The variable magnification imaging optical system according to claim 1, wherein the first lens group G1 moves to the object side during magnification change from a wide-angle end to a telephoto end, a distance between the first lens group G1 and the second lens group G2 increases, and a distance between the second lens group G2 and the third lens group G3 decreases.

4. The variable magnification imaging optical system according to claim 1, wherein the second lens group G2 moves to an image side during magnification change from a wide-angle end to a telephoto end, a distance between the first lens group G1 and the second lens group G2 increases, and a distance between the second lens group G2 and the third lens group G3 decreases.

5. The variable magnification imaging optical system according to claim 1, wherein the first lens group G1 includes a concave lens that satisfies the following conditional expression (2),
$$ndLN 1 < 1.8 \qquad ( 2 )$$
ndLN1: refractive index of concave lens having a highest refractive index included in first lens group G1.

6. The variable magnification imaging optical system according to claim 1, wherein the following conditional expression (3) is satisfied,
$$0.005 < DG 1 G 2 W / DG 1 G 2 T < 0.400 \qquad ( 3 )$$
DG1G2W: distance between the first lens group G1 and the second lens group G2 on the optical axis at infinity wide-angle end
DG1G2T: distance between the first lens group G1 and the second lens group G2 on the optical axis at infinity telephoto end.

7. The variable magnification imaging optical system according to claim 1, wherein the following conditional expression (4) is satisfied,
$$1. < D G 2 G 3 W / D G 2 G 3 T < 80.00 \qquad ( 4 )$$
DG2G3W: distance between the second lens group G2 and the third lens group G3 on the optical axis at infinity wide-angle end
DG2G3T: distance between the second lens group G2 and the third lens group G3 on the optical axis at infinity telephoto end.

8. The variable magnification imaging optical system according to claim 1, wherein the following conditional expression (5) is satisfied,
$$0.01 < DG 1 G 2 W / DG 2 G 3 W < 2. \qquad ( 5 )$$
DG1G2W: distance between the first lens group G1 and the second lens group G2 on the optical axis at infinity wide-angle end
DG2G3W: distance between the second lens group G2 and the third lens group G3 on the optical axis at infinity wide-angle end.

9. The variable magnification imaging optical system according to claim 1, wherein the following conditional expression (6) is satisfied,
$$2. < DG 1 G 2 T / DG 2 G 3 T < 200.0 \qquad ( 6 )$$
DG1G2T: distance between the first lens group G1 and the second lens group G2 on the optical axis at infinity telephoto end
DG2G3T: distance between the second lens group G2 and the third lens group G3 on the optical axis at infinity telephoto end.

10. The variable magnification imaging optical system according to claim 1, wherein the following conditional expression (7) is satisfied,
$$1.2 < DG 2 Sw / DG 2 St < 5. \qquad ( 7 )$$
DG2Sw: distance from surface vertex of lens closest to the object side in the second lens group G2 at wide-angle end to the aperture diaphragm S
DG2St: distance from surface vertex of lens closest to object side in the second lens group G2 at telephoto end to the aperture diaphragm S.

11. The variable magnification imaging optical system according to claim 1, wherein the second lens group G2 satisfies the following conditional expression (8),
$$0.2 < g 2 AXhW / g 2 AXhT < 1.5 \qquad ( 8 )$$
g2AXhW: height of axial marginal ray at front surface of the second lens group G2 at infinity wide-angle end with the diaphragm open
g2AXhT: height of the axial marginal ray at front surface of the second lens group G2 at infinity telephoto end with the diaphragm open.

12. The variable magnification imaging optical system according to claim 1, wherein the second lens group G2 satisfies the following conditional expressions (9) and (10),
$$- 1.8 < ( g 2 OAHW / Wih ) - ( g 2 OAhT / Tih ) < - 0.3 \qquad ( 9 )$$
$$0.6 < \vert g 2 OAhW / g 2 AXhT \vert < 2.5 \qquad ( 10 )$$
Wih: image height of off-axis chief ray at maximum angle of view at infinity wide-angle end
Tih: image height of the off-axis chief ray at maximum angle of view at infinity telephoto end
g2OAhW: height of the off-axis chief ray at maximum angle of view at front surface of second lens group G2 at the infinity wide-angle end
g2OAhT: height of the off-axis chief ray at maximum angle of view at front surface of the second lens group G2 at infinity telephoto end
g2AXhT: height of the axial marginal ray at front surface of the second lens group G2 at infinity telephoto end with the diaphragm open.

13. The variable magnification imaging optical system according to claim 1, wherein the second lens group G2 includes one or more concave lenses.

14. The variable magnification imaging optical system according to claim 1, wherein the second lens group G2 includes at least one or more concave lenses that satisfy the following conditional expression (11),
$$Δ PgFLg 2 > 0.009 \qquad ( 11 )$$
ΔPgFLg2: anomalous dispersion of concave lens having largest anomalous dispersion among concave lenses included in the second lens group G2.

15. The variable magnification imaging optical system according to claim 1, wherein the subsequent group GR includes at least one or more concave lenses that satisfy the following conditional expression (12),
$$Δ PgFnLr > 0.009 \qquad ( 12 )$$
ΔPgFnLr: anomalous dispersion of concave lens of the subsequent group GR.

16. The variable magnification imaging optical system according to claim 1, wherein the subsequent group GR includes at least one or more concave lenses that satisfy the following conditional expression (13),
$$vdnLr \times Δ PgFnLr > 0.8 \qquad ( 13 )$$
vdnLr: Abbe number of concave lens included in the subsequent group GR
ΔPgFnLr: anomalous dispersion of concave lens included in the subsequent group GR.

17. The variable magnification imaging optical system according to claim 1, wherein the subsequent group GR includes at least one or more convex lenses that satisfy the following conditional expression (14),
$$Δ PgFpLr < - 0.001 \qquad ( 14 )$$
ΔPgFpLr: anomalous dispersion of convex lens included in the subsequent group GR.

18. The variable magnification imaging optical system according to claim 1, wherein two convex lenses from an image side satisfy the following conditional expression (15),
$$Δ PgFprAVE < - 0.001 \qquad ( 15 )$$
ΔPgFprAVE: average value of anomalous dispersion of the two convex lenses from the image side.

19. The variable magnification imaging optical system according to claim 1, wherein the first lens group G1 satisfies the following conditional expression (16),
$$0.18 < f 1 / fT < 1. \qquad ( 16 )$$
f1: focal length of the first lens group G1
fT: focal length of the variable magnification imaging optical system at infinity telephoto end.

20. The variable magnification imaging optical system according to claim 1, wherein the second lens group G2 satisfies the following conditional expression (17),
$$0.1 < f 2 / fT < 1.4 \qquad ( 17 )$$
f2: focal length of the second lens group G2
fT: focal length of the variable magnification imaging optical system at infinity telephoto end.

21. The variable magnification imaging optical system according to claim 1, wherein the first lens group G1 and the second lens group G2 satisfy the following conditional expression (18),
$$0.6 < f 1 / f 2 < 2.2 \qquad ( 18 )$$
f1: focal length of the first lens group G1
f2: focal length of the second lens group G2.

22. The variable magnification imaging optical system according to claim 1, wherein the following conditional expression (19) is satisfied,
$$1. < f 1 / fW < 5. \qquad ( 19 )$$
f1: focal length of the first lens group G1
fW: focal length of the variable magnification imaging optical system at infinity wide-angle end.

23. The variable magnification imaging optical system according to claim 1, wherein the following conditional expression (20) is satisfied,
$$0.5 < f 2 / fW < 8.5 \qquad ( 20 )$$
f2: focal length of the second lens group G2
fW: focal length of the variable magnification imaging optical system at infinity wide-angle end.

24. The variable magnification imaging optical system according to claim 1, wherein the focusing group GF satisfies the following conditional expression (21),
$$0.04 < \vert fF / fT \vert < 0. 35 \qquad ( 21 )$$
fF: focal length of the focusing group GF
fT: focal length of the variable magnification imaging optical system at infinity telephoto end.

25. The variable magnification imaging optical system according to claim 1, wherein the following conditional expression (22) is satisfied,
$$2. < \vert \{ 1 - ( β FT ) \hat{} 2 \} \times ( β RT ) \hat{} 2 \vert < 20. \qquad ( 22 )$$
βFT: lateral magnification of the focusing group GF at infinity telephoto end
βRT: lateral magnification of all lens groups disposed on the image side of the focusing group GF at infinity telephoto end.

26. The variable magnification imaging optical system according to claim 1, wherein the third lens group G3 is fixed to an image surface during magnification change.

27. The variable magnification imaging optical system according to claim 1, wherein the subsequent group GR is fixed to an image surface during magnification change.
